(19) United States
(12) Patent Application Publication
(10) Pub. No.: US 2015/0010635 A1
(43) Pub. Date: Jan. 8, 2015

(54) CONTROLLED RELEASE PARTICLES, WOOD TREATMENT AGENT, AND PRODUCING METHOD THEREOF

(71) Applicant: Japan EnviroChemicals, Ltd., Osaka-shi, Osaka (JP)

(72) Inventors: Junji Oshima, Osaka (JP); Hideaki Inoue, Osaka (JP)

(73) Assignee: Japan EnviroChemicals, Ltd., Osaka-shi, Osaka (JP)

(21) Appl. No.: 14/368,902

(22) PCT Filed: Dec. 27, 2012
(86) PCT No.: PCT/JP2012/083986

§ 371 Date: Jun. 26, 2014

(30) Foreign Application Priority Data
Dec. 28, 2011 (JP) 2011-288100
Dec. 28, 2011 (JP) 2011-288101
Oct. 12, 2012 (JP) 2012-227114
Nov. 21, 2012 (JP) 2012-255733
Dec. 11, 2012 (JP) 2012-270477

(51) Int. Cl. A01N 25/04; A01N 43/80; A01N 53/00; A01N 31/14; A01N 43/56; A01N 55/00; A01N 37/18; A01N 47/12; A01N 43/653

(52) U.S. Cl. CPC A01N 25/04; A01N 47/12; A01N 43/80; A01N 53/00; A01N 43/653; A01N 43/56; A01N 55/00; A01N 37/18; A01N 31/14
USPC 424/489; 514/478; 514/372; 514/531; 514/383; 514/399; 514/63; 514/617; 514/721

(57) ABSTRACT

Controlled release particles are obtained by dissolving a hydrophobic antibiotic compound with a hydrophobic polymerizable vinyl monomer to prepare a hydrophobic solution, blending water with an emulsifier to prepare an aqueous emulsifier solution, emulsifying the hydrophobic solution in the aqueous emulsifier solution, and polymerizing the polymerizable vinyl monomer by mini-emulsion polymerization in the presence of a polymerization initiator, thereby producing a polymer containing an antibiotic compound and having an average particle size of below 1 μm.

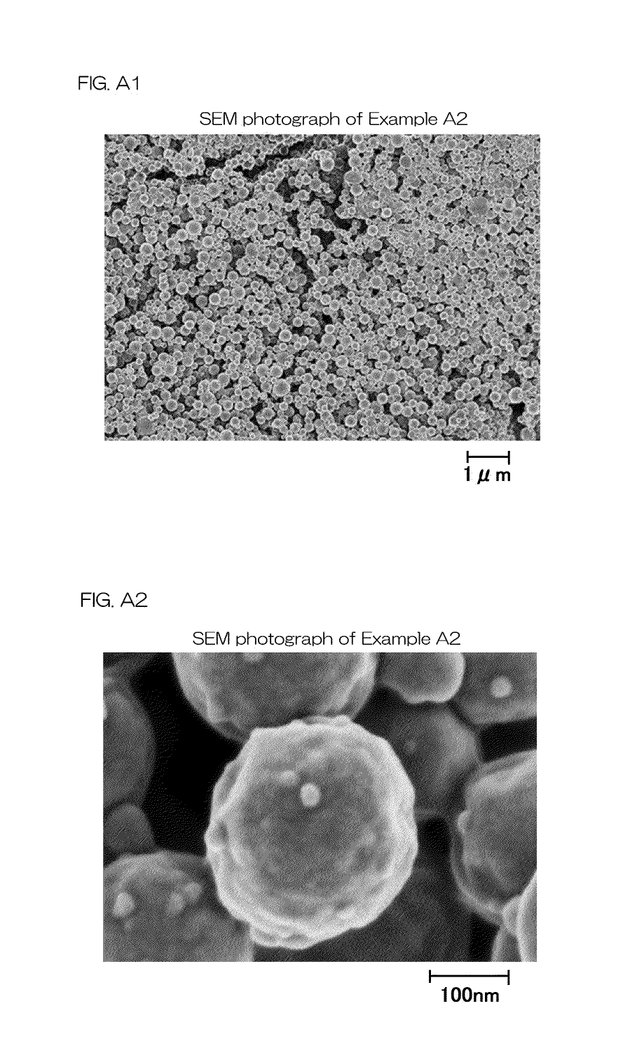

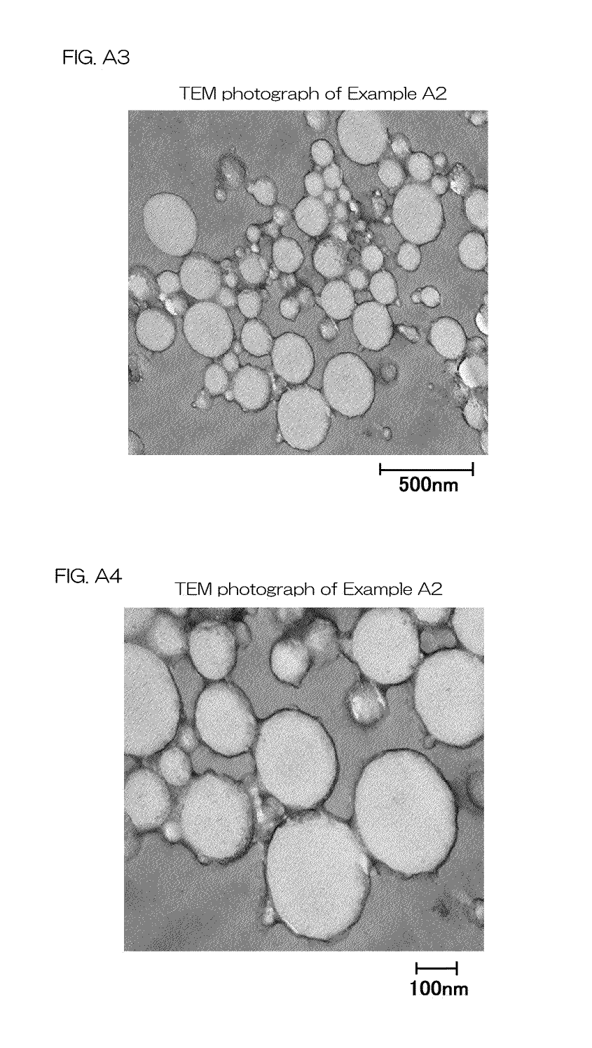

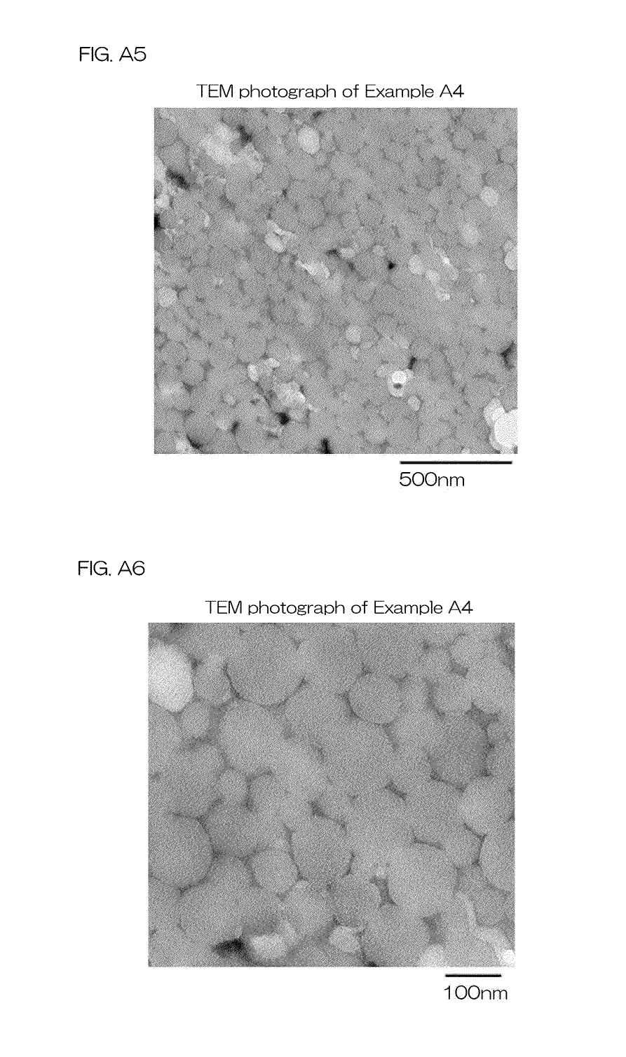

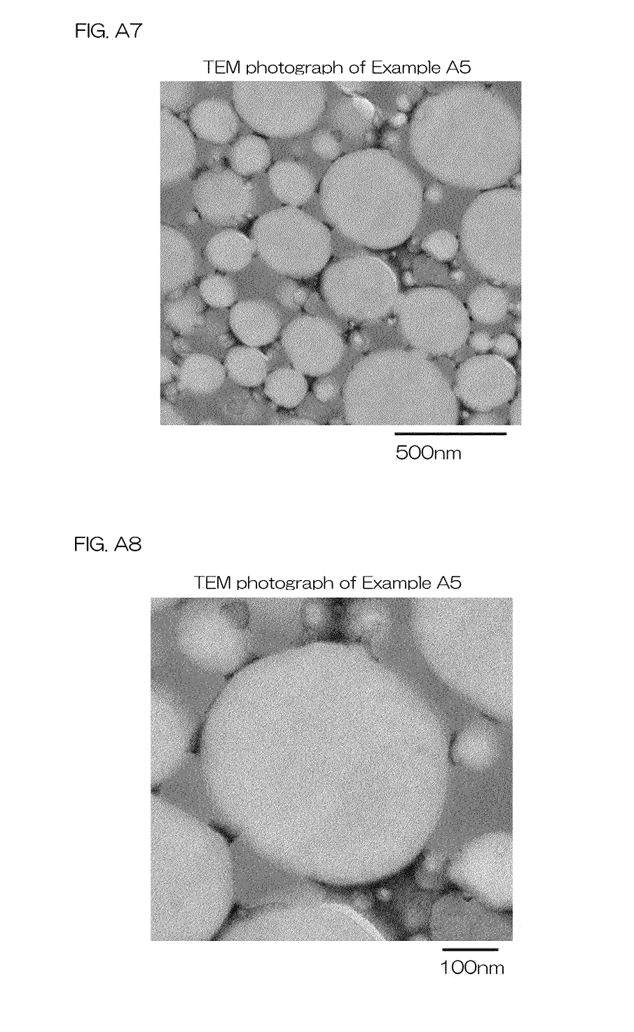

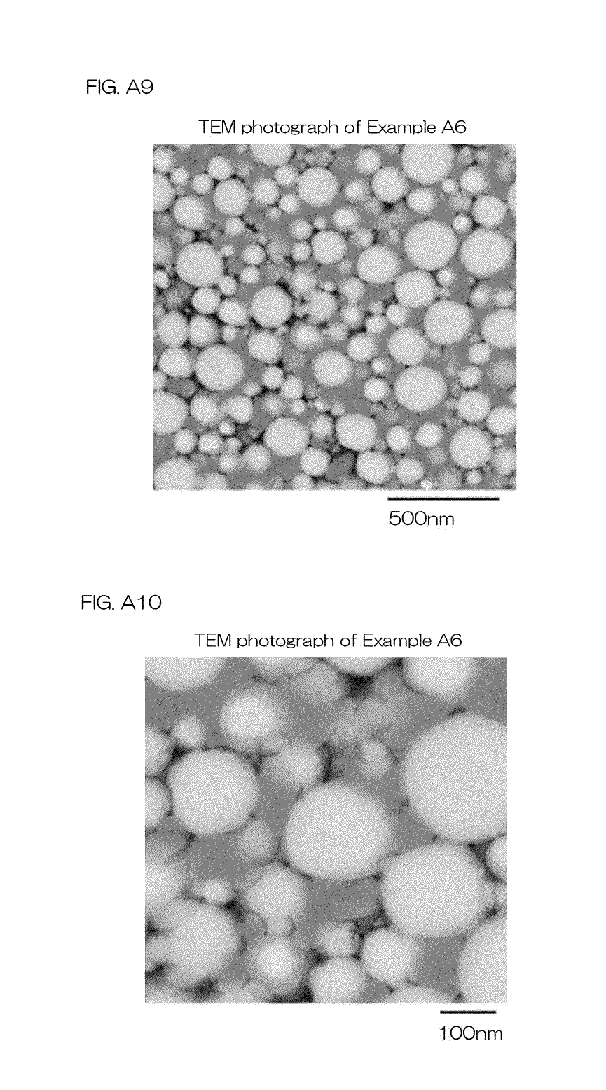

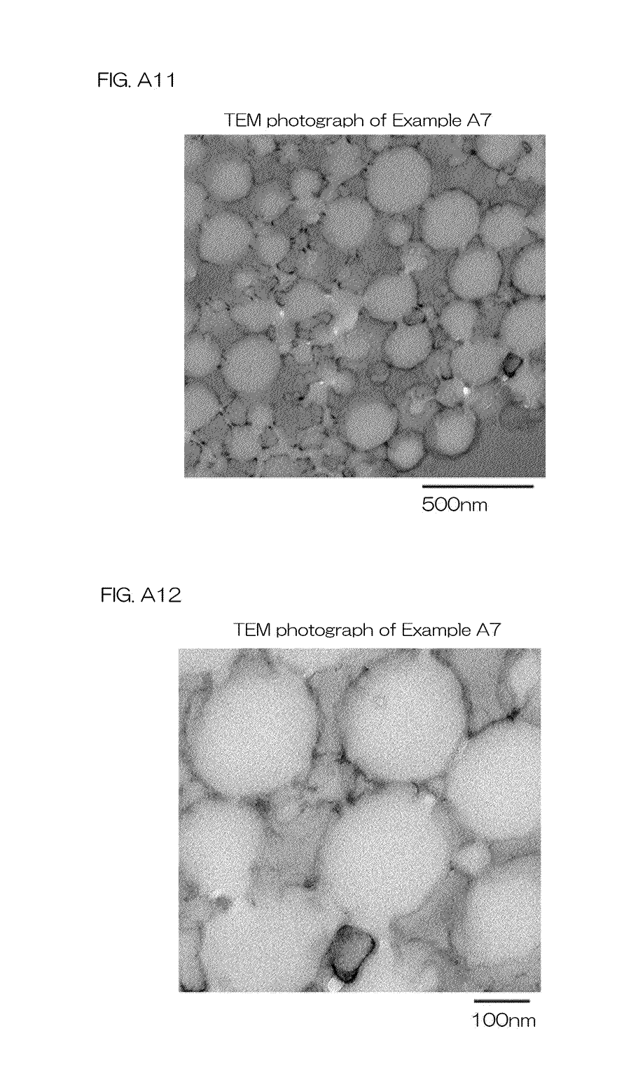

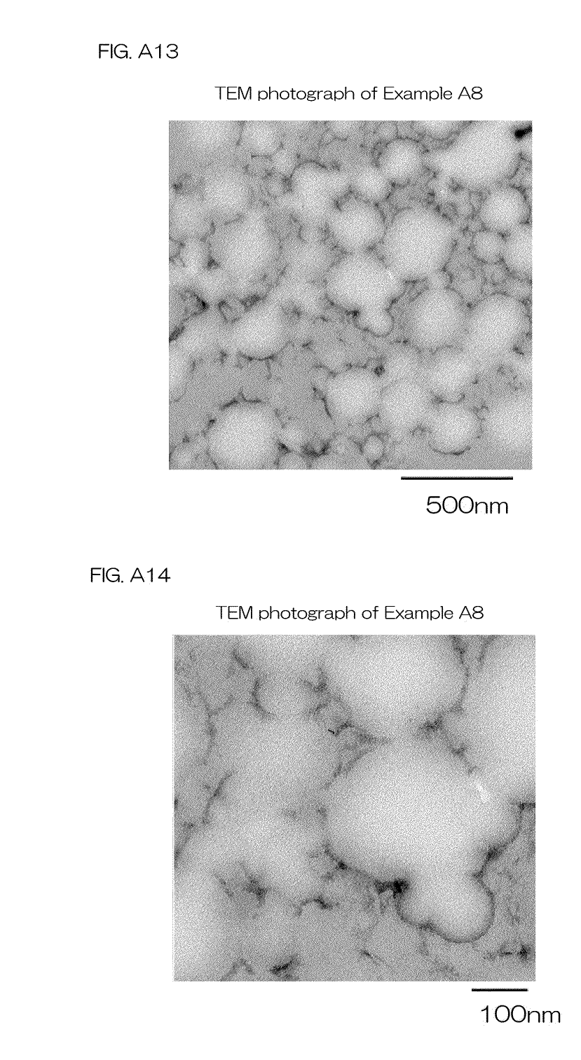

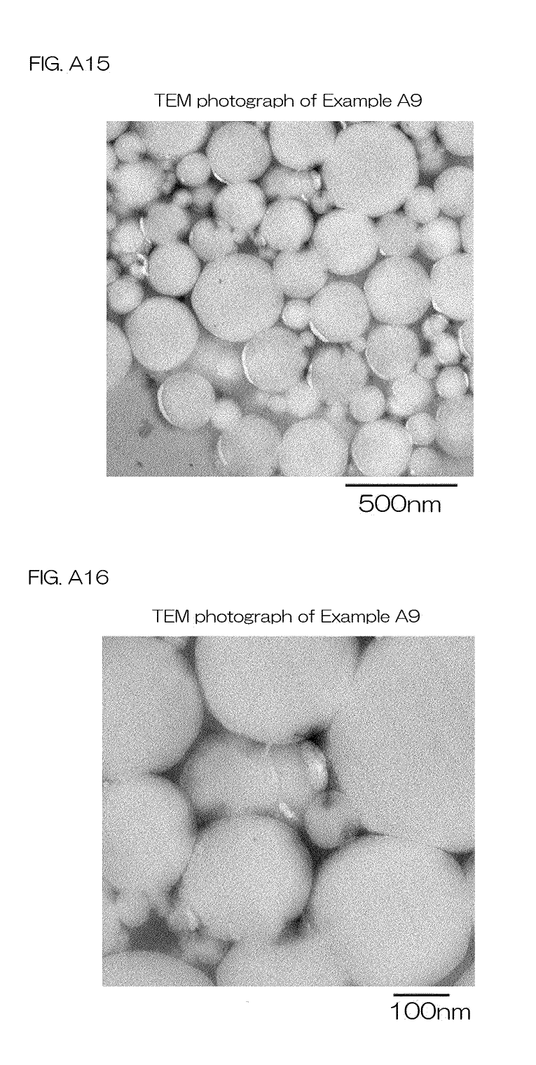

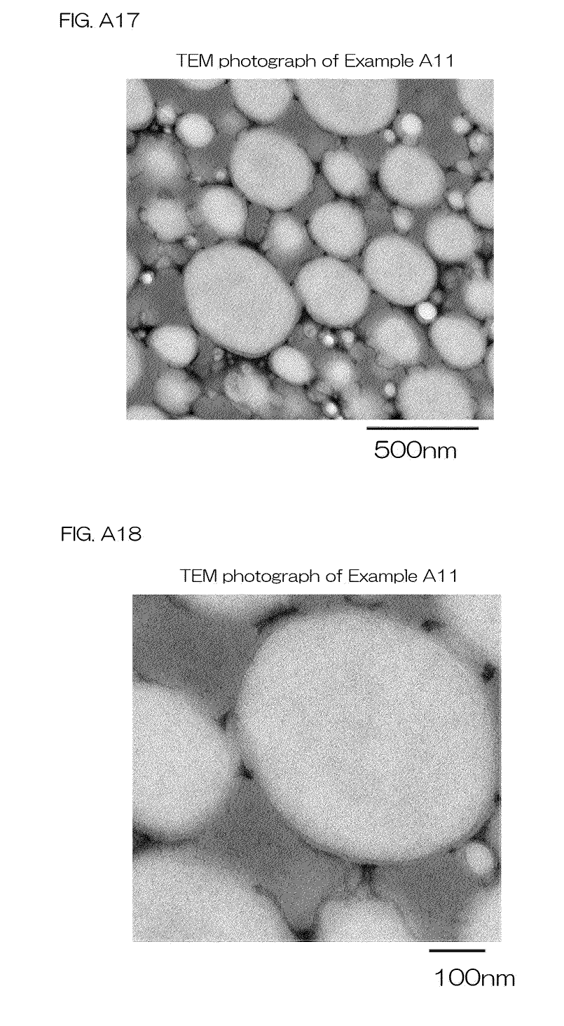

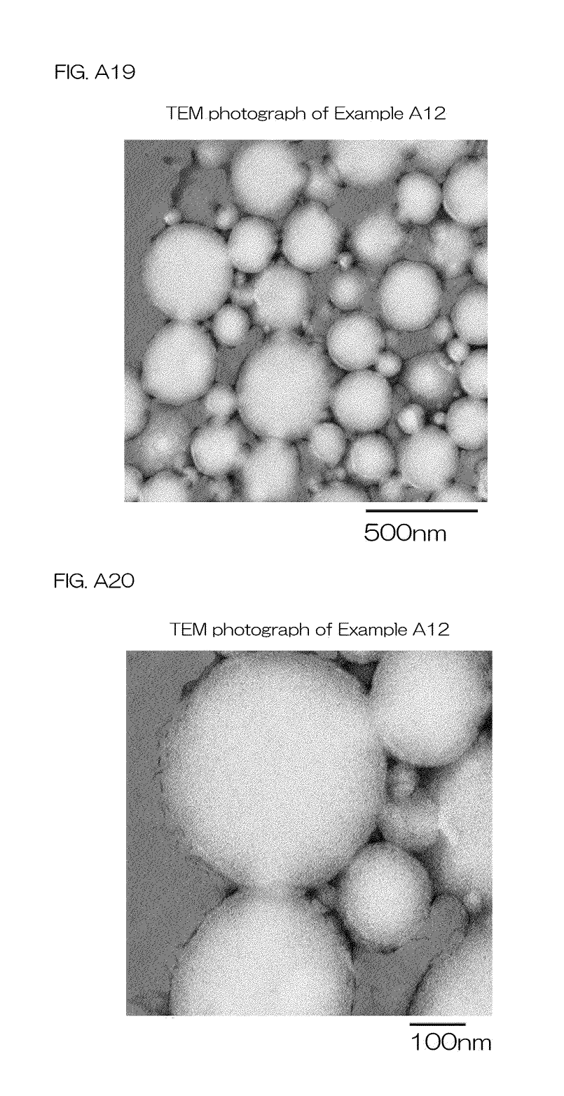

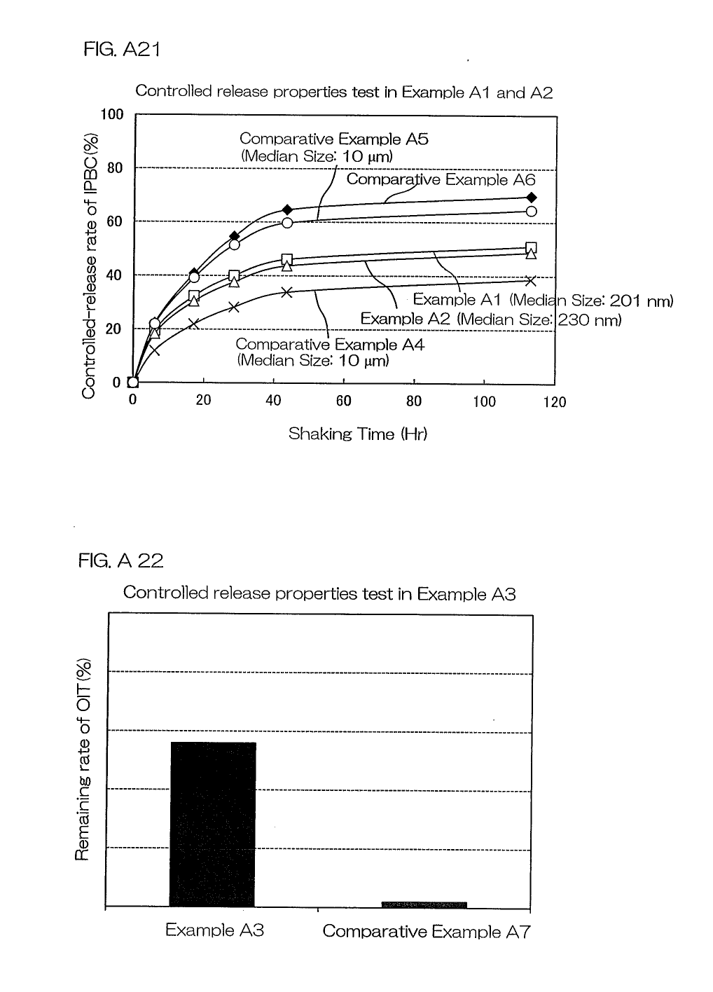

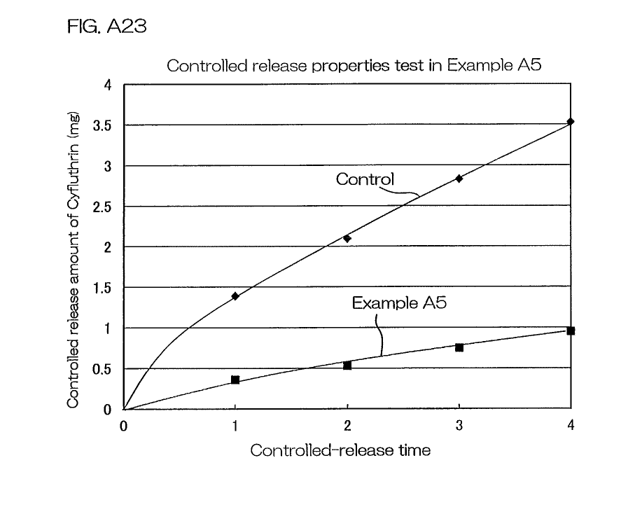

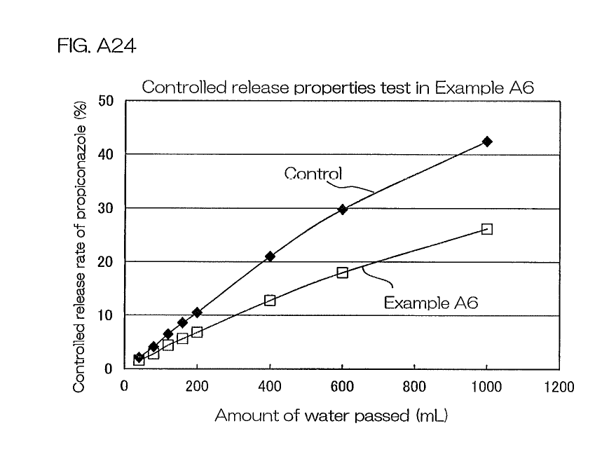

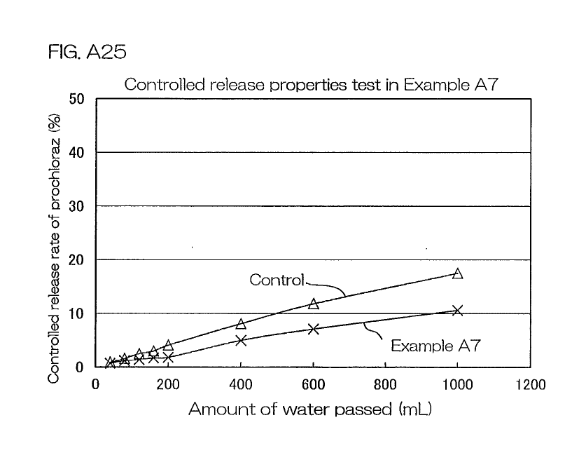

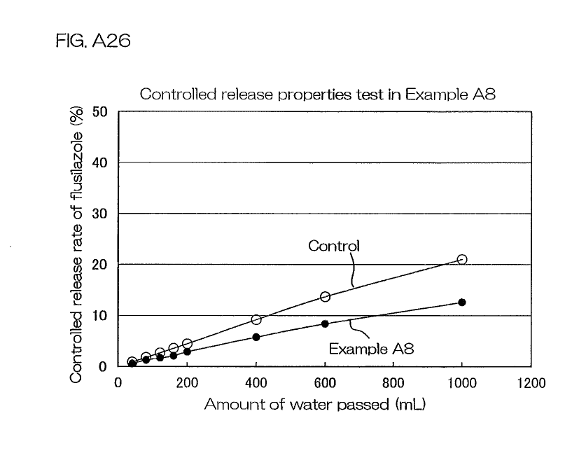

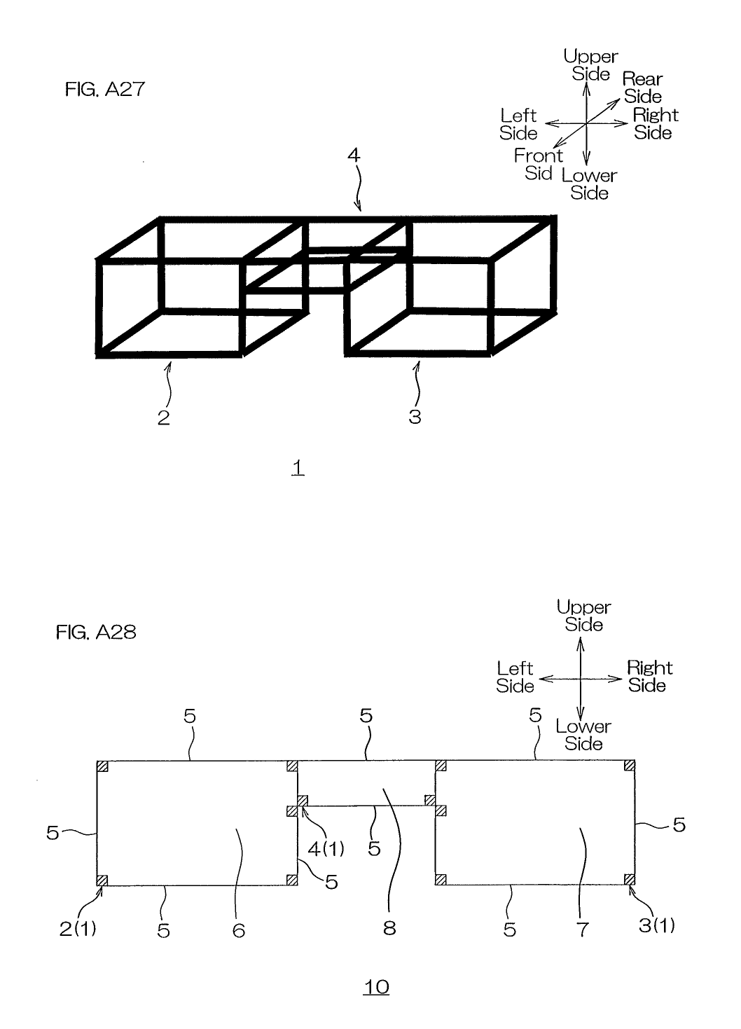

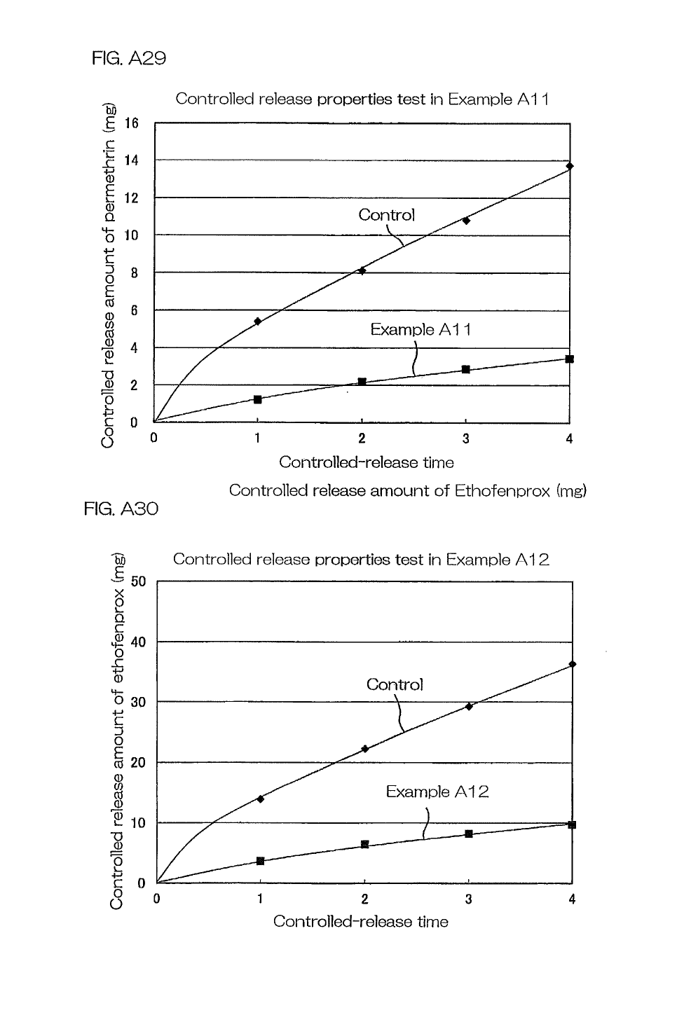

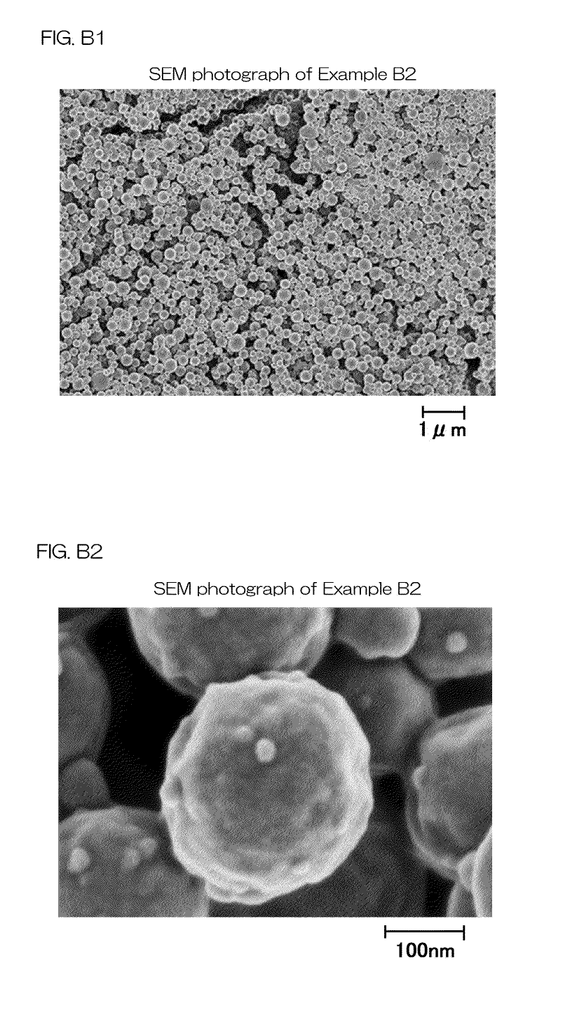

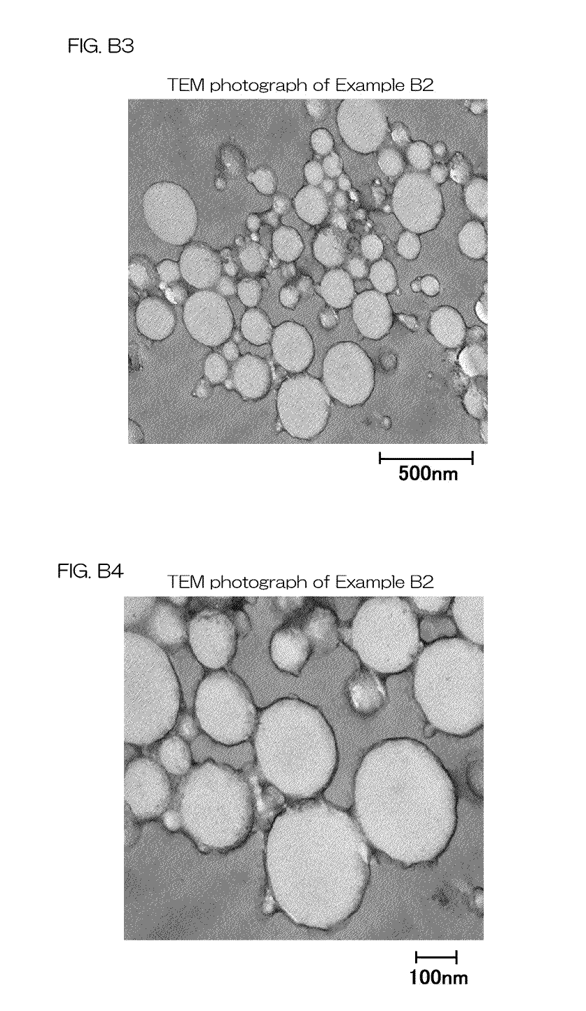

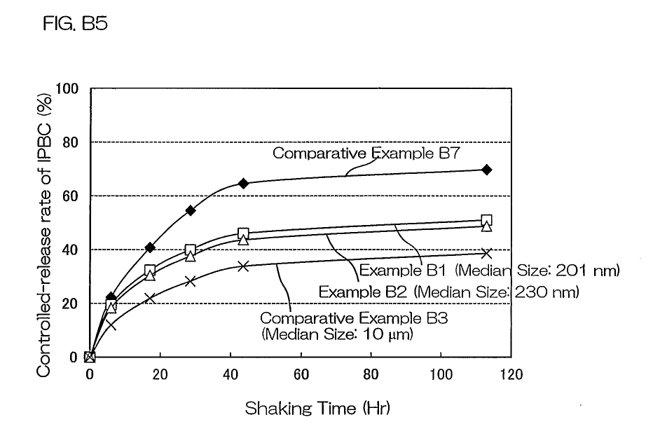

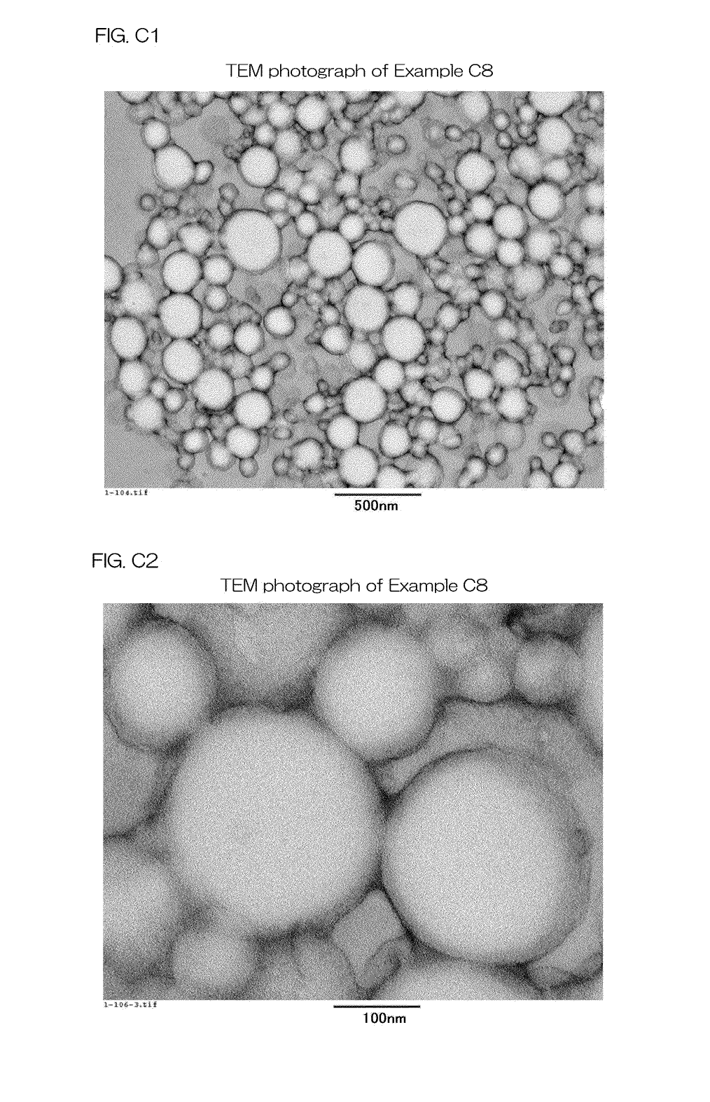

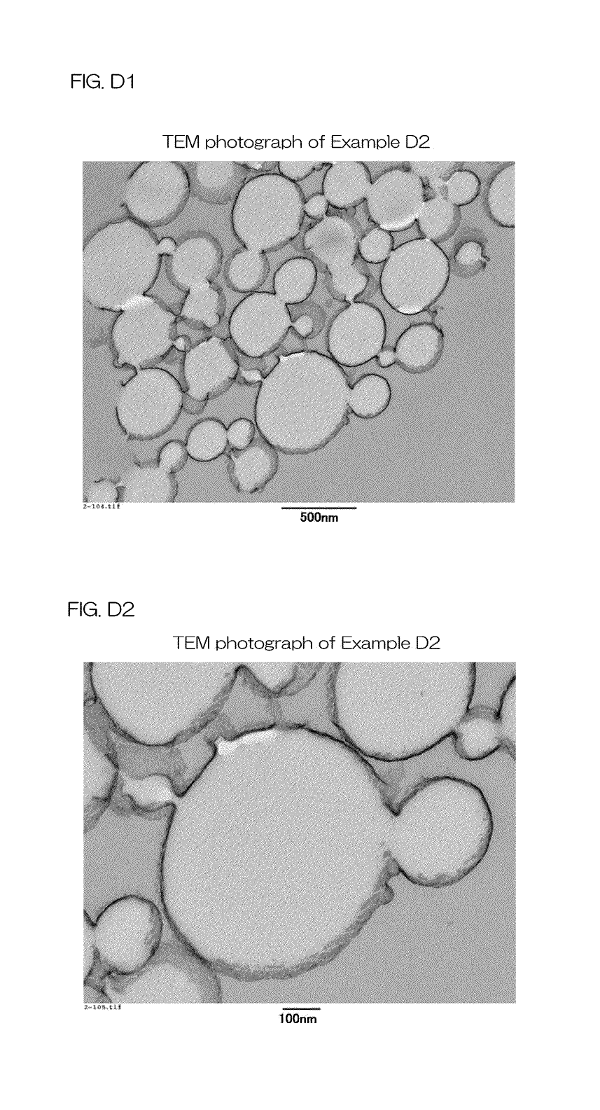

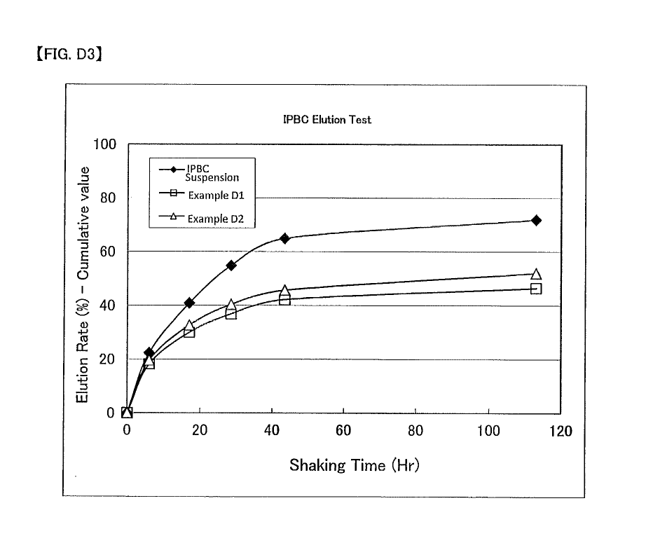

### TECHNICAL FIELD

The present invention relates to controlled release particles, a wood treatment agent, and a producing method thereof. In particular, the present invention relates to controlled release particles that allow controlled-release of an antibiotic compound, a wood treatment agent, and a producing method thereof.

### BACKGROUND ART

Recently, there has been proposed controlled release particles containing antibiotic compounds such as a sterilizer, an antiseptic, and a fungicide.

The following methods are proposed as a method for producing such controlled release particles (for example, see Patent Documents 1 and 2 below).

In Patent Document 1 below, first, 3-iodo-2-propynylbutylcarbamate (IPBC, fungicide) and a polymerizable vinyl monomer such as methyl methacrylate are blended with dilauroyl peroxide (polymerization initiator) to prepare a hydrophobic solution, and water is blended with polyvinyl alcohol (dispersing agent) to prepare an aqueous solution.

Thereafter, the hydrophobic solution is blended with the aqueous solution to prepare a suspension liquid, and thereafter, the temperature of the suspension liquid is increased while stirring to suspension polymerize, thereby producing a suspension liquid of controlled release particles containing IPBC.

In patent document 2 below, 4,5-dichloro-2-n-octyl-4-isothiazoline-3-one (fungicide) is blended with a solvent and polyisocyanate to prepare a hydrophobic solution, and water is blended with polyvinyl alcohol (dispersing agent) to prepare an aqueous solution.

Thereafter, the hydrophobic solution is blended with the aqueous solution to prepare a suspension liquid, and thereafter, polyamine is added to the suspension liquid while stirring and the temperature of the suspension liquid is increased to interfacially polymerize, thereby producing a suspension liquid of controlled release particles containing 4,5-dichloro-2-n-octyl-4-isothiazoline-3-one.

### CITATION LIST

### Patent Documents

Patent Document 1
Japanese Unexamined Patent Publication No. 2011-79816 (WO 2011/030824)
Patent Document 2
Japanese Unexamined Patent Publication No. 2003-48802

### SUMMARY OF THE INVENTION

### Problem to be Solved by the Invention

However, the controlled release particles proposed in patent documents 1 and 2 are produced by suspension polymerization and interfacial polymerization, respectively, and therefore their median size is large, i.e., 1 μm or more. Thus, sedimentation of the controlled release particles may be caused in the suspension liquid to cause caking.

Furthermore, with the controlled release particles proposed in patent document 1, when the IPBC content in the controlled release particles is increased, IPBC may deposit as needle crystal in the suspension liquid over time, which may reduce storage stability.

An object of the present invention is to provide controlled release particles that are excellent in not only controlled release properties but also in dispersiveness, and to provide a producing method thereof.

Furthermore, an object of the present invention is to provide controlled release particles that are excellent in not only controlled release properties, but also in dispersiveness and in storage stability, and to provide a producing method thereof.

### Means for Solving the Problem

The present inventors made an energetic study on the controlled release particles and the producing method thereof of the above object, and found out that controlled release particles that are excellent in not only controlled release properties but also in dispersiveness can be obtained as follows, and as a result of further advancing the study, accomplished a first invention group: a hydrophobic antibiotic compound is dissolved with a hydrophobic polymerizable vinyl monomer to prepare a hydrophobic solution, water is blended with an emulsifier to prepare an aqueous emulsifier solution, the hydrophobic solution is emulsified in the aqueous emulsifier solution, and the polymerizable vinyl monomer in the emulsified hydrophobic solution is polymerized by mini-emulsion polymerization in the presence of a polymerization initiator.

A first invention group relates to:
(1) controlled release particles obtained by

dissolving a hydrophobic antibiotic compound with a hydrophobic polymerizable vinyl monomer to prepare a hydrophobic solution,

blending water with an emulsifier to prepare an aqueous emulsifier solution,

emulsifying the hydrophobic solution in the aqueous emulsifier solution, and

polymerizing the polymerizable vinyl monomer by mini-emulsion polymerization in the presence of a polymerization initiator, thereby producing a polymer containing an antibiotic compound and having an average particle size of below 1 μm; and

(2) a method for producing controlled release particles, the method including the steps of:

dissolving a hydrophobic antibiotic compound with a hydrophobic polymerizable vinyl monomer to prepare a hydrophobic solution,

blending water with an emulsifier to prepare an aqueous emulsifier solution,

emulsifying the hydrophobic solution in the aqueous emulsifier solution, and

polymerizing the polymerizable vinyl monomer in the emulsified hydrophobic solution by mini-emulsion polymerization in the presence of a polymerization initiator, thereby producing a polymer containing an antibiotic compound and having an average particle size of below 1 μm.

Furthermore, the present inventors made an energetic study on the controlled release particles and the producing method thereof of the above-described first invention group, and found out that controlled release particles that are excellent in not only controlled release properties but also in dispersiveness can be obtained as follows, and as a result of further advancing the study, accomplished a second invention group: 3-iodo-2-propynylbutylcarbamate is dissolved with a hydrophobic polymerizable vinyl monomer to prepare a hydrophobic solution; water is blended with an emulsifier to prepare an aqueous emulsifier solution; the hydrophobic solution is emulsified in the aqueous emulsifier solution; the polymerizable vinyl monomer in the emulsified hydrophobic solution is polymerized by mini-emulsion polymerization in the presence of a polymerization initiator.

A second invention group relates to:
(1) controlled release particles obtained by

dissolving 3-iodo-2-propynylbutylcarbamate with a hydrophobic polymerizable vinyl monomer to prepare a hydrophobic solution;

blending water with an emulsifier to prepare an aqueous emulsifier solution;

emulsifying the hydrophobic solution in the aqueous emulsifier solution; and

polymerizing the polymerizable vinyl monomer by mini-emulsion polymerization in the presence of a polymerization initiator, thereby producing a polymer having an average particle size of below 1 μm,

wherein the polymer obtained by the mini-emulsion polymerization has a polar term δ_{p,polymer} of 5.0 to 6.0 [(J/cm³)^{1/2}] of the solubility parameter (δ), and a hydrogen bonding term δ_{h,polymer} of 9.0 to 9.9 [(J/cm³)^{1/2}] of the solubility parameter (δ), the solubility parameter (δ) being defined by Hansen and calculated by van Krevelen and Hoftyzer method;

(2) the controlled release particles of (1) above,

wherein the polymerizable vinyl monomer contains 50 mass % or more of a first monomer, and

50 mass % or more of the first monomer has a character such that the monomer unit composing the polymer obtained from the first monomer has a polar term δ_{p,1st monomer unit(s)} of 5.6 to 6.0 [J/cm³)^{1/2}] of the solubility parameter (δ), and a hydrogen bonding term δ_{h,1st monomer unit(s)} of 9.2 to 9.9 [(J/cm³)^{1/2}] of the solubility parameter (δ),

(3) the controlled release particles of (2) above, wherein the first monomer contains methyl methacrylate and/or ethylene glycol dimethacrylate,
(4) a method for producing controlled release particles, the method comprising the steps of:

dissolving 3-iodo-2-propynylbutylcarbamate with a hydrophobic polymerizable vinyl monomer to prepare a hydrophobic solution;

blending water with an emulsifier to prepare an aqueous emulsifier solution;

emulsifying the hydrophobic solution in the aqueous emulsifier solution; and

polymerizing the polymerizable vinyl monomer in the emulsified hydrophobic solution by mini-emulsion polymerization in the presence of a polymerization initiator, thereby producing a polymer having an average particle size of below 1 μm,

wherein the polymer obtained by the mini-emulsion polymerization has a polar term δ_{p,polymer} of 5.0 to 6.0 [(J/cm³)^{1/2}] of the solubility parameter (δ) and a hydrogen bonding term δ_{h,polymer} of 9.0 to 9.9 [(J/cm³)^{1/2}] of the solubility parameter (6), the solubility parameter (6) being defined by Hansen and calculated by van Krevelen and Hoftyzer method.

Furthermore, the present inventors made an energetic study on the controlled release particles and the producing method thereof of the above-described first invention group, and found out that controlled release particles that are excellent in not only controlled release properties but also in dispersiveness can be obtained and also found out that the thus obtained controlled release particles can be used as a wood treatment agent having excellent properties as follows, and as a result of further advancing the study, accomplished a third invention group:

3-iodo-2-propynylbutylcarbamate and propiconazole are dissolved with a hydrophobic polymerizable vinyl monomer to prepare a hydrophobic solution,
water is blended with an emulsifier to prepare an aqueous emulsifier solution;
the hydrophobic solution is emulsified in the aqueous emulsifier solution; and
the polymerizable vinyl monomer in the emulsified hydrophobic solution is polymerized by mini-emulsion polymerization in the presence of a polymerization initiator.
A third invention group relates to:
(1) controlled release particles obtained by

dissolving at least 3-iodo-2-propynylbutylcarbamate and propiconazole with a hydrophobic polymerizable vinyl monomer to prepare a hydrophobic solution;

blending water with an emulsifier to prepare an aqueous emulsifier solution;

emulsifying the hydrophobic solution in the aqueous emulsifier solution; and

polymerizing the polymerizable vinyl monomer by mini-emulsion polymerization in the presence of a polymerization initiator, thereby producing a polymer containing at least 3-iodo-2-propynylbutylcarbamate and propiconazole and having an average particle size of below 1 μm;

(2) a method for producing controlled release particles, the method comprising the steps of:

dissolving at least 3-iodo-2-propynylbutylcarbamate and propiconazole with a hydrophobic polymerizable vinyl monomer to prepare a hydrophobic solution,

blending water with an emulsifier to prepare an aqueous emulsifier solution,

emulsifying the hydrophobic solution in the aqueous emulsifier solution, and

polymerizing the polymerizable vinyl monomer in the emulsified hydrophobic solution by mini-emulsion polymerization in the presence of a polymerization initiator, thereby producing a polymer containing at least 3-iodo-2-propynylbutylcarbamate and propiconazole and having an average particle size of below 1 μm; and

(3) a wood treatment agent containing the controlled release particles of (1) above.

The present inventors made an energetic study on the controlled release particles and the producing method thereof of the above-described first invention group, and found out that controlled release particles that are excellent in not only controlled release properties but also in dispersiveness and storage stability can be obtained as follows, and as a result of further advancing the study, accomplished a fourth invention group:

3-iodo-2-propynylbutylcarbamate is dissolved with a hydrophobic polymerizable vinyl monomer to prepare a hydrophobic solution,
water is blended with an emulsifier and polyvinyl alcohol (hereinafter referred to as PVA) to prepare an aqueous emulsifier/PVA solution,
the hydrophobic solution is emulsified in the aqueous emulsifier/PVA solution, and
polymerizing the polymerizable vinyl monomer in the emulsified hydrophobic solution by mini-emulsion polymerization in the presence of a polymerization initiator.

The fourth invention group relates to,

(1) controlled release particles obtained by
dissolving 3-iodo-2-propynylbutylcarbamate with a hydrophobic polymerizable vinyl monomer to prepare a hydrophobic solution,
blending water with an emulsifier and PVA to prepare an aqueous emulsifier/PVA solution, emulsifying the hydrophobic solution in the aqueous emulsifier/PVA solution, and
polymerizing the polymerizable vinyl monomer by mini-emulsion polymerization in the presence of a polymerization initiator, thereby producing a polymer having an average particle size of below 1 μm,
wherein the polymer obtained by the mini-emulsion polymerization has a polar term δ_{p,polymer} of 5.0 to 7.0 [(J/cm³)^{1/2}] of the solubility parameter (δ), and has a hydrogen bonding term δ_{h, polymer} of 8.0 to 10.0 [(J/cm³)^{1/2}] of the solubility parameter (δ), the solubility parameter (δ) being defined by Hansen and calculated by van Krevelen and Hoftyzer method;
(2) the controlled release particles of (1) above, wherein the 3-iodo-2-propynylbutylcarbamate content relative to the controlled release particles is 10 to 50 mass %;
(3) the controlled release particles of (1) or (2) above,
wherein the polymerizable vinyl monomer contains 50 mass % or more of a first monomer, and in the polymer obtained from the first monomer, the monomer unit as a constituent of the first monomer has a polar term δ_{p,1st monomer unit(s)} of the solubility parameter (δ) of 5.6 to 6.0 [(J/cm³)^{1/2}], and a hydrogen bonding term δ_{h,1st monomer unit(s)} of the solubility parameter (δ) of 9.2 to 9.9 [(J/cm³)^{1/2}];
(4) the controlled release particles of (3) above, wherein the first monomer contains methyl methacrylate and/or ethylene glycol dimethacrylate;
(5) a method for producing controlled release particles, the method comprising the steps of:
dissolving 3-iodo-2-propynylbutylcarbamate with a hydrophobic polymerizable vinyl monomer to prepare a hydrophobic solution,
blending water with an emulsifier and PVA to prepare an aqueous emulsifier/PVA solution, emulsifying the hydrophobic solution in the aqueous emulsifier/PVA solution, and
polymerizing the polymerizable vinyl monomer in the emulsified hydrophobic solution by mini-emulsion polymerization in the presence of a polymerization initiator, thereby producing a polymer having an average particle size of below 1 μm, wherein the polymer obtained by the mini-emulsion polymerization has a polar term δ_{p,polymer} of 5.0 to 7.0 [(J/cm³)^{1/2}] of the solubility parameter (δ) and a hydrogen bonding term δ_{h,polymer} of the solubility parameter (δ) of 8.0 to 10.0 [(J/cm³)^{1/2}], the solubility parameter (δ) being defined by Hansen and calculated by van Krevelen and Hoftyzer method;
(6) the method for producing controlled release particles of (5), wherein in the step of preparing the hydrophobic solution, an oil-soluble polymerization initiator is blended with a hydrophobic solution, and in the step of polymerizing the polymerizable vinyl monomer by mini-emulsion polymerization, a water-soluble polymerization initiator is further blended after the start of mini-emulsion polymerization.

### Effect of the Invention

In the method for producing controlled release particles of the first invention group, the controlled release particles of the first invention group are obtained by polymerizing the polymerizable vinyl monomer in the emulsified hydrophobic solution by mini-emulsion polymerization in the presence of a polymerization initiator to produce a polymer containing an antibiotic compound and having an average particle size of below 1 μm, and therefore the controlled release particles are excellent in dispersiveness.

Thus, the controlled release particles of the first invention group can be used in various industrial products as controlled release particles that are excellent in not only controlled release properties but also in excellent dispersiveness.

Furthermore, the hydrophobic antibiotic compound can also work as a hydrophobe in the mini-emulsion polymerization, and therefore without blending a hydrophobe especially, the polymer containing an antibiotic compound and having an average particle size of below 1 μm can be produced easily.

In the method for producing controlled release particles of the second invention group, the polymerizable vinyl monomer in the emulsified hydrophobic solution is polymerized by mini-emulsion polymerization in the presence of a polymerization initiator, thereby producing a polymer containing 3-iodo-2-propynylbutylcarbamate and having an average particle size of below 1 μm to obtain controlled release particles of the second invention group, and therefore the controlled release particles are excellent in dispersiveness.

Furthermore, in the controlled release particles of the second invention group, the polymer is set so that the polymer has a polar term δ_{p,polymer} of 5.0 to 6.0 [(J/cm³)^{1/2}] and a hydrogen bonding term δ_{h,polymer} of the solubility parameter (δ) of 9.0 to 9.9 [(J/cm³)^{1/2}], the solubility parameter (δ) being defined by Hansen and calculated by van Krevelen and Hoftyzer method, and therefore miscibility with 3-iodo-2-propynylbutylcarbamate is more significantly excellent. Thus, the polymer contains 3-iodo-2-propynylbutylcarbamate so that 3-iodo-2-propynylbutylcarbamate is homogenously present in the polymer.

Therefore, the controlled release particles of the second invention group can be used in various industrial products as controlled release particles having excellent controlled release properties and excellent dispersiveness.

Furthermore, 3-iodo-2-propynylbutylcarbamate can also work as a hydrophobe in the mini-emulsion polymerization, and therefore a polymer containing 3-iodo-2-propynylbutylcarbamate and having an average particle size of below 1 μm can be obtained easily without blending the hydrophobe especially.

In the method for producing controlled release particles of the third invention group, the polymerizable vinyl monomer in the emulsified hydrophobic solution is polymerized by mini-emulsion polymerization in the presence of a polymerization initiator, thereby producing a polymer containing at least 3-iodo-2-propynylbutylcarbamate and propiconazole and having an average particle size of below 1 μm to obtain controlled release particles of the third invention group, and therefore the controlled release particles are excellent in dispersiveness.

Therefore, the controlled release particles of the third invention group can be suitably used in various industrial products, especially as a wood treatment agent as controlled release particles having not only excellent controlled release properties but also excellent dispersiveness.

Furthermore, at least 3-iodo-2-propynylbutylcarbamate and propiconazole can work also as a hydrophobe in the mini-emulsion polymerization, and therefore a polymer containing an antibiotic compound (at least IPBC and propiconazole) and having an average particle size of below 1 μm can be produced easily without blending the hydrophobe especially.

Furthermore, the controlled release particles of the third invention group contain at least 3-iodo-2-propynylbutylcarbamate and propiconazole having excellent miscibility in the controlled release particles, and therefore a high total antibiotic compound concentration in the controlled release particles can be achieved. Therefore, the controlled release particles can be used as the wood treatment agent of the third invention group having a high dilution rate.

Furthermore, the controlled release particles of the third invention group has an average particle size of below 1 μm, and therefore when treating lumber, the controlled release particles cover the surface of the lumber with a high drug distribution density, and thus the controlled release particles can be used as a wood treatment agent having excellent antiseptic and antifungal effects on lumber.

In the method for producing controlled release particles of the fourth invention group, the polymerizable vinyl monomer in the emulsified hydrophobic solution in the aqueous emulsifier/PVA solution prepared by blending water with an emulsifier and PVA is polymerized by mini-emulsion polymerization in the presence of a polymerization initiator, thereby producing a polymer having an average particle size of below 1 μm and containing 3-iodo-2-propynylbutylcarbamate to obtain controlled release particles of the fourth invention group, and therefore the controlled release particles are excellent in dispersiveness and storage stability.

Furthermore, in the controlled release particles of the fourth invention group, the polar term δ_{p,polymer} of the solubility parameter (δ) of the polymer is set to 5.0 to 7.0 [(J/cm³)^{1/2}], and the hydrogen bonding term δ_{h,polymer} of the solubility parameter (δ) of the polymer is set to 8.0 to 10.0 [(J/cm³)^{1/2}], the solubility parameter (δ) being defined by Hansen and calculated by van Krevelen and Hoftyzer method, and therefore miscibility with 3-iodo-2-propynylbutylcarbamate is more significantly excellent. Therefore, the polymer contains 3-iodo-2-propynylbutylcarbamate so that 3-iodo-2-propynylbutylcarbamate is homogenously present in the polymer.

Thus, the controlled release particles of the fourth invention group can be used in various industrial products as controlled release particles having excellent controlled release properties, dispersiveness, and storage stability.

Furthermore, 3-iodo-2-propynylbutylcarbamate can also work as a hydrophobe in the mini-emulsion polymerization, and therefore without blending the hydrophobe especially, a polymer containing 3-iodo-2-propynylbutylcarbamate and having an average particle size of below 1 μm can be produced easily.

### BRIEF DESCRIPTION OF THE DRAWINGS

FIG. A1 shows an image-processed SEM photograph of controlled release particles of Example A2.

FIG. A2 shows an image-processed SEM photograph of controlled release particles of Example A2.

FIG. A3 shows an image-processed TEM photograph of controlled release particles of Example A2.

FIG. A4 shows an image-processed TEM photograph of controlled release particles of Example A2.

FIG. A5 shows an image-processed TEM photograph of controlled release particles of Example A4.

FIG. A6 shows an image-processed TEM photograph of controlled release particles of Example A4.

FIG. A7 shows an image-processed TEM photograph of controlled release particles of Example A5.

FIG. A8 shows an image-processed TEM photograph of controlled release particles of Example A5.

FIG. A9 shows an image-processed TEM photograph of controlled release particles of Example A6.

FIG. A10 shows an image-processed TEM photograph of controlled release particles of Example A6.

FIG. A11 shows an image-processed TEM photograph of controlled release particles of Example A7.

FIG. A12 shows an image-processed TEM photograph of controlled release particles of Example A7.

FIG. A13 shows an image-processed TEM photograph of controlled release particles of Example A8.

FIG. A14 shows an image-processed TEM photograph of controlled release particles of Example A8.

FIG. A15 shows an image-processed TEM photograph of controlled release particles of Example A9.

FIG. A16 shows an image-processed TEM photograph of controlled release particles of Example A9.

FIG. A17 shows an image-processed TEM photograph of controlled release particles of Example A11.

FIG. A18 shows an image-processed TEM photograph of controlled release particles of Example A11.

FIG. A19 shows an image-processed TEM photograph of controlled release particles of Example A12.

FIG. A20 shows an image-processed TEM photograph of controlled release particles of Example A12.

FIG. A21 shows a graph of controlled release properties test in Example A1, Example A2, and Comparative Example A4 and Comparative Example A5.

FIG. A22 shows a graph of controlled release properties test in Example A3.

FIG. A23 shows a graph of controlled release properties test in Example A5.

FIG. A24 shows a graph of controlled release properties test in Example A6.

FIG. A25 shows a graph of controlled release properties test in Example A7.

FIG. A26 shows a graph of controlled release properties test in Example A8.

FIG. A27 shows a perspective view of a frame coupled unit used in a controlled release properties test of Example A10.

FIG. A28 shows a front cross-sectional view of an insect cage used in controlled release properties test of Example A10.

FIG. A29 shows a graph of controlled release properties test in Example A11.

FIG. A30 shows a graph of controlled release properties test in Example A12.

FIG. B1 shows an image-processed SEM photograph of controlled release particles of Example B2.

FIG. B2 shows an image-processed SEM photograph of controlled release particles of Example B2.

FIG. B3 shows an image-processed TEM photograph of controlled release particles of Example B2.

FIG. B4 shows an image-processed TEM photograph of controlled release particles of Example B2.

FIG. B5 shows a graph of controlled release properties tests in Example B1, Example B2, and Comparative Example B3.

FIG. C1 shows an image-processed TEM photograph of controlled release particles of Example C8.

FIG. C2 shows an image-processed TEM photograph of controlled release particles of Example C8.

FIG. D1 shows an image-processed TEM photograph of controlled release particles of Example D2.

FIG. D2 shows an image-processed TEM photograph of controlled release particles of Example D2.

FIG. D3 shows a graph of controlled release properties test in Example D1 and Example D2.

### EMBODIMENT OF THE INVENTION

In the following, first to fourth embodiments included in the present invention are described in sequence: the first to fourth embodiments correspond to first to fourth invention groups, respectively, and they are interrelated.

### First Embodiment

Controlled release particles of the first embodiment are obtained as follows: a hydrophobic antibiotic compound is dissolved with a hydrophobic polymerizable vinyl monomer to prepare a hydrophobic solution; separately, water is blended with an emulsifier to prepare an aqueous emulsifier solution; then, the hydrophobic solution is emulsified in the aqueous emulsifier solution; and thereafter, the polymerizable vinyl monomer is polymerized by mini-emulsion polymerization in the presence of a polymerization initiator, thereby producing a polymer containing an antibiotic compound.

The antibiotic compound works as a hydrophobe (co-stabilizer) in the mini-emulsion polymerization. To be specific, the antibiotic compound contributes to stabilization of mini-emulsion (described later) in the mini-emulsion polymerization, preventing Ostwald ripening, and suppressing enlargement (increase in particle size) of mini-emulsion particles.

The antibiotic compound has, for example, at least two functional moieties that are capable of interacting with the polymer of the polymerizable vinyl monomer.

Examples of such functional moieties include polar functional groups such as a carbonyl group, a nitro group, an amino group, a cyano group, a phosphate group, and a carboxyl group; polar bonds containing a polar group such as a carboxylate bond, a phosphate bond, a urea bond, and a carbon-halogen bond; and conjugated cyclic portions such as a benzene ring, and further a conjugated heterocyclic ring such as a triazine ring, an imidazole ring, and an isothiazoline ring.

The antibiotic compound has a molecular weight of, for example, 150 to 600, preferably 180 to 500.

When the antibiotic compound has a molecular weight exceeding the above-described range, miscibility of the antibiotic compound with the polymer may be reduced. On the other hand, when the antibiotic compound has a molecular weight below the above-described range, there is a case where the antibiotic compound leaks out in the aqueous phase during mini-emulsion polymerization, and after the mini-emulsion polymerization, the antibiotic compound separates out, forming another particle, and aggregating or solidifying the emulsion.

The antibiotic compound has a melting point of, for example, 100° C. or less, preferably 90° C. or less, and more preferably 80° C. or less. When the antibiotic compound has a melting point exceeding the above-described range, there may be a case where the antibiotic compound is not easily encapsulated in the controlled release particles and separates out to outside the controlled release particles, and even if the antibiotic compound is encapsulated in the controlled release particles, the controlled release particles may deposit and phase separation may occur during the mini-emulsion polymerization as solid from the polymer in the particles, and controlled-release of the antibiotic compound to the outside the controlled release particles may not be allowed.

To be specific, the antibiotic compound is selected from a sterilizer, an antibacterial agent, an antiseptic, an antialgae, a fungicide, a herbicide, an insect repellent, an insecticide, an attractant, a repellent, a rodenticide, etc. having antibiotic activity such as, for example, sterilizing, antibacterial, antiseptic, antialgae, antifungal, and insecticidal activity. Examples of these compounds having antibiotic activity include sterilizing antiseptic antialgae fungicides such as an iodine compound, a triazole compound, a carbamoyl imidazole compound, a dithiol compound, an isothiazoline compound, a nitro alcohol compound, and p-hydroxybenzoate; and insect repellents (insect killers) such as a pyrethroid compound, a neonicotinoid compound, an organic chlorine compound, an organic phosphorus compound, a carbamate compound, and an oxadiazine compound.

Examples of iodine compounds include 3-iodo-2-propynylbutylcarbamate (IPBC), 1-[[(3-iodo-2-propynyl)oxy]methoxy]-4-methoxybenzene, and 3-bromo-2,3-diiodo-2-propenyl ethyl carbonate.

Examples of triazole compounds include 1-[2-(2,4-dichlorophenyl)-4-n-propyl-1,3-dioxolane-2-ylmethyl]-1H-1,2,4-triazole (propiconazole), and bis(4-fluorophenyl)methyl (1H-1,2,4-triazole-1-ylmethylsliane (also called: flusilazole, 1-[[bis(4-fluorophenyl)methylsilyl]methyl]-1H-1,2,4-triazole).

Examples of carbamoyl imidazole compounds include N-propyl-N-[2-(2,4,6-trichloro-phenoxy)ethyl]imidazole-1-carboxamide (prochloraz).

Examples of dithiol compounds include 4,5-dichloro-1,2-dithiol-3-one.

Examples of isothiazoline compounds include 2-n-octyl-4-isothiazoline-3-one (OIT) and 5-chloro-2-methyl-4-isothiazoline-3-one (Cl-MIT).

Examples of nitro alcohol compounds include 2,2-dibromo-2-nitro-1-ethanol (DBNE).

Examples of p-hydroxybenzoates include butyl p-hydroxybenzoate and propyl p-hydroxybenzoate.

Examples of pyrethroid compounds include pyrethrin obtained from pyrethrum, cinerin, and jasmoline; and also include allethrin, bifenthrin, acrinathrin, permethrin (3-phenoxybenzyl(1RS,3RS; 1RS,3SR)-3-(2,2-dichlorovinyl)-2,2-dimethylcyclopropanecarboxylate), α-cypermethrin, tralomethrin, cyfluthrin ((RS)-α-cyano-4-fluoro-3-phenoxybenzyl-(1RS,3RS)-(1RS,3RS)-3-(2,2-dichlorovinyl)-2,2-dimethylcyclopropane carboxylate, to be specific, a mixture of isomer I ((1R-3R-αR)+(1S-3S-αS)) [melting point: 57° C.], isomer II ((1R-3R—S)+(1S-3S-αR))[melting point: 74° C.], and isomer III ((1R-3S-αR)+(1S-3R-αS)))[melting point: 66° C.]), cyphenothrin, prallethrin, ethofenprox (2-(4-ethoxyphenyl)-2-methylpropyl-3-phenoxybenzylether), silafluofen, and fenvalerate derived therefrom.

Examples of neonicotinoid compounds include (E)-N¹-[(6-chloro-3-pyridyl)methyl]-N²-cyano-N¹-methylacetamidine (acetamiprid).

Examples of organic chlorine compounds include Kelthane.

Examples of organic phosphorus compounds include phoxim, pyridaphenthion, fenitrothion, tetrachlorvinphos, dichlofenthion, and propetamphos.

Examples of carbamate compounds include fenobucarb and propoxur.

Examples of oxadiazon compounds include indoxacarb.

Examples of herbicides include pyraclonil, pendimethalin, and indanofan.

Examples of insecticides include pyriproxyfen.

Examples of repellents include DEET (N,N-diethyl-m-toluamide).

The antibiotic compound is substantially hydrophobic, and, for example, has a quite low water solubility at room temperature (20 to 30° C., to be more specific, 25° C.), to be specific, for example, a solubility at room temperature of, on a mass basis, 1 part by mass/100 parts by mass of water (10000 ppm) or less, preferably 0.5 parts by mass/100 parts by mass of water (5000 ppm) or less, and more preferably 0.1 parts by mass/100 parts by mass of water (1000 ppm) or less; and on a volume basis, for example, 1 g/100 mL of water or less, preferably 0.5 g/100 mL of water or less, and more preferably 0.1 g/100 mL of water or less.

When the antibiotic compound has a water solubility exceeding the above-described range, when polymerizing the polymerizable vinyl monomer by mini-emulsion polymerization, it does not work as a hydrophobe, and therefore enlargement of the polymerizable vinyl monomer droplet (oil droplet) occurs, and therefore retaining the average particle size at the time of emulsifying and synthesis of controlled release particles sufficiently encapsulating the antibiotic compound becomes difficult.

These antibiotic compounds can be used alone or in combination of two or more.

The above-described antibiotic compound may contain, for example, in the production processes, impurities having a melting point of outside the above-described range at an appropriate proportion. To be specific, a mixture of isomer I (melting point: 57° C.), isomer II (melting point: 74° C.), and isomer III (melting point: 66° C.) of cyfluthrin contains, for example, an impurity of isomer IV (melting point 102° C.).

The polymerizable vinyl monomer is, for example, a polymerizable monomer having at least one polymerizable carbon-carbon double bond in its molecule.

To be specific, examples of polymerizable vinyl monomers include a (meth)acrylate monomer, a (meth)acrylic acid monomer, an aromatic vinyl monomer, a vinyl ester monomer, a maleate monomer, vinyl halide, vinylidene halide, and a nitrogen-containing vinyl monomer.

Examples of (meth)acrylate monomers include methacrylates and acrylates, to be specific, alkyl (meth)acrylate having an alkyl moiety with 1 to 20 carbon atoms including methyl (meth)acrylate, ethyl (meth)acrylate, n-propyl (meth)acrylate, iso-propyl (meth)acrylate, n-butyl (meth)acrylate, iso-butyl (meth)acrylate, tert-butyl (meth)acrylate, and cyclohexyl (meth)acrylate; alkoxyalkyl (meth)acrylate such as 2-methoxyethyl (meth)acrylate; and hydroxyalkyl (meth)acrylate such as hydroxyethyl (meth)acrylate. Preferably, alkyl (meth)acrylate is used.

Examples of (meth)acrylic acid monomers include methacrylic acid and acrylic acid.

Examples of aromatic vinyl monomers include styrene, p-methylstyrene, o-methylstyrene, and α-methylstyrene.

Examples of vinyl ester monomers include vinyl acetate and vinyl propionate.

Examples of maleate monomers include dimethyl maleate, diethyl maleate, and dibutyl maleate.

Examples of vinyl halides include vinyl chloride and vinyl fluoride.

Examples of vinylidene halides include vinylidene chloride and vinylidene fluoride.

Examples of nitrogen-containing vinyl monomers include (meth)acrylonitrile, N-phenylmaleimide, and vinylpyridine.

The polymerizable vinyl monomer is substantially hydrophobic, and for example, has a significantly low water solubility at room temperature, to be specific, a solubility at room temperature of, for example, 10 parts by mass/100 parts by mass of water or less, preferably 8 parts by mass/100 parts by mass of water or less. When different types of polymerizable vinyl monomers are used in combination, the whole polymerizable vinyl monomer (that is, a mixture of different type of polymerizable vinyl monomers) is substantially hydrophobic.

Of the above-described polymerizable vinyl monomers, for example, an antibiotic compound-miscible monomer (hereinafter sometimes simply referred to as a miscible monomer) that is highly (or excellently) miscible with the above-described antibiotic compound and is capable of dissolving the antibiotic compound is selected.

Examples of miscible monomers include preferably a (meth)acrylate monomer.

These miscible monomers can be used alone or in combination of two or more.

For the (meth)acrylate monomer, preferably, alkyl methacrylate having an alkyl moiety of 1 to 3 carbon atoms is used, even more preferably, methyl methacrylate (MMA) is used singly.

Furthermore, preferably, alkyl methacrylate having an alkyl moiety of 1 to 3 carbon atoms is used in combination with alkyl (meth)acrylate having an alkyl moiety of 4 to 8 carbon atoms, even more preferably, methyl methacrylate is used in combination with butyl (meth) acrylate, particularly preferably, MMA is used in combination with isobutyl methacrylate.

When two types of (meth)acrylate monomers (to be specific, alkyl methacrylate having an alkyl moiety of 1 to 3 carbon atoms and alkyl (meth)acrylate having an alkyl moiety of 4 to 8 carbon atoms) are used in combination, the mixing ratio of the two types of (meth)acrylate monomers is such that for example, 50 parts by mass or more, preferably 60 parts by mass or more, even more preferably 65 parts by mass or more of the alkyl methacrylate having an alkyl moiety of 1 to 3 carbon atoms is mixed relative to 100 parts by mass of the (meth)acrylate monomers in total, and for example, below 100 parts by mass of the alkyl methacrylate having an alkyl moiety of 1 to 3 carbon atoms is mixed relative to 100 parts by mass of the (meth)acrylate monomers in total.

The (meth)acrylic acid monomer functions to increase colloid stability of the copolymer emulsion, and sometimes is included as a part of the miscible monomer to obtain such effects. The mixing ratio of the (meth)acrylic acid monomer in such a case is, for example, 0.1 to 20 parts by mass, preferably 0.5 to 10 parts by mass, even more preferably, 1 to 5 parts by mass relative to 100 parts by mass of the polymerizable vinyl monomer.

A combination of the antibiotic compound and the miscible monomer is selected so that the polymer of the polymerizable vinyl monomer and the antibiotic compound are miscible at a polymerization temperature (heating temperature) to be described later.

The polymerizable vinyl monomer can contain a crosslinkable monomer as the miscible monomer.

The crosslinkable monomer is blended as necessary to adjust controlled release properties of the controlled release particles, and examples of the crosslinkable monomer include mono or polyethylene glycol di(meth)acrylate such as ethylene glycol di(meth)acrylate and diethylene glycol di(meth)acrylate; alkane diol di(meth)acrylate such as 1,3-propanediol di(meth)acrylate, 1,4-butanediol di(meth)acrylate, and 1,5-pentanediol di(meth)acrylate; alkane polyol poly (meth)acrylate such as trimethylolpropane tri(meth)acrylate and pentaerythritol tetra(meth)acrylate; allyl monomers such as allyl (meth) methacrylate, and triallyl (iso)cyanurate; and divinyl monomers such as divinylbenzene.

For the crosslinkable monomer, preferably, ethylene glycol di(meth)acrylate is used, even more preferably, ethylene glycol dimethacrylate is used.

The mixing ratio of the crosslinkable monomer relative to 100 parts by mass of the polymerizable vinyl monomer (miscible monomer) is, for example, 1 to 80 parts by mass, preferably 2 to 50 parts by mass, even more preferably 5 to 20 parts by mass.

For the antibiotic compound and the polymerizable vinyl monomer, the following combination is selected: an antibiotic compound having a polar term δ_{p,compound} of the solubility parameter (δ) of, for example, 2 to 8 [(J/cm³)^{1/2}], preferably 3 to 7 [(J/cm³)^{1/2}], and a hydrogen bonding term δ_{h,compound} of the solubility parameter (δ) of, for example, 5.5 to 9.5 [(J/cm³)^{1/2}], preferably 5.8 to 9.5 [(J/cm³)^{1/2}]; and a polymerizable vinyl monomer that produces a polymer having a polar term δ_{p,polymer} of the solubility parameter (δ) of, for example, 5 to 7 [(J/cm³)^{1/2}], preferably 5 to 6.5 [(J/cm³)^{1/2}], and a hydrogen bonding term δ_{h,polymer} of the solubility parameter (δ) of, for example, 8 to 10 [(J/cm³)^{1/2}], preferably 8.5 to 10 [(J/cm³)^{1/2}].

The polar term δₚ and hydrogen bonding term δₕ of the solubility parameter (δ) is defined by Hansen and calculated by van Krevelen and Hoftyzer method, and to be specific, described in Japanese Unexamined Patent Publication No. 2011-79816 (WO 2011/030824).

The indexes “compound” and “polymer” in each term δ (δₚ and δₕ) represent the antibiotic compound and the polymer, respectively.

When the polar term δ_{p,polymer} and/or the hydrogen bonding term δ_{h,polymer} of the polymer is below the above-described range, there may be a case where hydrophobicity of the polymer becomes excessively high and sufficient miscibility with the antibiotic compound cannot be obtained, and even if miscibility could be obtained, the antibiotic compound leaks to the outside of the controlled release particles during mini-emulsion polymerization, making synthesis of controlled release particles in which the antibiotic compound is sufficiently contained difficult.

On the other hand, when the polar term δ_{p,polymer} and/or the hydrogen bonding term δ_{h,polymer} of the polymer exceeds the above-described range, there may be a case where hydrophilicity of the polymer becomes excessively high and sufficient miscibility with the antibiotic compound cannot be obtained, and even if miscibility could be obtained, interfacial free energy with the aqueous phase in the mini-emulsion polymerization may be lowered, and antibiotic compound may leak to the outside of the controlled release particles during the mini-emulsion polymerization, making synthesis of controlled release particles in which the antibiotic compound is sufficiently contained difficult.

Meanwhile, when the polar term δ_{p,compound} and/or the hydrogen bonding term δ_{h,compound} of the antibiotic compound is below the above-described range, there may be a case where hydrophobicity of the antibiotic compound becomes excessively high and sufficient miscibility with the polymer cannot be obtained.

On the other hand, when the polar term δ_{p,compound} and/or the hydrogen bonding term δ_{h,compound} of the antibiotic compound exceed the above-described range, there may be a case where hydrophilicity of the antibiotic compound becomes excessively high and the antibiotic compound easily may leak to the outside of the controlled release particles, making synthesis of the controlled release particles in which the antibiotic compound is sufficiently contained difficult.

In the solubility parameter (δ), the value of Δδₚ (=(δ_{p,polymer}−δ_{p,compound}) deducting the polar term δ_{p,compound} of the antibiotic compound from the polar term δ_{p,polymer} of the polymer is, for example, −1.1 to 2.8 [(J/cm³)^{1/2}].

The value of Δδh (=δ_{h,polymer}−δ_{h,compound}) deducting the hydrogen bonding term δ_{h,compound} of the antibiotic compound from the hydrogen bonding term δ_{h,polymer} of the polymer is, for example, −0.1 to 4.2 [(J/cm³)^{1/2}].

When Δδp and Δδh are within the above-described range, excellent miscibility of the antibiotic compound and the polymer can be ensured, ensuring excellent controlled release properties.

When the polar term δ_{p,compound} and the hydrogen bonding term δ_{h,compound} of the antibiotic compound are within the above-described range, and the polar term δ_{p,polymer} and the hydrogen bonding term δ_{h,polymer} of the polymer are within the above-described range, the antibiotic compound is defined as being miscible with (dissolved in) the polymer without leaking from the controlled release particles during mini-emulsion polymerization. That is, the antibiotic compound is contained in the polymer.

Examples of emulsifiers include those emulsifiers generally used in mini-emulsion polymerization, such as anionic emulsifiers including sodium dioctyl sulfosuccinate, sodium dodecylbenzene sulphonate, sodium lauryl sulfate, sodium dodecyl diphenyl ether disulphonate, sodium nonyl diphenyl ether sulfonate, and sodium naphthalene sulfonate formaldehyde condensate.

Examples of emulsifiers also include non-ionic emulsifiers such as polyoxyalkylenealkylether, polyoxyalkylenealkylarylether, polyoxyalkylenearalkylarylether, a polyoxyalkylene block copolymer, and polyoxyalkylenearylether.

Examples of polyoxyalkylenealkylether include polyoxyethylenealkylether.

Examples of polyoxyalkylenealkylarylether include polyoxyethylenenonylphenylether and polyoxyethyleneoctylphenylether.

Examples of polyoxyalkylenearalkylarylether include polyoxyethylene styrenated phenylether (for example, NOIGEN EA-177 (manufactured by Dai-ichi Kogyo Seiyaku Co., Ltd.)).

Examples of polyoxyalkylene block copolymers include a polyoxyethylene-polyoxypropylene block copolymer.

Examples of polyoxyalkylenearylether include polyoxyethylenearylether.

The HLB of the non-ionic emulsifier is, for example, 11 to 20, preferably 12 to 19, even more preferably 13 to 18.

The HLB is calculated by Griffin's formula represented by formula (I) below.

HLB=20×(sum total of formula weight of hydrophilic portion/molecular weight) (1)

Examples of non-ionic emulsifiers include, preferably, polyoxyalkylenearalkylarylether.

The emulsifier can be used singly, or can be used in combination of two or more. Preferably, an anionic emulsifier and a non-ionic emulsifier are used in combination, even more preferably, sodium dioctyl sulfosuccinate and polyoxyalkylenearalkylarylether are used in combination.

When the anionic emulsifier and the non-ionic emulsifier are used in combination, the mixing ratio of the anionic emulsifier relative to the emulsifier is, for example, 10 to 60 mass %, preferably 15 to 50 mass %, and the mixing ratio of the non-ionic emulsifier relative to the emulsifier is, for example, 40 to 90 mass %, preferably 50 to 85 mass %.

The emulsifier can also be prepared as an emulsifier-containing aqueous solution by dissolving the emulsifier in water in advance at a suitable ratio. The mixing ratio of the emulsifier relative to the emulsifier-containing aqueous solution is, for example, 10 to 90 mass %, preferably 20 to 80 mass %.

For the polymerization initiator, a polymerization initiator generally used in mini-emulsion polymerization may be used, and examples thereof include an oil-soluble polymerization initiator and a water-soluble polymerization initiator.

Examples of oil-soluble polymerization initiators include oil-soluble organic peroxide such as dilauroyl peroxide, 1,1,3,3-tetramethylbutylperoxy-2-ethylhexanoate, t-hexylperoxy-2-ethylhexanoate, diisopropylperoxydicarbonate, and benzoyl peroxide, and oil-soluble azo compounds such as 2,2′-azobisisobutyronitrile, 2,2′-azobis(2,4-dimethylvaleronitrile), and 2,2′-azobis (2-methylbutyronitrile).

Examples of water-soluble polymerization initiators include water-soluble azo compounds such as 2,2′-azobis(2-methylpropioneamidine)disulfate, 2,2′-azobis(2-methylpropioneamidine)dihydrochloride, 2,2′-azobis(2-amidinopropane)dihydrochloride, 2,2′-azobis[N-(2-carboxyethyl)-2-methylpropioneamidine]hydrate, 2,2′-azobis(N,N′-dimethyleneisobutylamidine), 2,2′-azobis{2-[1-(2-hydroxyethyl)-2-imidazoline-2-yl]propane}dihydrochloride, 2,2′-azobis(1-imino-1-pyrrolidino-2-methylpropane)dihydrochloride, 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis[2-(2-imidazoline-2-yl)propane], 2,2′-azobis[2-(2-imidazoline-2-yl)propane]dihydrochloride, and 2,2′-azobis[2-(2-imidazoline-2-yl)propane]disulfatedihydrate; persulfate compounds such as potassium persulfate, sodium persulfate, and ammonium persulfate; water-soluble inorganic peroxides such as hydrogen peroxide; water-soluble organic peroxides such as tert-butylperoxide, and cumene peroxide. Furthermore, examples of water-soluble polymerization initiators include redox water-soluble polymerization initiators in which a water-soluble polymerization initiator excluding the water-soluble azo compound is combined with a water-soluble reducing agent such as ascorbic acid, sodium bisulfite/sodium hydrogen sulfite, sodium hyposulfite, sodium hydrogen sulfite, sodium sulfite, sodium hydrogen sulfite, sodium hydroxymethylsulfinate (Rongalite), thiourea dioxide, sodium thiosulfate, ferrous salts, monovalent copper salts, and amines.

The polymerization initiator can be used singly or in combination of two or more.

Preferably, an oil-soluble polymerization initiator, even more preferably, oil-soluble organic peroxide is used.

In a method for producing controlled release particles of the first embodiment, first, a hydrophobic solution is prepared by dissolving a hydrophobic antibiotic compound with a hydrophobic polymerizable vinyl monomer.

That is, an antibiotic compound is blended with a polymerizable vinyl monomer, and the mixture is stirred homogenously, thereby producing a hydrophobic solution.

The hydrophobic solution is prepared without blending, for example, a solvent (a hydrophobic organic solvent such as hexane, toluene, and ethyl acetate) for the antibiotic compound, and/or a hydrophobe (a co-stabilizer such as hexadecane, cetyl alcohol). This allows for reduction in environmental stress.

The mixing ratio of the antibiotic compound relative to the polymerizable vinyl monomer is, on a mass basis (that is, parts by mass of the antibiotic compound/parts by mass of the polymerizable vinyl monomer), for example, 0.01 to 4.0, preferably 0.05 to 3.0.

Preparation of the hydrophobic solution may be performed, for example, at normal temperature, or can be performed by heating to increase the speed of dissolving the antibiotic compound in the polymerizable vinyl monomer, further to increase solubility when the solubility of the antibiotic compound is insufficient at normal temperature.

The heating temperature is, for example, 30 to 100° C., preferably 40 to 80° C.

When an oil-soluble polymerization initiator is used as the polymerization initiator in preparation of the hydrophobic solution, an oil-soluble polymerization initiator is blended along with an antibiotic compound and a polymerizable vinyl monomer. Blending of the oil-soluble polymerization initiator is preferably performed at normal temperature. When the antibiotic compound and the polymerizable vinyl monomer are blended, and the mixture is heated to dissolve the antibiotic compound in the polymerizable vinyl monomer, the solution after the dissolving is cooled to room temperature, or cooled to a temperature higher than the temperature under which the dissolved antibiotic compound does not deposit, and thereafter, the oil-soluble polymerization initiator is blended.

The mixing ratio of the oil-soluble polymerization initiator relative to 100 parts by mass of the polymerizable vinyl monomer is, for example, 0.01 parts by mass or more, preferably 0.1 parts by mass or more, and for example, 5 parts by mass or less, preferably 3 parts by mass or less.

When the mixing ratio of the oil-soluble polymerization initiator is more than the above-described upper limit, the molecular weight of the polymer may be reduced excessively, and when the mixing ratio of the oil-soluble polymerization initiator is below the above-described lower limit, the conversion rate may not be improved sufficiently, and unreacted polymerizable vinyl monomer may remain.

In the method for producing controlled release particles of the first embodiment, separately, an aqueous emulsifier solution is prepared by blending water with an emulsifier.

To be specific, water is blended with an emulsifier, and the mixture is stirred homogenously, thereby producing an aqueous emulsifier solution.

The amount of the emulsifier is selected so that the amount is sufficient for the emulsifier to be adsorbed onto the entire surface of the droplets of emulsified hydrophobic solution, and allows for suppression of generation of emulsion polymerization particles of new polymerizable vinyl monomer that does not contain the antibiotic compound due to the presence of excessive emulsifier, and although it is different depending on the type of the emulsifier, for example, 0.1 to 20 mass %, preferably 0.2 to 10 mass % of the emulsifier is blended as an active component amount of the emulsifier relative to the hydrophobic solution.

Preparation of the aqueous emulsifier solution may be performed, for example, at normal temperature, or by heating, as necessary.

The heating temperature is, for example, 30 to 100° C., preferably 40 to 80° C.

When a water-soluble polymerization initiator is used as the polymerization initiator in preparation of the aqueous emulsifier solution, a water-soluble polymerization initiator is blended along with water and the emulsifier. Blending of the water-soluble polymerization initiator is performed preferably at normal temperature. When the emulsifier is dissolved in water by blending water and the emulsifier, and by heating the mixture, the aqueous solution is cooled to room temperature, and thereafter, the water-soluble polymerization initiator is blended.

The mixing ratio of the water-soluble polymerization initiator relative 100 parts by mass of water is, for example, 0.01 parts by mass or more, preferably 0.1 parts by mass or more, and for example, 5 parts by mass or less, preferably 3 parts by mass or less.

When the mixing ratio of the water-soluble polymerization initiator is more than the above-described upper limit, the molecular weight of the polymer may be reduced excessively, and when the mixing ratio of the water-soluble polymerization initiator is below the above-described lower limit, the conversion rate may not be improved sufficiently, and unreacted polymerizable vinyl monomer may remain.

In the aqueous emulsifier solution, polyvinyl alcohol (hereinafter referred to as “PVA”) may be blended.

PVA is a dispersing agent blended in an aqueous phase for forming a protective colloid in the mini-emulsion, and for example, is produced by saponifying a polyvinyl acetate polymer produced by polymerizing a vinyl monomer mainly composed of vinyl acetate by a suitable method.

By blending PVA in the aqueous emulsifier solution, the protective colloid of PVA allows for formation of a stable hydration sphere, and hinders aggregation of particles due to collision between particles. Thus, for example, in the formulation with a small amount of emulsifier as well, polymerization stability can be improved, for example, by decreasing the amount of aggregate in the mini-emulsion polymerization, and preventing unstable mini-emulsion polymerization particles due to the polymerization initiator (including redox water-soluble polymerization initiator) added to decrease the remaining monomer amount at a terminating period of polymerization. Furthermore, colloid stability can be improved, for example, by preventing aggregation and caking of controlled release particles during long-term storage, and by preventing aggregation of controlled release particles even in the case where the controlled release particles are diluted with water and allowed to pass through a pump or a nozzle with a high shearing force when used as a wood treatment agent (described later).

The degree of saponification of PVA is, for example, 70% or more, preferably 80% or more, and for example, 99% or less, preferably 90% or less.

The average degree of polymerization of PVA is, for example, 300 or more, preferably 500 or more, and for example, 4000 or less, preferably 2500 or less.

The viscosity of PVA in a 4% aqueous solution at 20° C. is, for example, 3 mPa·sec or more, preferably 5 mPa·sec or more, and for example, 100 mPa·sec or less, preferably 50 mPa·sec or less.

The viscosity of PVA can be measured by using 4% aqueous solution of PVA at 20° C. with a B-type viscometer.

The mixing ratio of the PVA is, when PVA is used, selected so that the amount is sufficient for PVA to be adsorbed to the entire surface of the emulsified droplets of hydrophobic solution, and although it is different depending of the type of PVA, for example, 0.5 to 10 mass %, preferably 1 to 8 mass % relative to the hydrophobic solution is blended as an active component amount of PVA.

Preparation of the aqueous PVA solution may be performed, for example, by introducing PVA into cold water of 25° C. or less with stirring to be dispersed, and dissolving PVA therein by increasing the temperature to 60 to 90° C. After confirming that PVA is dissolved completely in water, the mixture is cooled to room temperature.

The aqueous emulsifier solution can contain a dispersing agent other than PVA.

Examples of dispersing agents include a condensate of aromatic sulfonic acid and formaldehyde, and polycarboxylic acid oligomer, and preferably, a condensate of aromatic sulfonic acid and formaldehyde is used.

Examples of condensates of aromatic sulfonic acid and formaldehyde sodium salt of include β-sodium naphthalene sulfonate formaldehyde condensates.

These dispersing agents can be used singly, or can be used in combination of two or more.

The mixing ratio of the dispersing agent relative to, for example, the hydrophobic solution is, for example, 0.001 mass % or more, preferably 0.01 mass % or more, and for example, 0.5 mass % or less, preferably 0.3 mass % or less, more preferably, 0.2 mass % or less.

In the method for producing controlled release particles of the first embodiment, then, the hydrophobic solution is emulsified in the aqueous emulsifier solution.

To be specific, the hydrophobic solution is blended in an aqueous emulsifier solution, and by applying a high shearing force to the mixture, the hydrophobic solution is emulsified in the aqueous emulsifier solution, thereby preparing a mini-emulsion.

In the emulsification of the hydrophobic solution, for example, an emulsifier such as homomixer, an ultrasonic homogenizer, a pressurized homogenizer, Milder, or a porous membrane injection emulsifier is used, and preferably, a homomixer is used.

The stirring conditions are set suitably, and when a homomixer is used, the number of revolution is set, for example, to 6000 rpm or more, preferably 8000 rpm or more, even more preferably 10000 rpm or more, and for example, 30000 rpm or less.

When the number of revolution is below the above-described lower limit, mini-emulsion particles having a particle size of below 1 μm may not be formed.

The stirring time is, for example, 1 minute or more, preferably 2 minutes or more, and 1 hour or less.

Preparation of the mini-emulsion may be performed, for example, at normal temperature, or can be performed by heating. The heating can also be performed at the time of emulsification. The heating temperature is, for example, the heating temperature at the time of preparation of the above-described hydrophobic solution and/or aqueous emulsifier solution or more, to be specific, 30 to 100° C., preferably 40 to 80° C.

The mixing ratio of the hydrophobic solution relative to 100 parts by mass of the aqueous emulsifier solution is, for example, 10 to 150 parts by mass, preferably 25 to 90 parts by mass.

A mini-emulsion of hydrophobic solution is prepared by the above-described method. In the mini-emulsion of hydrophobic solution, the emulsifier is adsorbed onto the mini-emulsion particles (emulsified droplets of hydrophobic solution), and in the aqueous medium, mini-emulsion particles of hydrophobic solution having an average particle size below 1 μm are formed.

The average particle size of the mini-emulsion particles (median size, described later) is adjusted to, for example, below 1 μm, preferably 750 nm or less, even more preferably, 500 nm or less, particularly preferably 400 nm or less, most preferably 300 nm or less, and for example, 50 nm or more.

The emulsifier is adsorbed onto the surface of the mini-emulsion particles, and this allows for stabilization of the mini-emulsion.

Thus, the mini-emulsion prepared by stirring is allowed to stand, and then can be used for a next mini-emulsion polymerization. In such a case, the mini-emulsion can be allowed to stand for, for example, 24 hours or more.

The average particle size of the mini-emulsion particles does not substantially change over time, or the changing rate is significantly low.

To be specific, the ratio of the average particle size after 24 hours passed from the preparation (allowed to stand at room temperature) relative to the average particle size after 20 minutes (allowed to stand at room temperature) (average particle size after 24 hours passed from preparation/average particle size after 20 minutes passed from preparation) from the preparation of mini-emulsion is, for example, 0.9 to 1.1, preferably 0.95 to 1.05.

In the first embodiment, thereafter, the polymerizable vinyl monomer is polymerized by mini-emulsion polymerization in the emulsified hydrophobic solution in the presence of a polymerization initiator, thereby producing a polymer.

The mini-emulsion polymerization is an in situ polymerization, because all of the ingredient polymerizable vinyl monomers are in mini-emulsion particles (hydrophobic liquid phase) only.

That is, in mini-emulsion polymerization, by stirring the mini-emulsion while heating, polymerizable vinyl monomers start polymerization therein in the mini-emulsion particles, thereby producing a polymer.

The stirring can be performed, for example, with a stirrer having an impeller. A stirrer that can achieve homogenous heat conduction to mini-emulsion, and can achieve sufficient stirring effects for controlling fixation of mini-emulsion particles on the stirrer wall and holding and film-forming of mini-emulsion at the mini-emulsion surface can be used. Excessive stirring may cause aggregation of mini-emulsion particles. The stirring may be performed so that the circumferential speed of the impeller is, for example, 10 m/min or more, preferably 20 m/min or more, and 400 m/min or less, preferably 200 m/min or less.

The heating conditions are selected suitably depending on the type of the polymerization initiator and antibiotic compound and may be as follows: the heating temperature of, for example, the melting point of the antibiotic compound or more, to be specific, 30 to 100° C., preferably 50 to 100° C., and the heating time of, for example, 2 to 24 hours, preferably 3 to 12 hours. Furthermore, the heating can be performed in stages by heating to a predetermined temperature, thereafter keeping the temperature for a predetermined time, and repeating heating and keeping the temperature.

To reduce the polymerizable vinyl monomer that remains at the terminal stage of polymerization, a water-soluble polymerization initiator can be added for polymerizing the polymerizable vinyl monomer that is dissolved and saturated in the aqueous phase.

Those water-soluble polymerization initiators mentioned above can be used. When using a water-soluble initiator other than the water-soluble azo compound, the water-soluble polymerization initiator is solely added, or a redox water-soluble polymerization initiator containing a water-soluble reducing agent is added. In view of reducing the remaining monomer, the redox water-soluble polymerization initiator (latter one) is preferable.

The mixing ratio of the water-soluble polymerization initiator relative to 100 parts by mass of the polymerizable vinyl monomer is, for example, 0.01 to 0.5 parts by mass, and when the redox water-soluble polymerization initiator is added, the mixing ratio of the water-soluble reducing agent relative to 100 parts by mass of the water-soluble polymerization initiator is, for example, 0.01 to 0.5 parts by mass.

The pressure at the time of mini-emulsion polymerization is not particularly limited, and for example, can be a normal pressure.

In the description above, the mini-emulsion polymerization is performed under a normal pressure, but for example, can also be performed under a high pressure. This allows the reaction system to be set at a temperature of more than 100° C., and the antibiotic compound having a melting point of 80 to 100° C. can be easily liquefied.

As described above, the mini-emulsion polymerization is clearly different from the emulsion polymerization in that the polymerization process in mini-emulsion polymerization is in situ. The polymerization process in emulsion polymerization is not in situ, and in the emulsion polymerization, polymerizable vinyl monomer is polymerized while mass transferring.

To be specific, in emulsion polymerization, stirring is performed in an aqueous phase in the presence of an emulsifier, a polymerizable vinyl monomer, and a polymerization initiator (radical polymerization initiator), and polymerization is started by radicals produced by decomposition of a radical polymerization initiator. At that time, the polymerizable vinyl monomer is present under the three states as follows. The polymerizable vinyl monomer is present under the three states: (1) as being solubilized in the micelles of the emulsifier (having an average particle size of below several tens of nm), (2) dissolved in an aqueous phase, and (3) as oil droplets (having a particle size of several μm or more).

The radicals generated by decomposition of the radical polymerization initiator collide and enter the polymerizable vinyl monomers under those three states, and can start polymerization by being added to the polymerizable vinyl monomer, but the number of the particles of the above-described state (1) as being solubilized in the micelles of the emulsifier, micelle is overwhelmingly larger than the above-described (3) oil droplets of the polymerizable vinyl monomer, and therefore the surface area is large and the possibility for the radicals to enter is high. Therefore, polymerization is initiated in the (1) emulsifier micelle to form polymer particles. When a highly water-soluble polymerizable vinyl monomer is used as the polymerizable vinyl monomer, radical addition to the above-described (2) vinyl monomer dissolved in the aqueous phase occurs, and the produced polymer is stabilized by the emulsifier at the time when it cannot be dissolved in the aqueous phase and deposited, thereby producing polymer particles. Such initiation reactions can also be observed in the process of the emulsion polymerization.

When emulsion polymerization is initiated, the polymerizable vinyl monomer dissolves from (3) oil droplets of the polymerizable vinyl monomer into the aqueous phase, and then the polymerizable vinyl monomer moves to the polymer particles: thus, polymerization progresses. That is, the place of polymerization is polymer particles, oil droplets of the polymerizable vinyl monomer only takes a role as a source of supply of the polymerizable vinyl monomer, and polymerization at that place, that is, in situ polymerization does not occur.

On the other hand, mini-emulsion polymerization is a polymerization method in which a high shearing force is applied to the oil droplets of the polymerizable vinyl monomer in the aqueous phase in the presence of an emulsifier and a hydrophobe (co-stabilizer), with a homomixer (Homo Mixer), a high pressure homogenizer, or by ultrasonic irradiation to micrify to a particle size of below 1 μm, preferably below 0.5 μm; when the polymerization initiator (radical polymerization initiator) is oil-soluble, radical polymerization progresses by radicals generated by decomposition of the polymerization initiator in the microscopic and stable oil droplets of the polymerizable vinyl monomer, or when the polymerization initiator is water-soluble, polymerization is initiated by the radicals entered, and radical polymerization progresses by radicals entered the oil droplet.

To be specific, the microscopic oil droplets of the polymerizable vinyl monomer are stably present by, for example, using an anionic emulsifier as an emulsifier. At the same time, the microscopic oil droplets of the polymerizable vinyl monomer are stably present by using a hydrophobe (co-stabilizer) to control enlargement (Ostwald ripening) due to movement of the polymerizable vinyl monomer from smaller (microscopic) oil droplets of the polymerizable vinyl monomer to larger oil droplets of the polymerizable vinyl monomer through the aqueous phase.

Meanwhile, in the first embodiment, mini-emulsion polymerization progresses: in the mini-emulsion polymerization, the polymerizable vinyl monomer is polymerized (radical polymerization) in mini-emulsion particles (microscopic oil droplet composed of the antibiotic compound and the polymerizable vinyl monomer). During the mini-emulsion polymerization, the polymer of the polymerizable vinyl monomer is preferably miscible with the antibiotic compound. That is, the polymer is dissolved in the antibiotic compound, forming a solution of the polymer in the antibiotic compound, and such an antibiotic compound solution is emulsified in water.

Because the polymerizable vinyl monomer is selected so that preferably, the combination of the above-described polymer of the polymerizable vinyl monomer and the antibiotic compound are miscible with each other at the polymerization temperature (heating temperature) during the above-described mini-emulsion polymerization, phase separation during the mini-emulsion polymerization is prevented, and polymer (polymer during the reaction) dissolves the antibiotic compound, or the reaction progresses in a state where the polymer (polymer during the reaction) is swollen with the antibiotic compound. Therefore, controlled-release particles in which homogeneous phase is formed can be obtained. When the antibiotic compound is liquid at normal temperature, the state of the solution of the polymer in the antibiotic compound is kept as is also at normal temperature.

Meanwhile, because the average particle size of the mini-emulsion particles is small, i.e., below 1 μm, molecular diffusion of the polymerizable vinyl monomer into the aqueous phase easily occurs. However, in the mini-emulsion polymerization of the first embodiment, the antibiotic compound works as a hydrophobe, and therefore the above-described molecular diffusion is effectively prevented, and as a result, Ostwald ripening is prevented, and enlargement (increase in particle size) of the mini-emulsion particles is suppressed.

Thereafter, the temperature of the emulsion after polymerization is decreased, for example, by allowing the emulsion after polymerization to stand to cool.

The cooling temperature is, for example, room temperature (20 to 30° C., to be more specific, 25° C.).

When the controlled release particles are formulated into powder formulation (described later) or granular formulation (described later), to prevent the controlled release particles to adhere to each other, the polymerizable vinyl monomer is selected so that the controlled release particles are preferably in a hard glass-state at room temperature.

The average particle size (median size) of the thus obtained controlled release particles (polymer) is below 1 μm, preferably 750 nm or less, even more preferably, 500 nm or less, particularly preferably 400 nm or less, most preferably 300 nm or less, and for example, 10 nm or more, preferably 50 nm or more.

The emulsion in which the controlled release particles in which the antibiotic compound homogeneously is present are homogeneously dispersed can be obtained in this manner.

Then, to the emulsion containing the controlled release particles, as necessary, known additives such as another dispersing agent, a thickening agent, an anti-freezing agent, an antiseptic, a microbial growth inhibitor, and a specific gravity adjuster are blended appropriately.

The thus obtained controlled release particles may be used as is (emulsion), that is, may be used as an emulsion agent. Alternatively, for example, the thus obtained controlled release particles may be formulated into a known form such as powder formulation or granular formulation, by aggregating with spray-drying, freezing and thawing, or salting out, and then by solid-liquid separation with centrifugal separation, washing and drying thereafter.

Then, in the method for producing controlled release particles of the first embodiment, the polymerizable vinyl monomer in the emulsified hydrophobic solution is polymerized by mini-emulsion polymerization in the presence of a polymerization initiator, thereby producing a polymer having an average particle size of below 1 μm: the controlled release particles of the first embodiment are obtained in this manner, and therefore the controlled release particles are excellent in dispersiveness.

To be specific, the controlled release particles have an average particle size of below 1 μm, and therefore sedimentation due to gravity is hardly caused, and because of Brownian movement of the controlled release particles, the particles are dispersed homogenously in the emulsion. When the emulsion is added into various aqueous mediums, the particles can be dispersed in a liquid homogenously.

Thus, the controlled release particles of the first embodiment can be applied to various usages as controlled release particles having not only excellent controlled release properties but also having excellent dispersiveness, by dispersing the controlled release particles of the first embodiment homogeneously (uniformly) in the medium to which they are added with a size of an average particle size of below 1 μm (submicron size).

To be specific, the controlled release particles can be applied as an additive that exhibits antibiotic activities to various industrial products, for example, indoor/outdoor paint, rubber, fiber, resin, plastic, adhesive, joint mixture, sealing agent, building material, caulking agent, soil treating agent, wood treatment agent, white water in paper-making processes, pigment, treatment liquid for printing plates, cooling water, ink, cutting oil, cosmetic products, nonwoven fabric, spinning oil, and leather. The amount of the antibiotic compound added in the controlled release particles for these industrial products is, for example, 10 mg/kg to 100 g/kg (product weight).

Furthermore, the controlled release particles can be blended suitably in a water-based paint in which the emulsifier used therein is the same as the emulsifier blended in the aqueous emulsifier solution. The water-based paint is a water-based paint used indoor/outdoor, to be specific, examples of water-based paint include paints using emulsion or aqueous resin of acrylic, acrylic-styrene, styrene, vinyl acetate, vinyl acetate-acrylic, polyester, silicone, urethane, alkyd, and fluorine resin, or mixtures thereof as a vehicle. In particular, when the controlled release particles are blended in a zero VOC paint, environmental burden can be reduced, and stability of the controlled release particles can be kept excellently, and further improvement in lasting effects can be achieved.

Furthermore, the hydrophobic antibiotic compound can also work as a hydrophobe in the mini-emulsion polymerization, and therefore without blending the hydrophobe especially, controlled release particles having an average particle size of below 1 μm can be produced easily.

When the average particle size of the controlled release particles is 750 nm or less and 100 nm or more, and when there is a difference of, for example, 0.2 or more between the refraction of the controlled release particles and refraction of the medium, light reflection (visible light, wavelength 360 to 760 nm) is high at an interface between the controlled release particles and the medium, and the controlled release particles blended in the medium can be seen as white by visual check.

Furthermore, when the average particle size of the controlled release particles is below 100 nm, a percentage of light transmission (visible light, wavelength 360 to 760 nm) through the controlled release particles increases regardless of the medium, and the controlled release particles become highly transparent.

Thus, the controlled release particles of the first embodiment blended in a suitable medium can be suitably used as an additive for paint, because even if the antibiotic compound is substantially discolored, the discoloration is less obvious to the eyes.

Furthermore, the controlled release particles can also be used as a wood treatment agent. When the controlled release particles are used as a wood treatment agent, the wood treatment agent may simply contain the controlled release particles. For example, an emulsion (undiluted emulsion) containing the above-described controlled release particles, and the emulsion diluted by a diluent with the above-described dilution rate can be used as the wood treatment agent.

To use the wood treatment agent, for example, the wood treatment agent can be applied on the surface of the lumber by atomizing or with brush; the lumber is immersed in the wood treatment agent; and the wood treatment agent is put into holes formed in the lumber by drilling (to be specific, put while applying pressure).

The wood treatment agent may contain the controlled release particle in an amount of, when the wood treatment agent is an undiluted emulsion, for example, 10 mass % or more, preferably 30 mass % or more, and for example, 60 mass % or less, preferably 50 mass % or less. Meanwhile, when the wood treatment agent is diluted with a diluent, for example, the wood treatment agent may contain the controlled release particles in an amount of 0.2 mass % or more, preferably 0.5 mass % or more, and for example, 10 mass % or less, preferably 5 mass % or less.

The antibiotic compound concentration of the wood treatment agent is, in the case of an undiluted emulsion, for example, 2 mass % or more, preferably 5 mass % or more, and for example, 50 mass % or less, preferably 40 mass % or less. Meanwhile, when the wood treatment agent is diluted with a diluent, the antibiotic compound concentration of the wood treatment agent is, for example, 0.03 mass % or more, preferably 0.1 mass % or more, and for example, 10 mass % or less, preferably 5 mass % or less.

The wood treatment agent may be added with known additives such as a dispersing agent, a thickening agent, an anti-freezing agent, an antiseptic, an insecticide, an insect repellent, a pest repellent, a microbial growth inhibitor, and a specific gravity adjuster.

The wood treatment agent may be applied to the types of lumber without limitation as long as the lumber is industrially applicable. Examples include preferably Japanese cypress, Thujopsis, Japanese cedar, Tsuga heterophylla, and pine. The lumber to be treated include, for example, those generally used lumber-based materials such as lumber for construction, square timber, crossties, bridging parts, breakwater, wooden vehicles, palette, container, wooden cladding, wooden window and doors, plywood, particle board, and those used by joiners, construction workers, or building architects.

### Second Embodiment

In the second embodiment, 3-iodo-2-propynylbutylcarbamate (hereinafter may be referred to as, in the second embodiment, simply IPBC) is used as the antibiotic compound described in the first embodiment.

In the following, the second embodiment is described.

Controlled release particles of the second embodiment are obtained as follows: IPBC is dissolved with a hydrophobic polymerizable vinyl monomer to prepare a hydrophobic solution; separately, water is blended with an emulsifier to prepare an aqueous emulsifier solution; then, the hydrophobic solution is emulsified in the aqueous emulsifier solution; and thereafter, the polymerizable vinyl monomer is polymerized by mini-emulsion polymerization in the presence of a polymerization initiator, thereby producing a polymer containing IPBC.

IPBC is an iodine antibiotic compound (for example, fungicide).
IPBC works as a hydrophobe (co-stabilizer) in the mini-emulsion polymerization. To be specific, IPBC contributes to stabilization of mini-emulsion (described later) in the mini-emulsion polymerization, preventing Ostwald ripening, and suppressing enlargement (increase in particle size) of mini-emulsion particles.
IPBC is substantially hydrophobic, and, for example, has significantly low water solubility at room temperature (20 to 30° C., to be more specific, 25° C.), to be specific, a solubility at room temperature of, on a mass basis, 0.015 parts by mass/100 parts by mass of water (150 ppm).

The IPBC has a polar term δ_{p,IPBC} of 3.23 of the solubility parameter (δ) and a hydrogen bonding term δ_{h,IPBC} of 7.83 of the solubility parameter (δ), the solubility parameter (δ) being calculated by van Krevelen and Hoftyzer method.

The polar term δ_{p,IPBC} and the hydrogen bonding term δ_{h,IPBC} of the solubility parameter (δ) are defined by Hansen, and calculated by van Krevelen and Hoftyzer method. To be specific, it is described in Japanese Unexamined Patent Publication No. 2011-79816 (WO 2011/030824).

The index “IPBC” in each term δ(δₚ and δₕ) represents IPBC, and the same applies to the polymer, monomer unit of the first monomer, and the monomer unit of the second monomer in each term δ(δₚ and δₕ).

The polymerizable vinyl monomer is, for example, a polymerizable monomer having at least one polymerizable carbon-carbon double bond in its molecule, and is selected so that the polymer obtained by polymerization has a polar term δ_{p,polymer} and a hydrogen bonding term δ_{h,polymer} within the desired range.

Examples of polymerizable vinyl monomers include a first monomer.

The monomer unit (described later) composing the polymer obtained from the first monomer has a polar term δ_{p,1st monomer unit(s)} of the solubility parameter (δ) of, for example, 5.6 to 6.0 [(J/cm³)^{1/2}], preferably 5.7 to 6.0 [(J/cm³)^{1/2}], and a hydrogen bonding term δ_{h,1st monomer unit(s)} of the solubility parameter (δ) of, for example, 9.2 to 9.9 [(J/cm³)^{1/2}], preferably 9.2 to 9.8 [(J/cm³)^{1/2}].

In the following, the polar term δ_{p,1st monomer unit(s)} of the solubility parameter (δ) and the hydrogen bonding term δ_{h,1st monomer unit(s)} of the monomer unit composing the polymer obtained from the first monomer may be simply referred to as “the polar term δ_{p,1st monomer unit(s)} and the hydrogen bonding term δ_{h,1st monomer unit(s)} of the monomer unit of the first monomer”, respectively. The monomer unit of the first monomer is to be described later.

The first monomer is a main monomer contained as a main component in the polymerizable vinyl monomer, and for example, a miscible monomer selected to increase miscibility of the polymer to be obtained to IPBC may be used. Examples of the first monomer include, to be specific, methyl methacrylate (MMA) and ethylene glycol dimethacrylate (EGDMA), and more preferably, MMA is used.

To be specific, the first monomer contains, preferably, at least MMA as an essential component.

The first monomer can be used singly, or can be used in combination of two or more. Preferably, MMA is used alone, or MMA and EGDMA are used in combination, even more preferably, MMA is used alone.

The mixing ratio of MMA relative to the first monomer is, when only MMA and EGDMA are used in combination as the first monomer, for example, 50 mass % or more, preferably 60 mass % or more, even more preferably, 70 mass % or more, and furthermore, 80 mass % or more, 90 mass % or more, 95 mass % or more, 98 mass % or more are preferable, and is below 100 mass %. The mixing ratio of EGDMA relative to the first monomer is, when only MMA and EGDMA are used in combination as the first monomer, for example, 50 mass % or less, preferably 40 mass % or less, even more preferably, 30 mass % or less, and furthermore, 20 mass % or less, 10 mass % or less, 5 mass % or less, 2 mass % or less are preferable, and is over 0 mass %.

The ratio of the surface area of the mini-emulsion particles (interface area) relative to the volume of the mini-emulsion particles (surface area/volume) is inverse relation to the average particle size, and the average particle size of the mini-emulsion particles is below 1 μm (described later), and therefore IPBC tends to leak out easily into the aqueous phase. In particular, even if the polymer is miscible with IPBC, when the polymer density per unit volume is high due to, for example, crosslinking of the polymer to be obtained, the amount (ratio) of the IPBC miscible relative to the polymer decreases, and IPBC crystal may partially be deposited during the mini-emulsion polymerization, cooling after the polymerization, or within a few days after the cooling.

However, when only MMA and EGDMA are used in combination as the first monomer, when the mixing ratio of MMA is the above-described lower limit or more, the crosslinking density is low, and therefore the amount (ratio) of IPBC miscible relative to the polymer is sufficient. Therefore, decrease in the above-described miscible amount is effectively prevented, and deposit of IPBC can be effectively prevented.

Next, the polar term δ_{p,1st monomer unit(s)} and the hydrogen bonding term δ_{h,1st monomer unit(s)} of the monomer unit based on the first monomer are described for the case when MMA is used alone as the first monomer, and for the case when only MMA and EGDMA are used in combination as the first monomer as examples.

### 1. Definition of Polar Term δₚ and Hydrogen Bonding Term δₕ

Definitions of the polar term δₚ and the hydrogen bonding term δₕ are described in Japanese Unexamined Patent Publication No. 2011-79816 (WO 2011/030824). To be specific, shown in the formulas (1) and (2) below.

$$\begin{matrix}[ Mathematical Formula 1 ] & \\ {δ}_{p} = \frac{\sqrt{\sum {F}_{pi}^{2}}}{V} & ( 1 )\end{matrix}$$

(where Fₚ represents polar component of the molar attraction function, and V represents molar volume)

$$\begin{matrix}[ Mathematical Formula 2 ] & \\ {δ}_{h} = \sqrt{\frac{\sum {E}_{hi}}{V}} & ( 2 )\end{matrix}$$

(where Eₕ represents contribution of the hydrogen bonding forces to the cohesive energy, and V represents molar volume)

### 2. When MMA is Used Alone as the First Monomer

### (1) Structural Formula of Polymethyl Methacrylate (PMMA)

PMMA, a polymer of MMA is represented by formula (3) below.

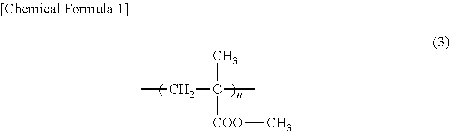

(where n represents degree of polymerization)
(2) Polar Term δ_{p,monomer unit} (=polar term δ_{p,MMA unit})

Fₚ and V of atomic groups in the monomer unit (—CH₂—C(CH₃)COOCH₃—) of the above-described formula (3) are shown below.

—CH₃Fₚ: 0 (J^{1/2}·cm^{3/2}·mol⁻¹)
V: 33.5 (cm³·mol)
   —CH₂—Fₚ: 0 (J^{1/2}·cm^{3/2} mol⁻¹)
V: 16.1 (cm³·mol)
   >C< Fₚ: 0 (J^{1/2}·cm^{3/2} mol⁻¹)
V: −19.2 (cm³·mol)
   —COO— Fₚ: 490 (J^{1/2}·cm^{3/2}·mol⁻¹)
V: 18(cm³·mol)

Therefore, polar term δ_{p,monomer unit} of the monomer unit (polar term δ_{p,MMA unit}) is calculated, as shown in formula (4) below, to be 5.98 [(J/cm³)^{1/2}].

$$\begin{matrix}[ Mathematical Formula 3 ] & \\ \begin{matrix}{δ}_{p} = \frac{\sqrt{\sum {F}_{pi}^{2}}}{V} \\ = \frac{\sqrt{{0}^{2} + {0}^{2} + {0}^{2} + {490}^{2}}}{2 \times 33.5 + 16.1 + ( - 19.2 ) + 18} \\ = 5.98 [ {( J \text{/} {cm}^{3} )}^{1 / 2} ]\end{matrix} & ( 4 )\end{matrix}$$

The above-described polar term δ_{p,MMA unit} of the monomer unit is the same value as the polar term δ_{p,PMMA} of polymethyl methacrylate, having a repeating structure of the monomer unit.

(3) Hydrogen Bonding Term δ_{h,monomer unit}(Hydrogen Bonding Term δ_{h,MMA unit})

Eₕ of the atomic groups in the monomer unit (—CH₂—C(CH₃)COOCH₃—) of the above-described formula (3) is shown below.

—CH₃ Eₕ: 0 (J·mol⁻¹)
—CH₂— Eₕ: 0 (J·mol⁻¹)
>C< Eₕ: 0 (J·mol⁻¹)
—COO— Eₕ: 7000 (J·mol⁻¹)

Therefore, the hydrogen bonding term δ_{h,monomer unit} (hydrogen bonding term δ_{h,MMA unit}) of the monomer unit is calculated, as shown in formula (5) below, to be 9.25 [(J/cm³)^{1/2}].

$$\begin{matrix}[ Mathematical Formula 4 ] & \\ \begin{matrix}{δ}_{h} = \sqrt{\frac{\sum {E}_{hi}}{V}} \\ = \sqrt{\frac{0 + 0 + 0 + 7000}{2 \times 33.5 + 16.1 + ( - 19.2 ) + 18}} \\ = 9.25 [ {( J \text{/} {cm}^{3} )}^{1 / 2} ]\end{matrix} & ( 5 )\end{matrix}$$

The above-described hydrogen bonding term δ_{h,MMAunit} of the monomer unit is the same value as the hydrogen bonding term δ_{h,PMMA} of PMMA, having a repeating structure of the monomer unit.

### 3. When Only MMA and EGDMA are Used in Combination as the First Monomer

When a plurality of types of monomers are used in combination in the first monomer, the polar term δ_{p,1st monomer units} of the monomer units as constituents of the copolymer of the first monomer as a whole is calculated as follows: the polar term δ_{p,1st monomer unit} of the monomer unit of respective monomers is multiplied by the mass ratio of each of the monomer, and they are added (arithmetic mean).

Furthermore, the hydrogen bonding term δ_{h,monomer units} of the monomer units as constituents of the copolymer of the first monomer as a whole is calculated as follows: the hydrogen bonding term δ_{h,1st monomer unit} of the monomer unit of respective monomers is multiplied by the mass ratio of each of the monomer, and they are added (arithmetic mean).

Next, a method for calculating polar term δ_{p,1st monomer units} and the hydrogen bonding term δ_{h,1st monomer units} of the solubility parameter (δ) of the monomer unit is described using poly(methyl methacrylate-ethylene glycol dimethacrylate)(P(MMA-EGDMA)) containing MMA and EGDMA at a mass ratio of 94:6 as a copolymer of the first monomer, as an example of copolymer.

(1) Polar Term δ_{p,1st monomer units}

The polar term δ_{p,MMAunit} of the monomer unit of MMA is, as described above, 5.98 [(J/cm³)^{1/2}].

The polar term δ_{p,EDGMA unit} of the monomer unit of EGDMA calculated as described above is 5.37 [(J/cm³)^{1/2}].

The polar term δ_{p,1st monomer units} of the monomer units of the first monomer is calculated as in formula (6) below.

$$\begin{matrix}{δ}_{p , 1 st monomer units} = ( 94 / 100 ) {δ}_{p , MMA unit} + ( 6 / 100 ) {δ}_{p , EGDMA unit} \\ = ( 94 / 100 ) \times 5.98 + ( 6 / 100 ) \times 5.37 \\ = 5.95 [ {( J \text{/} {cm}^{3} )}^{1 / 2} ]\end{matrix} \qquad ( 6 )$$

This value is the same as the polar term δ_{p,P(MMA-EGDMA)} of poly(methyl methacrylate-ethylene glycol dimethacrylate).

(2) Hydrogen Bonding Term δ_{h,1st monomer units}

The hydrogen bonding term δ_{h,MMA unit} of the monomer unit of MMA is 9.25 [(J/cm³)^{1/2}].

The hydrogen bonding term δ_{h,EGDMA} of the monomer unit of EGDMA is 10.42 [(J/cm³)^{1/2}].

The hydrogen bonding term δ_{h,1st monomer units} of the first monomer is calculated as in formula (7) below.

$$\begin{matrix}{δ}_{h , 1 st monomer units} = ( 94 / 100 ) {δ}_{h , 1 st monomer unit} + \\ ( 6 / 100 ) {δ}_{h , EGDMA unit} \\ = ( 94 / 100 ) \times 9.25 + ( 6 / 100 ) \times 10.42 \\ = 9.32 [ {( J \text{/} {cm}^{3} )}^{1 / 2} ]\end{matrix} \qquad ( 7 )$$

The value is the same as the hydrogen bonding term δ_{h,PMMA-EGDMA} of polymethyl methacrylate-ethylene glycol dimethacrylate, a copolymer.

The calculation method for the polar term δ_{p,1st monomer unit(s)} and the hydrogen bonding term δ_{h,1st monomer unit(s)} of the monomer unit based on the first monomer is described in Japanese Unexamined Patent Publication No. 2011-79816 (WO 2011/030824).

Based on the description above, the solubility parameter (δ) (polar term δ_{p,2nd monomer units} and hydrogen bonding term δ_{h,2nd monomer units}) of the first monomer is, when different types are used in combination, calculated for the first monomer as a whole (that is, a mixture of different types).

The mixing ratio of the first monomer relative to the polymerizable vinyl monomer is, for example, 50 mass % or more, preferably 70 mass % or more, even more preferably 75 mass % or more, particularly preferably 80 mass % or more, and furthermore, 85 mass % or more, 90 mass % or more, 95 mass % or more, 98 mass % or more are preferable, and is 100 parts by mass % or less.

The polymerizable vinyl monomer can contain a second monomer.

The second monomer is used in combination with the first monomer, and is a sub monomer contained optionally in the polymerizable vinyl monomer. To be specific, the second monomer is copolymerizable with the first monomer, and is selected so that the copolymer with the first monomer has a polar term δ_{p,polymer} and a hydrogen bonding term δ_{h,polymer} within the desired range.

Examples of the second monomer include a (meth)acrylate monomer excluding MMA, a (meth)acrylic acid monomer, an aromatic vinyl monomer, a vinyl ester monomer, a maleate monomer, vinyl halide, vinylidene halide, a nitrogen-containing vinyl monomer, and a crosslinkable monomer excluding EGDMA.

When the blending of the second monomer into the polymerizable vinyl monomer causes decrease in the glass transition temperature of the copolymer produced by copolymerization with the first monomer, the crosslinking density of such a copolymer can be increased relative to the homopolymer produced by homopolymerization of the first monomer. The mixing ratio of the EGDMA relative to the polymerizable vinyl monomer is, when the first monomer and the second monomer are used in combination, and MMA and EGDMA are used in combination in the first monomer, for example, 5 mass % or more, preferably 10 mass % or more, even more preferably, 20 mass % or more, particularly preferably 30 mass % or more, and for example, 60 mass % or less, preferably 50 mass % or less, even more preferably, 40 mass % or less.

A (meth)acrylate monomer is also a miscible monomer, because a copolymer with the above-described first monomer is relatively highly miscible with IPBC.

Examples of (meth)acrylate monomers include methacrylate (excluding MMA) and/acrylate, to be specific, alkyl (meth)acrylate (excluding MMA) having an alkyl moiety with 1 to 20 carbon atoms such as methyl acrylate, ethyl (meth)acrylate, n-propyl (meth)acrylate, iso-propyl (meth)acrylate, n-butyl (meth)acrylate, iso-butyl (meth)acrylate, tert-butyl (meth)acrylate, and cyclohexyl(meth)acrylate; alkoxy alkyl (meth)acrylate such as 2-methoxyethyl (meth)acrylate; and hydroxyl alkyl(meth)acrylate such as hydroxyethyl (meth)acrylate. Preferably, alkyl (meth)acrylate (excluding MMA) is used.

For alkyl (meth)acrylate, even more preferably, the following is used: alkyl acrylate having an alkyl moiety with two or more carbon atoms, particularly preferably ethyl acrylate, and propyl acrylate such as n-propyl acrylate, and iso-propylacrylate; and furthermore butyl acrylate such as n-butyl acrylate, iso-butyl acrylate, and tert-butylacrylate. Furthermore, as alkyl methacrylate, even more preferably, alkyl methacrylate having an alkyl moiety with four or more carbon atoms, particularly preferably butylmethacrylate such as n-butyl methacrylate, iso-butyl methacrylate, and tert-butylmethacrylate are used.

Examples of (meth)acrylic acid monomers include methacrylic acid and acrylic acid. A (meth)acrylic acid monomer functions to increase colloid stability of the emulsion formed from a copolymer with the first monomer, and is blended as necessary to achieve such effects.

Examples of aromatic vinyl monomers include styrene, p-methylstyrene, o-methylstyrene, and α-methylstyrene.

Examples of vinyl ester monomers include vinyl acetate and vinyl propionate.

Examples of maleate monomers include dimethyl maleate, diethyl maleate, and dibutyl maleate.

Examples of vinyl halides include vinyl chloride and vinyl fluoride.

Examples of vinylidene halides include vinylidene chloride and vinylidene fluoride.

Examples of nitrogen-containing vinyl monomers include (meth)acrylonitrile, N-phenylmaleimide, and vinylpyridine.

Examples of crosslinkable monomers (excluding EGDMA) include mono or polyethylene glycol di(meth)acrylate (excluding EGDMA) such as ethylene glycol diacrylate, and diethylene glycol di(meth)acrylate; alkane diol di(meth)acrylate such as 1,3-propanediol di(meth)acrylate, 1,4-butanediol di(meth)acrylate, and 1,5-pentanediol di(meth)acrylate; alkanepolyol poly(meth)acrylate such as trimethylolpropanetri(meth)acrylate, and pentaerythritoltetra(meth)acrylate; allyl monomers such as allyl(meth)methacrylate, and triallyl(iso)cyanurate; and divinyl monomers such as divinylbenzene.

For the polymerizable vinyl monomer, preferably, a (meth)acrylate monomer is used.

The second monomer has a polar term δ_{p,2nd monomer unit(s)} of the solubility parameter (δ) of, for example, 3.0 to 6.0 [(J/cm³)^{1/2}], preferably 3.5 to 6.0 [(J/cm³)^{1/2}], and a hydrogen bonding term δ_{h,2nd monomer unit(s)} of the solubility parameter (δ) of, for example, 7.0 to 10.0 [(J/cm³)^{1/2}], preferably 7.2 to 9.5 [(J/cm³)^{1/2}].

When different types are used in combination, the solubility parameter (δ) of the second monomer (the polar term δ_{p,2nd monomer units} and the hydrogen bonding term δ_{h,2nd monomer units}) is calculated for the second monomer as a whole (that is, a mixture of different types). The calculation method is the same as the case for the above-described first monomer as a whole.

The mixing ratio of the second monomer is suitably set based on the fact that the solubility parameter (δ) of the polymer (polar term δ_{p,polymer} and hydrogen bonding term δ_{h,polymer}) is calculated based on the solubility parameter (δ) of the first monomer, its mixing ratio, the solubility parameter (δ) of the second monomer and its mixing ratio (ref: Japanese Unexamined Patent Publication No. 2011-79816 (WO2011/030824)), and to be specific, relative to the polymerizable vinyl monomer, the mixing ratio of the second monomer is, for example, 50 mass % or less, preferably 40 mass % or less, even more preferably, 38 mass % or less, and furthermore, 30 mass % or less, 25 mass % or less, 20 mass % or less, 15 mass % or less, 10 mass % or less, 5 mass % or less, 2 mass % or less are preferable, and is over 0 mass %.

When the mixing ratio of the second monomer is more than the above-described upper limit, miscibility of the copolymer and IPBC may decrease, and in such a case, IPBC crystal may partially be deposited during the mini-emulsion polymerization, cooling after the polymerization or within a few days after the cooling.

The above-described polymerizable vinyl monomer is substantially hydrophobic, and for example, has a significantly low water solubility at room temperature, to be specific, a solubility at room temperature of, for example, 8 parts by mass/100 parts by mass of water or less, preferably 5 parts by mass/100 parts by mass of water or less, even more preferably, 3 parts by mass/100 parts by mass of water or less. When different types of polymerizable vinyl monomers are used in combination (for example, when the first monomer and the second monomer are used in combination, and for example, different types of the first monomers are used in combination), the polymerizable vinyl monomer as a whole (that is, a mixture of different types of polymerizable vinyl monomers) is substantially hydrophobic.

In the polymerizable vinyl monomer obtained by mini-emulsion polymerization, the polymer has a polar term δ_{p,polymer} of the solubility parameter (δ) of 5.0 to 6.0 [(J/cm³)^{1/2}], preferably 5.1 to 6.0 [(J/cm³)^{1/2}], and a hydrogen bonding term δ_{h,polymer} of the solubility parameter (δ) of 9.0 to 9.9 [(J/cm³)^{1/2}], preferably 9.0 to 9.8 [(J/cm³)^{1/2}].

When the polymer has a polar term δ_{p,polymer} and/or hydrogen bonding term δ_{h,polymer} of below the above-described range, the polymer becomes excessively hydrophobic, and sufficient miscibility with IPBC may not be obtained, and even if miscibility could be achieved, IPBC leaks out during the mini-emulsion polymerization outside the controlled release particles, which causes synthesis of controlled release particles sufficiently encapsulating IPBC may become difficult.

On the other hand, when the polymer has a polar term δ_{p,polymer} and/or a hydrogen bonding term δ_{h,polymer} of more than the above-described range, the polymer becomes excessively hydrophilic, and sufficient miscibility with IPBC may not be obtained, and even if miscibility could be obtained, interfacial free energy with the aqueous phase during mini-emulsion polymerization becomes low, and IPBC leaks out into the controlled release particles during mini-emulsion polymerization, which causes synthesis of controlled release particles sufficiently encapsulating IPBC may become difficult.

In the solubility parameter (δ), the difference Δδₚ(=δ_{p,polymer}−δ_{p,IPBC}) deducting the polar term δ_{p,IPBC}(=3.23) of IPBC from the polar term δ_{p, polymer} of the polymer is, for example, 0 to 2.8 [(J/cm³)^{1/2}], preferably 1 to 2.8 [(J/cm³)^{1/2}].

The difference Δδₕ (=δ_{h,polymer}−δ_{h,IPBC}) deducting the hydrogen bonding term δ_{h,IPBC}(=7.83) of IPBC from the hydrogen bonding term δ_{h,polymer} of the polymer is, for example, 0 to 2.8 [(J/cm³)^{1/2}], preferably 1 to 2.8 [(J/cm³)^{1/2}].

When Δδₚ and Δδₕ are within the above-described range, excellent miscibility of IPBC and polymer can be ensured, and excellent controlled release properties can be ensured.

When IPBC has a polar term δ_{p,IPBC} and a hydrogen bonding term δ_{h,IPBC} of the above-described value, and the polymer has a polar term δ_{p,polymer} and a hydrogen bonding term δ_{h,polymer} within the above-described range, IPBC is defined as being miscible with the polymer without leaking from the controlled release particles during mini-emulsion polymerization.

The emulsifier and the mixing ratio of the emulsifier are the same as that of the first embodiment.

The polymerization initiator mentioned in the first embodiment may be used as the polymerization initiator.

Then, in the method for producing controlled release particles of the second embodiment, first, a hydrophobic solution is prepared by dissolving IPBC with a hydrophobic polymerizable vinyl monomer.

That is, IPBC and a polymerizable vinyl monomer are blended, and the mixture is stirred homogenously, thereby producing a hydrophobic solution.

The method for preparing the hydrophobic solution is the same as that of the first embodiment.

In the method for producing controlled release particles of the second embodiment, separately, water is blended with an emulsifier to prepare an aqueous emulsifier solution. The method for preparing an aqueous emulsifier solution is the same as that of the first embodiment.

In the method for producing controlled release particles of the second embodiment, next, the hydrophobic solution is emulsified in the aqueous emulsifier solution. The method for emulsifying the hydrophobic solution is the same as that of the first embodiment. In this manner, the mini-emulsion of hydrophobic solution is prepared.

In the second embodiment, thereafter, the polymerizable vinyl monomer in the emulsified hydrophobic solution is polymerized by mini-emulsion polymerization in the presence of a polymerization initiator, thereby producing a polymer.

The mini-emulsion polymerization is an in situ polymerization, because all of the ingredient polymerizable vinyl monomers are only in mini-emulsion particles (hydrophobic liquid phase).

That is, in mini-emulsion polymerization, by stirring mini-emulsion while heating, polymerization is initiated by the polymerizable vinyl monomers therein in the mini-emulsion particles, thereby producing a polymer.

The stirring conditions are the same as those of the first embodiment.

The heating conditions are as follows. The heating temperature is, for example, the melting point (60° C.) of IPBC or more, to be specific, 40 to 100° C., preferably 60 to 80° C. Because the mini-emulsion polymerization progresses while IPBC is miscible with the polymer, it is necessary that at least in the terminal stage of polymerization, preferably from the initial stage of polymerization, the heating temperature is the melting point of IPBC or more, that is, 60° C. or more. The heating time is, for example, 2 to 12 hours, preferably 3 to 8 hours. Furthermore, the heating can be performed in stages by heating to a predetermined temperature, and then keeping the temperature for a predetermined time, and thereafter, by repeating heating and keeping the temperature. When IPBC tends to turn yellowish brown by heating, and the conversion rate from the polymerizable vinyl monomer to the polymer is 98% or more, preferably 99% or more, the conditions are set so that the temperature is in a temperature range of 60° C. or more, and preferably set so that the temperature is preferably as low as possible and the time is short.

To reduce the polymerizable vinyl monomer remaining in the terminal stage of polymerization, a water-soluble polymerization initiator (including redox water-soluble polymerization initiators) can be added to polymerize the polymerizable vinyl monomer dissolved and saturated in the aqueous phase.

Examples of water-soluble polymerization initiators and water-soluble reducing agents include those mentioned in the first embodiment.

The scheme of the mini-emulsion polymerization is the same as that of the first embodiment.

To be specific, in the second embodiment, mini-emulsion polymerization, in which the polymerizable vinyl monomer polymerizes (radical polymerization) in mini-emulsion particles (microscopic oil droplet composed of IPBC and a polymerizable vinyl monomer) progresses. During mini-emulsion polymerization, the polymer of the polymerizable vinyl monomer is preferably miscible with IPBC. That is, the polymer is dissolved in IPBC, to be a solution of IPBC in polymer, and the IPBC solution particles are emulsified in water.

The polymerizable vinyl monomer is selected to be a combination such that under the above-described polymerization temperature (heating temperature) during mini-emulsion polymerization, preferably the polymer of the polymerizable vinyl monomer and IPBC are miscible as described above, and therefore phase separation during mini-emulsion polymerization is prevented, and the reaction progresses while the polymer (polymer during the reaction) dissolves IPBC, or the polymer (polymer in the process of reaction) is swollen with IPBC. Therefore, controlled release particles in which homogenous phases are formed can be produced.

Meanwhile, because the average particle size of the mini-emulsion particles is small, i.e., below 1 μm, molecular diffusion of the polymerizable vinyl monomer into the aqueous phase easily occurs, but in the mini-emulsion polymerization of the second embodiment, IPBC can function as a hydrophobe, and therefore the above-described molecular diffusion can be effectively prevented, preventing Ostwald ripening, and suppressing enlargement (increase in particle size) of mini-emulsion particles.

Thereafter, the emulsion after polymerization is cooled, for example, by allowing the emulsion after polymerization to stand to cool.

The cooling method is the same as that of the first embodiment.

IPBC has a melting point of 60° C., and therefore the cooling freezes the miscible state of the polymer of the polymerizable vinyl monomer and IPBC, thereby forming controlled release particles as a homogeneous phase.

When the controlled release particles are formulated into powder formulation (described later) or granular formulation (described later), to prevent the controlled release particles to adhere to each other, the polymerizable vinyl monomer is selected so that the controlled release particles are preferably in a hard glass-state at room temperature.

The average particle size of the thus obtained controlled release particles (polymer) is the same as that of the first embodiment.

In this manner, an emulsion, in which controlled release particles in which IPBC is homogeneously present therein are finely dispersed, can be obtained.

Then, to the emulsion containing the controlled release particles, as necessary, additives as mentioned in the first embodiment are blended suitably.

The thus obtained controlled release particles may be used as is (emulsion), that is, may be used as an emulsion agent. Alternatively, for example, the thus obtained controlled release particles may be formulated into a known form such as powder formulation or granular formulation, by aggregating with spray-drying, freezing and thawing, or salting out, and then by solid-liquid separation with centrifugal separation, washing and drying thereafter.

Then, in the method for producing controlled release particles of the second embodiment, the polymerizable vinyl monomer in the emulsified hydrophobic solution is polymerized by mini-emulsion polymerization in the presence of a polymerization initiator, thereby producing a polymer containing IPBC and having an average particle size of below 1 μm: the controlled release particles of the second embodiment are obtained in this manner, and therefore the controlled release particles are excellent in dispersiveness.

Furthermore, in the controlled release particles, the polymer is set so that its polar term δ_{p,polymer} of the solubility parameter (δ) is 5.0 to 6.0 [(J/cm³)^{1/2}], and its hydrogen bonding term δ_{h,polymer} of the solubility parameter (δ) is 9.0 to 9.9 [(J/cm³)^{1/2}], and therefore miscibility with IPBC is more significantly excellent. Thus, the polymer contains IPBC so that IPBC is homogenously present in the polymer.

The controlled release particles have an average particle size of below 1 μm, and therefore sedimentation due to gravity is hardly caused, and because of Brownian movement of the controlled release particles, the particles are dispersed homogenously in the emulsion. When the emulsion is added into various aqueous mediums, the particles can be dispersed in a liquid homogenously.

Thus, the controlled release particles of the second embodiment can be applied to various usages as controlled release particles having excellent controlled release properties and excellent dispersiveness, by dispersing the controlled release particles of the second embodiment homogeneously (uniformly) in the medium to which they are added with a size of an average particle size of below 1 μm (submicron size).

Applications, operations and effects, and amount added of the controlled release particles are the same as those of the first embodiment.

When the average particle size of the controlled release particles is 750 nm or less and 100 nm or more, and when there is a difference of, for example, 0.2 or more between the refraction of the controlled release particles and the refraction of the medium, light reflection (visible light, wavelength 360 to 760 nm) is high at an interface between the controlled release particles and the medium, and the controlled release particles blended in the medium can be seen as white by visual check.

Furthermore, when the average particle size of the controlled release particles is below 100 nm, a percentage of light transmission (visible light, wavelength 360 to 760 nm) through the controlled release particles increases regardless of the medium, and the controlled release particles become highly transparent.

Thus, the controlled release particles of the second embodiment blended in a suitable medium can be suitably used as an additive for a paint, because even if IPBC is substantially discolored, the discoloration is less obvious to the eyes.

### Third Embodiment

In the third embodiment, at least 3-iodo-2-propynylbutylcarbamate (in third embodiment, hereinafter abbreviated as “IPBC”) and propiconazole are used as the antibiotic compound described in the first embodiment.

In the following, the third embodiment is described.

Controlled release particles of the third embodiment are obtained as follows: at least IPBC and propiconazole are dissolved with a hydrophobic polymerizable vinyl monomer to prepare a hydrophobic solution; separately, water is blended with an emulsifier to prepare an aqueous emulsifier solution; then the hydrophobic solution is emulsified in the aqueous emulsifier solution; and thereafter, the polymerizable vinyl monomer is polymerized by mini-emulsion polymerization in the presence of a polymerization initiator, thereby producing a polymer containing at least IPBC and propiconazole.

IPBC is the same IPBC as that in the second embodiment.

Propiconazole(1-[2-(2,4-dichlorophenyl)-4-n-propyl-1,3-dioxolane-2-ylmethyl]-1H-1,2,4-triazole) is a triazole antibiotic compound (for example, antiseptic).

Propiconazole along with IPBC work as a hydrophobe (co-stabilizer) in the mini-emulsion polymerization, to be specific, contribute to stabilization of mini-emulsion (described later) in the mini-emulsion polymerization, preventing Ostwald ripening, and suppressing enlargement (increase in particle size) of mini-emulsion particles.

Propiconazole is substantially hydrophobic, and, for example, has a quite low water solubility at room temperature (20 to 30° C., to be more specific, 25° C.), to be specific, a solubility at room temperature of, on a mass basis, 0.011 parts by mass/100 parts by mass of water (110 ppm).

Propiconazole has a polar term δ_{p,PROP} of 6.55 [J/cm³)^{1/2}] of the solubility parameter (6) and a hydrogen bonding term δ_{h,PROP} of 9.44 [J/cm³)^{1/2}] of the solubility parameter (6) calculated by van Krevelen and Hoftyzer method.

The polymerizable vinyl monomer is, for example, a polymerizable monomer having at least one polymerizable carbon-carbon double bond in its molecule, and is selected so that the polymer obtained by polymerization has a polar term δ_{p,polymer} and a hydrogen bonding term δ_{h,polymer} within the desired range.

Examples of polymerizable vinyl monomer include the first monomer. The first monomer is the same as the first monomer in the second embodiment.

The mixing ratio of MMA relative to the first monomer when only MMA and EGDMA are used in combination as the first monomer is, for example, 50 mass % or more, preferably 60 mass % or more, even more preferably 70 mass % or more, and for example, is below 100 mass %, preferably 95 mass % or less. The mixing ratio of the EGDMA relative to the first monomer when only MMA and EGDMA are used in combination as the first monomer is, for example, 50 mass % or less, preferably 40 mass % or less, even more preferably 30 mass % or less, and for example, over 0 mass %, preferably 5 mass % or more.

The ratio of the surface area of the mini-emulsion particles (interface area) relative to the volume of the mini-emulsion particles (surface area/volume) is inverse relation to the average particle size, and the average particle size of the mini-emulsion particles is below 1 μm (described later), and therefore IPBC and propiconazole tend to leak out easily into the aqueous phase. In particular, even if the polymer is miscible with IPBC and propiconazole, when the polymer density per unit volume is high due to, for example, crosslinking of the polymer to be obtained, the amount (ratio) of the IPBC and propiconazole that are miscible relative to the polymer decreases, and IPBC crystal may partially be deposited during the mini-emulsion polymerization, cooling after the polymerization, or within a few months after the cooling.

The polar term δ_{p,1st monomer unit(s)} and the hydrogen bonding term δ_{h,1st monomer unit(s)} of the monomer unit based on the first monomer are the same as those of the second embodiment.

The mixing ratio of the first monomer is the same as that of the second embodiment.

The polymerizable vinyl monomer may contain a second monomer.

The second monomer, solubility parameter (δ), and mixing ratio thereof are the same as those of the second embodiment.

The (meth)acrylate monomer as well is regarded as a miscible monomer because the above-described copolymer with the first monomer has relatively high miscibility with IPBC and propiconazole. The (meth)acrylate monomer is the same as the (meth)acrylate monomer in the second embodiment.

The above-described polymerizable vinyl monomer is substantially hydrophobic, and, for example, has a significantly low water solubility at room temperature. To be specific, the polymerizable vinyl monomer has the same solubility as that of the second embodiment.

The polymer obtained by mini-emulsion polymerization has a polar term δ_{p,polymer} of the solubility parameter (δ) of, for example, 5.0 to 7.0 [(J/cm³)^{1/2}], preferably 5.0 to 6.5 [(J/cm³)^{1/2}], and a hydrogen bonding term δ_{h,polymer} of the solubility parameter (δ) of, for example, 8.0 to 10.0 [(J/cm³)^{1/2}], preferably 9.0 to 10.0 [(J/cm³)^{1/2}].

When the polar term δ_{p,polymer} and/or the hydrogen bonding term δ_{h,polymer} of the polymer is below the above-described range, there may be a case where hydrophobicity of the polymer becomes excessively high and sufficient miscibility with IPBC and propiconazole is not obtained, and even if miscibility is obtained, IPBC and propiconazole leak to the outside of the controlled release particles during mini-emulsion polymerization, making synthesis of controlled release particles in which IPBC and propiconazole are sufficiently contained difficult.

On the other hand, when the polar term δ_{p,polymer} and/or the hydrogen bonding term δ_{h,polymer} of the polymer exceeds the above-described range, there may be a case where hydrophilicity of the polymer becomes excessively high and sufficient miscibility with IPBC and propiconazole cannot be obtained, and even if miscibility could be obtained, interfacial free energy with the aqueous phase in the mini-emulsion polymerization is lowered, and IPBC and propiconazole leak to the outside of the controlled release particles during the mini-emulsion polymerization, making synthesis of controlled release particles in which IPBC and propiconazole are sufficiently contained difficult.

When the polymer has a polar term δ_{p,polymer} and a hydrogen bonding term δ_{h,polymer} within the above-described range, IPBC and propiconazole are defined as being miscible with the polymer without leaking from the controlled release particles during mini-emulsion polymerization.

The emulsifier and its mixing ratio are the same as that of the first embodiment.

The polymerization initiator may be the same polymerization initiator as that of the first embodiment.

In the method for producing controlled release particles of the third embodiment, first, a hydrophobic solution is prepared by dissolving IPBC and propiconazole with a hydrophobic polymerizable vinyl monomer.

That is, IPBC, propiconazole, and a polymerizable vinyl monomer are blended, and the mixture is stirred homogenously, thereby producing a hydrophobic solution.

The hydrophobic solution is prepared, for example, without blending a solvent (a hydrophobic organic solvent such as hexane, toluene, and ethyl acetate), and/or a hydrophobe (a co-stabilizer such as hexadecane, and cetyl alcohol). This allows for reduction in environmental stress.

The mixing ratio of IPBC and propiconazole relative to the polymerizable vinyl monomer is, on a mass basis (that is, parts by mass of IPBC and propiconazole in total/parts by mass of the polymerizable vinyl monomer), for example, 0.25 or more, preferably 0.6 or more, and for example, 9.0 or less, preferably 4.0 or less.

The mixing ratio of IPBC and propiconazole in total relative to 100 parts by mass of IPBC, propiconazole, and the polymerizable vinyl monomer in total (that is, parts by mass of IPBC and propiconazole in total/Parts by mass of IPBC, propiconazole, and polymerizable vinyl monomer in total) is, for example, 20 parts by mass or more, preferably 40 parts by mass or more, more preferably, 60 parts by mass or more, and for example, 90 parts by mass or less.

The mixing ratio of IPBC relative to 100 parts by mass of IPBC, propiconazole, and polymerizable vinyl monomer in total (that is, parts by mass of IPBC/parts by mass of IPBC, propiconazole, and polymerizable vinyl monomer in total) is, for example, 50 parts by mass or less, preferably 40 parts by mass or less, and for example, 5 parts by mass or more.

The mixing ratio of IPBC relative to propiconazole is, on a mass basis (that is, parts by mass of IPBC/parts by mass of propiconazole), for example, 90/10 to 1/99, preferably 70/30 to 10/90. When the mixing ratio of IPBC is within such a range, IPBC coexist with propiconazole, and leaking out of IPBC to the outside of the controlled release particles can be effectively controlled.

The method for preparing the hydrophobic solution is the same as that of the first embodiment.

In the method for producing controlled release particles of the third embodiment, separately, water is blended with an emulsifier to prepare an aqueous emulsifier solution. The method for preparing an aqueous emulsifier solution is the same as that of the first embodiment.

In the method for producing controlled release particles of the third embodiment, then, the hydrophobic solution is emulsified in the aqueous emulsifier solution. The method for emulsifying the hydrophobic solution is the same as that of the first embodiment. In this manner, the mini-emulsion of hydrophobic solution is prepared.

In the third embodiment, thereafter, the polymerizable vinyl monomer in the emulsified hydrophobic solution is polymerized by mini-emulsion polymerization in the presence of a polymerization initiator, thereby producing a polymer.

The mini-emulsion polymerization is an in situ polymerization, because all of the ingredient polymerizable vinyl monomers are only in mini-emulsion particles (hydrophobic liquid phase).

That is, in mini-emulsion polymerization, by stirring mini-emulsion while heating, polymerization is initiated by the polymerizable vinyl monomers therein in the mini-emulsion particles, thereby producing a polymer.

The stirring conditions are the same as those of the first embodiment.

The heating conditions are selected suitably depending on the type of the polymerization initiator, and the heating temperature is, for example, the melting point of IPBC and propiconazole or more, to be specific, the same as that of the first embodiment.

The pressure at the time of mini-emulsion polymerization is not particularly limited, and for example, may be a normal pressure.

In the description above, the mini-emulsion polymerization is performed under a normal pressure, but for example, may also be performed under a high pressure. This allows for performance of mini-emulsion polymerization at a temperature of more than 100° C.

The scheme of the mini-emulsion polymerization is the same as that of the first embodiment.

To be specific, in the third embodiment, mini-emulsion polymerization progresses: in the mini-emulsion polymerization, the polymerizable vinyl monomer is polymerized (radical polymerization) in mini-emulsion particles (microscopic oil droplet composed of IPBC, propiconazole, and polymerizable vinyl monomer). During mini-emulsion polymerization, the polymer of the polymerizable vinyl monomer preferably is miscible with IPBC and propiconazole. That is, the polymer is dissolved in IPBC and propiconazole, forming a solution of the polymer in the antibiotic compound, and such an antibiotic compound solution is emulsified in water.

Because the polymerizable vinyl monomer is selected so that preferably, the combination of the above-described polymer of the polymerizable vinyl monomer and IPBC and propiconazole are miscible with each other at the polymerization temperature (heating temperature) during the above-described mini-emulsion polymerization, phase separation during the mini-emulsion polymerization is prevented, and polymer (polymer during the reaction) dissolves IPBC and propiconazole, or the reaction progresses in a state where the polymer (polymer during the reaction) is swollen with IPBC and propiconazole. Therefore, controlled-release particles with homogeneous phases formed can be obtained.

IPBC is highly miscible with propiconazole. Therefore, although when IPBC is used alone and the controlled release particles are produced with a high concentration (for example, IPBC concentration of 30 mass % or more in the controlled release particles) such that needle crystal deposits in the emulsion after polymerization, when the particles are produced so that IPBC coexists with propiconazole, even if the particles contain IPBC with a high concentration, deposit of needle crystal in the emulsion after polymerization can be suppressed.

Furthermore, even when the concentration in total of IPBC and propiconazole in the controlled release particles is high, controlled release particles can be obtained without deposit of needle crystal in the emulsion after polymerization. That is, controlled release particles with a high concentration of IPBC and propiconazole in total can be obtained.

In this manner, emulsion of controlled release particles that can be used with a high dilution ratio can be obtained.

Furthermore, with the controlled release particles containing IPBC and propiconazole, compared with controlled release particles containing only IPBC, and controlled release particles containing only propiconazole, the speed of controlled release can be made slower, and therefore controlled release particles that exhibit controlled release properties for a long period of time can be obtained.

Meanwhile, because the average particle size of the mini-emulsion particles is small, i.e., below 1 μm, molecular diffusion of the polymerizable vinyl monomer into the aqueous phase easily occurs. However, in the mini-emulsion polymerization of the third embodiment, IPBC and propiconazole work as a hydrophobe, and therefore the above-described molecular diffusion is effectively prevented, and as a result, Ostwald ripening is prevented, and enlargement (increase in particle size) of mini-emulsion particles is suppressed.

Thereafter, the temperature of the emulsion after polymerization is decreased, for example, by allowing the emulsion after polymerization to stand to cool.

The cooling method is the same as that of the first embodiment.

When the controlled release particles are formulated into powder formulation (described later) or granular formulation (described later), to prevent the controlled release particles to adhere to each other, the polymerizable vinyl monomer is selected so that the controlled release particles are preferably in a hard glass-state at room temperature.

The average particle size of the thus obtained controlled release particles (polymer) is the same as that of the first embodiment.

The IPBC and propiconazole contents in total in the controlled release particles is, for example, 20 mass % or more, preferably 40 mass % or more, even more preferably, 60 mass % or more, and for example, 90 mass % or less.

The controlled release particle content in the emulsion is, for example, 10 mass % or more, preferably 30 mass % or more, even more preferably, 40 mass % or more, and for example, 60 mass % or less.

The IPBC and propiconazole contents in total in the emulsion is, for example, 10 mass % or more, preferably 15 mass % or more, even more preferably, 20 mass % or more, and for example, 50 mass % or less.

The controlled release particles of the third embodiment can contain, especially as a wood treatment agent, in addition to IPBC and propiconazole, insecticides, insect repellents, and pest repellents (all referred to as “insecticides”) to prevent damages of wood pests such as termites and lyctus brunneus. The insecticides can be included in the controlled release particles of the third embodiment in the same manner as IPBC and propiconazole: the insecticides can be included by selecting a compound miscible with the polymer produced by the mini-emulsion polymerization in the third embodiment, without damaging excellent characteristics of controlled release particles containing at least IPBC and propiconazole of the third embodiment.

Examples of insecticides include a hydrophobic organic compound having a molecular weight of 150 to 500 and a melting point of 100° C. or less. The insecticides may contain, for example, a suitable percentage of impurity having a melting point outside the above-described range during production. To be specific, a mixture of isomer I (melting point: 57° C.),isomer II (melting point: 74° C.), and isomer III (melting point: 66° C.) of cyfluthrin contains, for example, an impurity of isomer IV (melting point 102° C.). The insecticides are selected to be a compound having preferably a polar term δ_{p,INSEC} of 2 to 8 [(J/cm³)^{1/2}] of the solubility parameter (δ) and a hydrogen bonding term δ_{h,INSEC} of 5.5 to 9.5 [(J/cm³)^{1/2}] of the solubility parameter (δ), the solubility parameter (δ) being defined by Hansen and calculated by van Krevelen and Hoftyzer method. Examples of the insecticide include, to be specific, cyfluthrin, permethrin, DEET, and ethofenprox.

In production of the controlled release particles, insecticides are blended in the same manner as propiconazole and IPBC, and work as a hydrophobe in mini-emulsion polymerization.

The mixing ratio of the insecticides relative to a total amount of propiconazole and IPBC is, for example, 2 to 100 mass %, preferably 5 to 80 mass %. When insecticides are blended, the total of propiconazole and IPBC are interpreted as the total of propiconazole, IPBC, and insecticides in all of the above description.

Then, to the emulsion containing the controlled release particles, as necessary, additives as mentioned in the first embodiment are blended suitably.

The thus obtained controlled release particles may be used as is (emulsion), that is, may be used as an emulsion agent. Alternatively, for example, the thus obtained controlled release particles may be formulated into a known form such as powder formulation or granular formulation, by aggregating with spray-drying, freezing and thawing, or salting out, and then by solid-liquid separation with centrifugal separation, washing and drying thereafter.

When the emulsion agent containing the controlled release particles is used as a wood treatment agent, the emulsion agent can be diluted at a dilution ratio of, on a mass basis, for example, 1:18 or more (times 18 or more), preferably 1:22 or more (times 22 or more), even more preferably 1:25 (times 25 or more) or more, and for example, 1:60 or less (times 60 or less).

Then, in the method for producing controlled release particles of the third embodiment, the polymerizable vinyl monomer in the emulsified hydrophobic solution is polymerized by mini-emulsion polymerization in the presence of a polymerization initiator, thereby producing a polymer having an average particle size of below 1 μm: controlled release particles of the third embodiment are obtained in this manner, and therefore the controlled release particles are excellent in dispersiveness.

To be specific, the controlled release particles have an average particle size of below 1 μm, and therefore sedimentation due to gravity is hardly caused, and because of Brownian movement of the controlled release particles, the particles are dispersed homogenously in the emulsion. When the emulsion is added into various aqueous mediums, the particles can be dispersed in a liquid homogenously, and the sedimentation can be suppressed.

Thus, the controlled release particles of the third embodiment can be applied to various usages as controlled release particles having not only excellent controlled release properties but also having excellent dispersiveness, by dispersing the controlled release particles of the third embodiment homogeneously (uniformly) in the medium to which they are added with a size of an average particle size of below 1 μm (submicron size)

Applications, operations and effects, and amount added of the controlled release particles are the same as those of the first embodiment.

The controlled release particles are used preferably as a wood treatment agent. When the controlled release particles are used as a wood treatment agent, the wood treatment agent may simply contain the controlled release particles. For example, an emulsion (undiluted emulsion) containing the above-described controlled release particles, and the emulsion diluted with a diluent with the above-described dilution ratio can be used as the wood treatment agent.

The method for using the wood treatment agent is the same as those exemplified in the first embodiment.

The controlled release particle content of the wood treatment agent is, when the wood treatment agent is an undiluted emulsion, for example, 10 mass % or more, preferably 30 mass % or more, and for example, 60 mass % or less, preferably 50 mass % or less. When the wood treatment agent is a diluent, the controlled release particle content of the wood treatment agent is, for example, 0.2 mass % or more, preferably 0.5 mass % or more, and for example, 10 mass % or less, preferably 5 mass % or less.

The IPBC and propiconazole concentrations in total in the wood treatment agent is, in the case of undiluted emulsion, for example, 2 mass % or more, preferably 5 mass % or more, and for example, 50 mass % or less, preferably 40 mass % or less, and in the case of diluted emulsion, for example, 0.03 mass % or more, preferably 0.1 mass % or more, and for example, 10 mass % or less, preferably 5 mass % or less.

The mixing ratio of IPBC relative to propiconazole is, on a mass basis (that is, parts by mass of IPBC/parts by mass of propiconazole), for example, 50/50 or less, to be specific, 50/50 to 1/99, preferably 40/60 to 20/80.

To the wood treatment agent, known additives such as, for example, dispersing agents, thickening agents, anti-freezing agents, antiseptics, insecticides, insect repellents, pest repellents, microbial growth inhibitors, and specific gravity adjusters can be suitably added.

Lumber to which the wood treatment agent is applied is the same as that of the first embodiment.

The wood treatment agent can contain IPBC and propiconazole at a high concentration, and therefore can be diluted with water at a high dilution ratio for use. Therefore, the wood treatment agent is excellent in production efficiency, transportation efficiency, and storage efficiency. Furthermore, the controlled release particles contained in the wood treatment agent are excellent in colloid dispersiveness, and therefore are excellent in mechanical resistance. That is, even if the wood treatment agent is applied or sprayed to the lumber using an applicator or an atomizer at a high pressure, gelling of the wood treatment agent in the applicator or atomizer is suppressed, and therefore the wood treatment agent is excellent in application properties. Furthermore, in the wood treatment agent, the controlled release particles have an average particle size of below 1 μm, i.e., small, and therefore even if the wood treatment agent after diluted with water is allowed to stand as is, the controlled release particles are hardly sedimented, and can be used for a long period of time without trouble. That is, storage stability of the wood treatment agent diluted with water is excellent.

The controlled release particles can be suitably blended in a water-based paint in which the emulsifier is the same as the emulsifier blended in the aqueous emulsifier solution. Examples of the water-based paint include those mentioned in the first embodiment. In particular, when the controlled release particles are blended in a zero VOC paint, environmental burden can be reduced, and stability of the controlled release particles can be kept excellently, and further improvement in lasting effects can be achieved.

Furthermore, the hydrophobic IPBC and propiconazole can also work as a hydrophobe in the mini-emulsion polymerization, and therefore without blending the hydrophobe especially, controlled release particles having an average particle size of below 1 μm can be produced easily.

When the average particle size of the controlled release particles is 750 nm or less and 100 nm or more, and when there is a difference of, for example, 0.2 or more between the refraction of the controlled release particles and the refraction of the medium, light reflection (visible light, wavelength 360 to 760 nm) is high at an interface between the controlled release particles and the medium, and the controlled release particles blended in the medium can be seen as white by visual check.

Furthermore, when the average particle size of the controlled release particles is below 100 nm, a percentage of light transmission (visible light, wavelength 360 to 760 nm) of the controlled release particles increases regardless of the medium, and the controlled release particles become highly transparent.

Therefore, the controlled release particles of the third embodiment blended in a suitable medium can be suitably used as an additive for a paint, because even if IPBC and propiconazole are substantially discolored, the discoloration is less obvious to the eyes.

### Fourth Embodiment

In the fourth embodiment, an aqueous emulsifier/polyvinyl alcohol (hereinafter referred to as PVA in the fourth embodiment) solution is used as the aqueous emulsifier solution shown in the second embodiment.

In the following, the fourth embodiment is described.

Controlled release particles of the fourth embodiment are obtained as follows: IPBC is dissolved with a hydrophobic polymerizable vinyl monomer to prepare a hydrophobic solution; separately, water is blended with an emulsifier and PVA to prepare an aqueous emulsifier solution; then the hydrophobic solution is emulsified in the aqueous emulsifier/PVA solution; and thereafter, the polymerizable vinyl monomer is polymerized by mini-emulsion polymerization in the presence of a polymerization initiator, thereby producing a polymer containing IPBC.

IPBC is the same as the IPBC in the second embodiment.

The polymerizable vinyl monomer is the same as the polymerizable vinyl monomer in the second embodiment.

The emulsifier is the same as the emulsifier in the second embodiment.

PVA is the same as the PVA in the first embodiment.

The polymerization initiator is the same as the polymerization initiator in the second embodiment.

In the method for producing controlled release particles of the fourth embodiment, first, a hydrophobic solution is prepared by dissolving IPBC with a hydrophobic polymerizable vinyl monomer.

That is, IPBC and polymerizable vinyl monomer are blended, and the mixture is stirred homogenously, thereby producing a hydrophobic solution.

The method for preparing the hydrophobic solution is the same as that of the second embodiment.

In the method for producing controlled release particles of the fourth embodiment, separately, an aqueous emulsifier/PVA solution is prepared by blending water with an emulsifier and PVA.

To be specific, the aqueous PVA solution is prepared in advance, and water and an emulsifier are blended therein, and the mixture is stirred homogenously, thereby producing an aqueous emulsifier/PVA solution.

The mixing ratio of the emulsifier relative to the hydrophobic solution is selected such that the amount is sufficient for the emulsifier to be adsorbed onto the entire surface of the emulsified droplets of hydrophobic solution, and such that the amount allows for suppression of generation of new emulsion polymerization particles of the polymerizable vinyl monomer containing no IPBC due to the presence of excessive emulsifier, and although it depends on the type of the emulsifier, for example, as an active component amount of the emulsifier, for example, 0.1 to 20 mass %, preferably 0.2 to 10 mass %.

The mixing ratio of the PVA relative to the hydrophobic solution is selected such that the amount is sufficient for PVA to be adsorbed onto the entire surface of the emulsified droplets of hydrophobic solution, and although it is different depending on the type of PVA, for example, as an active component amount of PVA, the mixing ratio of the PVA relative to the hydrophobic solution is, for example, 0.5 to 10 mass %, preferably 1 to 8 mass %.

The preparation of the aqueous PVA solution can be performed, for example, as follows: PVA is added while stirring to cold water of 25° C. or less to be dispersed, and the temperature is increased as is to 60 to 90° C. to dissolve PVA. After confirming that PVA is completely dissolved in the water, the mixture is cooled to room temperature.

The aqueous emulsifier/PVA solution can contain a dispersing agent other than PVA.

The dispersing agent and its mixing ratio are the same as those of the second embodiment.

In preparation of the aqueous emulsifier/PVA solution, when a water-soluble polymerization initiator is used as the polymerization initiator, a water-soluble polymerization initiator is blended along with water, an emulsifier, and an aqueous PVA solution. The water-soluble polymerization initiator is blended preferably at normal temperature.

The mixing ratio of the water-soluble polymerization initiator relative to 100 parts by mass of water is, for example, 0.01 parts by mass or more, preferably 0.1 parts by mass or more and for example, 5 parts by mass or less, preferably 3 parts by mass or less.

When the mixing ratio of the water-soluble polymerization initiator is more than the above-described upper limit, the molecular weight of the polymer is reduced significantly, and when the mixing ratio of the water-soluble polymerization initiator is below the above-described lower limit, the conversion rate may not be improved sufficiently, and a few % or more of unreacted polymerizable vinyl monomer may remain.

In the method for producing controlled release particles of the fourth embodiment, then, the hydrophobic solution is emulsified in the aqueous emulsifier/PVA solution. The method for emulsifying the hydrophobic solution is the same as that of the first embodiment. In this manner, the hydrophobic solution is emulsified in the aqueous emulsifier/PVA solution to prepare a mini-emulsion.

In the fourth embodiment, thereafter, the polymerizable vinyl monomer in the emulsified hydrophobic solution is polymerized by mini-emulsion polymerization in the presence of a polymerization initiator, thereby producing a polymer.

The mini-emulsion polymerization is an in situ polymerization, because all of the ingredient polymerizable vinyl monomers are only in mini-emulsion particles (hydrophobic liquid phase).

That is, in mini-emulsion polymerization, by stirring the mini-emulsion while heating, polymerization is initiated by the polymerizable vinyl monomers therein in the mini-emulsion particles, thereby producing a polymer.

The stirring conditions and the heating conditions are the same as those of the second embodiment.

MMA is known to have a strong smell even in a small amount, and may damage environment even with a slight amount of unreacted MMA. Thus, for example, for MMA, under Article 95-6 of Ordinance on Industrial Safety and Health, a report must be submitted when handling 500 kg or more per year of a substance containing 0.1% or more of MMA. Thus, to reduce the amount of polymerizable vinyl monomer (remaining monomer amount) containing MMA remaining at the terminal stage of polymerization, for example, to polymerize both of the remaining polymerizable vinyl monomer dissolved and saturated in the aqueous phase and remaining monomer in the particles, preferably, the above-described water-soluble polymerization initiator (including redox water-soluble polymerization initiator) is added.

The amount of the water-soluble polymerization initiator to be added is, relative to 100 parts by mass of the polymerizable vinyl monomer charged, for example, 0.01 to 0.5 parts by mass, preferably 0.02 to 0.2 parts by mass.

The water-soluble polymerization initiator can also be prepared as a water-soluble polymerization initiator-containing aqueous solution by blending and dissolving the water-soluble polymerization initiator in water in advance in a suitable ratio. The water-soluble polymerization initiator concentration in the water-soluble polymerization initiator-containing aqueous solution may be adjusted to, for example, 0.5 to 20 mass %, preferably 1 to 10 mass %. The water-soluble polymerization initiator can also be prepared as a water-soluble polymerization initiator-containing aqueous solution containing an emulsifier. All of the types of emulsifiers given as examples for dispersion of the hydrophobic solution can be used, and the amount is, relative to 100 parts by mass of the polymerizable vinyl monomer charged, for example, 0.0001 to 0.5 parts by mass, preferably 0.0005 to 0.3 parts by mass, more preferably, 0.001 to 0.2 parts by mass.

When the redox water-soluble polymerization initiator is added, the above-described water-soluble reducing agent can be used.

The amount of water-soluble reducing agent to be added is, relative to 100 parts by mass of the polymerizable vinyl monomer charged, for example, 0.01 to 0.5 parts by mass, preferably 0.02 to 0.2 parts by mass.

As a result, the remaining monomer amount at the termination of polymerization is, for example, below 0.1 mass % of the controlled release particles emulsion, preferably below 0.08 mass %.

The scheme of the mini-emulsion polymerization is the same as that of the second embodiment.

To be specific, in the fourth embodiment, the mini-emulsion particles (microscopic oil droplet composed of IPBC and a polymerizable vinyl monomer) produced by reduction in interfacial free energy by the emulsifier and a large mechanical shearing force maintain colloid stability by the emulsifier and PVA, and at the same time, working as a hydrophobe, IPBC suppresses increase in particle size to stabilize the particles. In those mini-emulsion particles, mini-emulsion polymerization progresses, in which the polymerizable vinyl monomer is polymerized (radical polymerization). During mini-emulsion polymerization, the polymer of the polymerizable vinyl monomer is preferably miscible with IPBC. That is, the polymer is dissolved in IPBC to be a solution of IPBC in polymer, and the IPBC solution particles are emulsified in water.

Furthermore, the mini-emulsion particles during polymerization form a stable hydration sphere due to the protective colloid of PVA. Therefore, aggregation due to collision between particles is hindered, and unstable mini-emulsion particles due to the polymerization initiator (including the redox water-soluble polymerization initiator) added to reduce the remaining monomer amount are prevented. That is, the method for producing controlled release particles of the fourth embodiment allows for excellent polymerization stability.

In other words, to produce stable particles of below 1 μm by mini-emulsion polymerization, it is necessary to stabilize with an emulsifier electrostatically. However, such particles only stabilized electrostatically lose stability by addition of electrolyte. However, in the mini-emulsion polymerization of the fourth embodiment, even if the electrolyte is added in the solution, the obtained particles are stabilized, and generation of aggregate can be extremely reduced.

Thereafter, the temperature of the emulsion after polymerization is decreased, for example, by allowing the emulsion after polymerization to stand to cool, and the emulsion after polymerization is filtered with a filter cloth having 100 pores, thereby producing an emulsion of controlled release particles.

The cooling method is the same as that of the first embodiment.

IPBC has a melting point of 60° C., and therefore the cooling freezes the miscible state of the polymer of the polymerizable vinyl monomer and IPBC, thereby forming controlled release particles as a homogeneous phase.

When the controlled release particles are formulated into powder formulation (described later) or granular formulation (described later), to prevent the controlled release particles to adhere to each other, the polymerizable vinyl monomer is selected so that the controlled release particles are preferably in a hard glass-state at room temperature.

Furthermore, the polymerizable monomer is selected so that the polymerizable monomer is in a state of soft rubber when antifungal properties are exhibited by giving adhesiveness to the substrate to which antifungal properties are added.

The average particle size of the thus obtained controlled release particles (polymer) is the same as that of the second embodiment.

The controlled release particles have an IPBC content of, for example, 10 to 50 mass %, preferably 20 to 40 mass %.

In this manner, an emulsion, in which controlled release particles with IPBC homogeneously present therein are finely dispersed, can be obtained.

In the obtained emulsion, deposit of needle crystal of IPBC can be suppressed during storage of the emulsion due to the action of PVA to suppress production and growth of needle crystal of IPBC.

In the emulsion, aggregation is suppressed during mini-emulsion polymerization due to the effects of the protective colloid of PVA, and the amount of the remained substance on the filter cloth when filtered with a filter cloth having 100 pores was, which is an indicator of polymerization stability, relative to the controlled release particles, for example, 0.2 mass % or less, preferably 0.1 mass % or less.

Furthermore, the controlled release particles of over 1 μm is contained (measurement method is described later), relative to the controlled release particles in total, for example, in an amount of 30% by volume or less, preferably 10% by volume or less, more preferably, 0% by volume.

Then, to the emulsion containing the controlled release particles, as necessary, known additives such as other dispersing agent, thickening agent, anti-freezing agent, antiseptic, microbial growth inhibitor, and specific gravity adjuster are suitably added.

The thus obtained controlled release particles may be used as is (emulsion), that is, may be used as an emulsion agent. Alternatively, for example, the thus obtained controlled release particles may be formulated into a known form such as powder formulation or granular formulation, by aggregating with spray-drying, freezing and thawing, or salting out, and then by solid-liquid separation with centrifugal separation, washing and drying thereafter.

Then, in the method for producing controlled release particles of the fourth embodiment, the hydrophobic solution of the polymerizable vinyl monomer emulsified in the aqueous emulsifier/PVA solution containing water, an emulsifier, and PVA is polymerized by mini-emulsion polymerization in the presence of a polymerization initiator, thereby producing a polymer containing IPBC and having an average particle size of below 1 μm. The controlled release particles of the fourth embodiment are produced in this manner, and therefore the controlled release particles are excellent in dispersiveness and storage stability.

Furthermore, in the controlled release particles, the polymer is set so that its polar term δ_{p,polymer} of the solubility parameter (δ) of 5.0 to 7.0 [(J/cm³)^{1/2}], and its hydrogen bonding term δ_{h,polymer} of the solubility parameter (δ) is 8.0 to 10.0 [(J/cm³)^{1/2}], and therefore miscibility with IPBC is more significantly excellent. Thus, the polymer contains IPBC so that IPBC is homogenously present in the polymer.

The controlled release particles have an average particle size of below 1 μm, and therefore sedimentation due to gravity is hardly caused, and because of Brownian movement of the controlled release particles, the particles are dispersed homogenously in the emulsion. When the emulsion is added into various aqueous mediums, the particles can be dispersed in a liquid homogenously.

Thus, the controlled release particles of the fourth embodiment can be applied to various usages as controlled release particles having excellent controlled release properties, dispersiveness, and storage stability, by dispersing the controlled release particles of the fourth embodiment homogeneously (uniformly) in the medium to which they are added with a size of an average particle size of below 1 μm (submicron size).

Applications, operations and effects, and amount added of the controlled release particles are the same as those of the second embodiment.

### EXAMPLES

Values in Examples are interchangeable with the values described in the embodiments above (that is, upper limit value or lower limit value).

### [1] Examples a Corresponding to the First Invention Group

Details of the ingredients and the measurement methods used in Examples A and Comparative Examples A are described below.

IPBC: trade name “Fungitrol 400”, 3-iodo-2-propynylbutylcarbamate, molecular weight 281, melting point: 60° C., water solubility: 150 ppm, polar term δ_{p,compound} of the solubility parameter (δ): 3.23 [(J/cm³)^{1/2}], hydrogen bonding term δ_{h,compound} of the solubility parameter (δ): 7.83 [(J/cm³)^{1/2}], manufactured by International Specialty Products Inc.

OIT: trade name “KATHON 893T”, 2-n-octyl-4-isothiazoline-3-one, molecular weight 213, melting point below 20° C., water solubility 300 ppm, polar term δ_{p,compound} of the solubility parameter (δ): 5.47 [(J/cm³)^{1/2}], hydrogen bonding term δ_{h,compound} of the solubility parameter (δ): 5.87 [(J/cm³)^{1/2}], manufactured by The Dow Chemical Company

Cyfluthrin: trade name “Preventol HS12”, (RS)-α-cyano-4-fluoro-3-phenoxybenzyl-(1RS,3RS)-(1RS,3RS)-3-(2,2-dichlorovinyl)-2,2-dimethylcyclopropanecarboxylate, molecular weight 434, water solubility: 1 to 2 ppb, mixture of isomer I (melting point 57° C.), isomer II (melting point 74° C.), isomer III (melting point 66° C.), and isomer IV (melting point 102° C.), polar term δ_{p,compound} of the solubility parameter (δ): 3.46 [(J/cm³)^{1/2}], hydrogen bonding term δ_{h,compound} of the solubility parameter (δ): 6.09 [(J/cm³)^{1/2}], manufactured by LANXESS

Propiconazole: 1-[2-(2,4-dichlorophenyl)-4-n-propyl-1,3-dioxolane-2-ylmethyl]-1H-1,2,4-triazole, molecular weight 342, melting point below 20° C., water solubility 110 ppm, polar term δ_{p,compound} of the solubility parameter (δ): 6.55 [(J/cm³)^{1/2}], hydrogen bonding term δ_{h,compound} of the solubility parameter (δ): 9.44 [(J/cm³)^{1/2}], manufactured by HAKKO TSUSHO CO., LTD.

Prochloraz: N-propyl-N-[2-(2,4,6-trichloro-phenoxy)ethyl]imidazole-1-carboxamide, molecular weight 375, melting point 45 to 52° C., water solubility: 55 ppm, polar term δ_{p,compound} of the solubility parameter (δ): 7.07 [(J/cm³)^{1/2}], hydrogen bonding term δ_{h,compound} of the solubility parameter (δ): 8.31 [(J/cm³)^{1/2}], manufactured by Maruzen Chemicals Co., Ltd.

Flusilazole: bis(4-fluorophenyl)methyl(1H-1,2,4-triazole-1-ylmethylsilane, molecular weight 315, melting point: 54° C., water solubility: 45 ppm, polar term δ_{p,compound} of the solubility parameter (δ): 5.95 [(J/cm³)^{1/2}], hydrogen bonding term δ_{h,compound} of the solubility parameter (δ): 6.85 [(J/cm³)^{1/2}], manufactured by ARBROWN CO., LTD.

DEET: N,N-diethyl-m-toluamide, molecular weight 191, melting point: −45° C., water solubility: 990 ppm, δ_{p,compound}: 5.42 [(J/cm³)^{1/2}], δ_{h,compound}: 5.83 [(J/cm³)^{1/2}], manufactured by Tokyo Chemical Industry Co., Ltd.

Permethrin: trade name “Preventol HS75”, 3-phenoxybenzyl(1RS,3RS;1RS,3SR)-3-(2,2-dichlorovinyl)-2,2-dimethylcyclopropanecarboxylate, molecular weight 391, melting point: 34 to 35° C., water solubility: 6 ppb, δ_{p,compound}: 3.63 [(J/cm³)^{1/2}], δ_{h,compound}: 6.22 [(J/cm³)^{1/2}], manufactured by LANXESS

Ethofenprox: trade name “TREBON insecticide, technical grade”, 2-(4-ethoxyphenyl)-2-methylpropyl-3-phenoxybenzylether, molecular weight 377, melting point: 36 to 38° C., water solubility: 22.5 ppb, δ_{p,compound}: 2.27 [(J/cm³)^{1/2}], δ_{h,compound}: 5.33 [(J/cm³)^{1/2}], manufactured by Mitsui Chemicals Agro, Inc.

Methyl methacrylate: trade name “ACRYESTER M”, water solubility: 1.6 mass %, polar term δ_{p,monomer unit} of solubility parameter (δ) as monomer unit: 5.98 [(J/cm³)^{1/2}], hydrogen bonding term δ_{h,monomer unit} of solubility parameter (δ) as monomer unit: 9.25 [(J/cm³)^{1/2}], manufactured by Mitsubishi Rayon Co., Ltd.

Isobutyl methacrylate: water solubility: 0.06 mass %, polar term δ_{p,monomer unit} of solubility parameter (δ) as monomer unit: 3.75 [(J/cm³)^{1/2}], hydrogen bonding term δ_{h,monomer unit} of solubility parameter (δ) as monomer unit: 7.32 [(J/cm³)^{1/2}], manufactured by Nippon Shokubai Co., Ltd.

Ethylene glycol dimethacrylate: trade name “Light Ester EG”, water solubility: 5.37 ppm, polar term δ_{p,monomer unit} of solubility parameter (δ) as monomer unit: 5.37 [(J/cm³)^{1/2}], hydrogen bonding term δ_{h,monomer unit} of solubility parameter (δ) as monomer unit: 10.42 [(J/cm³)^{1/2}], manufactured by Kyoeisha Chemical Co., Ltd.

T-1890: trade name “VESTANAT T 1890/100”, isocyanurate of isophorone diisocyanate, manufactured by Evonic Industries AG

DETA: diethylene triamine, Wako 1st grade reagent, manufactured by Wako Pure Chemical Industries, Ltd.

ATBC: Acetyl tributyl citrate, solvent, manufactured by ASAHI KASEI FINECHEM CO., LTD.

PEROYL L: trade name (“PEROYL” is registered trademark), dilauroyl peroxide, manufactured by NOF CORPORATION

NEOCOL SW-C: trade name, solution of 70 mass % sodium dioctyl sulfosuccinate (anionic emulsifier) in isopropanol, manufactured by Dai-ichi Kogyo Seiyaku Co., Ltd.

DBN: trade name “NEOPELEX No. 6 powder”, sodium dodecylbenzene sulphonate, anionic emulsifier, manufactured by Kao Corporation

NOIGEN EA-177: trade name, polyoxyethylene styrenated phenylether (non-ionic emulsifier, HLB: 15.6), manufactured by Dai-ichi Kogyo Seiyaku Co., Ltd.

DEMOL NL: trade name, aqueous solution of 41 mass % β-sodium naphthalene sulfonate formaldehyde condensate, dispersing agent, manufactured by Kao Corporation

PVA-217: trade name “Kuraray Poval 217”, partially saponified polyvinyl alcohol, dispersing agent, the degree of saponification 87 to 89%, degree of polymerization (average degree of polymerization) 1700, manufactured by Kuraray Co., Ltd.

Average Particle Size: samples below were evaluated by the following measurement method.

Hydrophobic solution dispersion particles and controlled release particles of Example A1 to Example A12 and hydrophobic solution dispersion particles of Comparative Example A1 to Comparative Example A3:

Measured as volume-based median size by dynamic light scattering using a particle size analyzer (FPAR-1000, measurable average particle size 3 nm to 7 μm, however, measurement accuracy significantly decreases in the range when the particle size is over several μm and where the effects of gravity are large on Brownian movement, Otsuka Electronics Co., Ltd.).

For the hydrophobic solution dispersion particles, mini-emulsion after 20 minutes passed from preparation was subjected to measurement.

For the controlled release particles, filtrate was subjected to measurement after filtration with a filter cloth having 100 pores.

Controlled Release Particles of Comparative Example A4 and Comparative Example A5:

Filtrate after filtration with a filter cloth having 100 pores was measured as volume-based median size by laser diffraction using a laser diffraction scattering particle size distribution analyzerLA-920 (measurable average particle size 20 nm to 2000 μm, however, with the particle size of 1 μm or less, angular dependence of Mie scattering is lost, and measurement accuracy significantly decreases, manufactured by HORIBA, Ltd.).

### Example A1

### Production of Controlled Release Particles Containing IPBC by Mini-Emulsion polymerization

A 200 mL container was charged with 25 g of IPBC, 75 g of methyl methacrylate, and 0.5 g of PEROYL L, and the mixture was stirred at room temperature, thereby producing a homogenous hydrophobic solution.

Separately, a 500 mL beaker was charged with 125.5 g of deionized water, 4.0 g of NEOCOL SW-C, and 20 g of an aqueous solution of 25 mass % NOIGEN EA-177, and the mixture was stirred at room temperature, thereby producing a homogenous aqueous emulsifier solution.

Then, a hydrophobic solution was added to the aqueous emulsifier solution of the 500 mL beaker, and the mixture was stirred with T.K. Homo Mixer MARK model 2.5 (manufactured by PRIMIX Corporation) at 12000 rpm for 5 minutes to emulsify the hydrophobic solution in the aqueous emulsifier solution, thereby preparing a mini-emulsion.

Thereafter, the prepared mini-emulsion was transferred to a 300 mL, 4-neck flask equipped with a stirrer, a reflux condenser, a thermometer, and a nitrogen inlet tube, and polymerized by mini-emulsion polymerization under nitrogen gas current, while stirring with a 6 cm-diameter stirrer at 125 rpm (circumferential speed 23.6 m/min), and increasing the temperature of the 4-neck flask with water bath.

The mini-emulsion polymerization was regarded as initiated when the temperature reached 55° C., and thereafter, polymerization was performed continuously for 1 hour at 60±2° C., and for 3.5 hours at 70±2° C.

Then, the temperature of the water bath was increased to increase the temperature of the reaction solution to 80° C.±2° C., and the reaction solution was aged at that temperature for 2.5 hours.

Thereafter, the reaction solution was cooled to 30° C. or less, thereby producing an emulsion of controlled release particles containing IPBC.

Thereafter, the emulsion was filtered with a filter cloth having 100 pores, and the median size of the controlled release particles in the filtrate was measured: as a result, the median size was 201 nm.

The emulsion was a colloidal dispersion stable as a normal polymer latex, and no tendency of sedimentation or phase separation of the controlled release particles was observed during storage at room temperature.

### Example A2

### Production of Controlled Release Particles Containing IPBC by Mini-Emulsion Polymerization

A 200 mL container was charged with 25 g of IPBC, 70.5 g of methyl methacrylate, 4.5 g of ethylene glycol dimethacrylate, and 0.5 g of PEROYL L, and the mixture was stirred at room temperature, thereby producing a homogenous hydrophobic solution.

Separately, a 500 mL beaker was charged with 125.5 g of deionized water, 4.0 g of NEOCOL SW-C, and 20 g of an aqueous solution of 25 mass % NOIGEN EA-177, and the mixture was stirred at room temperature, thereby producing a homogenous aqueous emulsifier solution.

Then, a hydrophobic solution was added to the aqueous emulsifier solution of the 500 mL beaker, and the mixture was stirred with T.K. Homo Mixer MARK model 2.5 (manufactured by PRIMIX Corporation) at 12000 rpm for 5 minutes to emulsify the hydrophobic solution in the aqueous emulsifier solution, thereby preparing a mini-emulsion.

Thereafter, the prepared mini-emulsion was transferred to a 300 mL, 4-neck flask equipped with a stirrer, a reflux condenser, a thermometer, and a nitrogen inlet tube, and polymerized by mini-emulsion polymerization in the same manner as in Example A1.

Thereafter, the reaction solution was cooled to 30° C. or less, thereby producing an emulsion of controlled release particles containing IPBC. The emulsion was filtered with a filter cloth having 100 pores, and the median size of the controlled release particles in the filtrate was measured: as a result, the median size was 230 nm.

The emulsion was a colloidal dispersion stable as a normal polymer latex, and no tendency of sedimentation or phase separation of the particles was observed during storage at room temperature.

### Example A3

### Production of Controlled Release Particles Containing OIT by Mini-Emulsion Polymerization

A 200 mL container was charged with 25 g of OIT, 48 g of methyl methacrylate, 22.5 g of isobutyl methacrylate, 4.5 g of ethylene glycol dimethacrylate, and 0.5 g of PEROYL L, and the mixture was stirred at room temperature, thereby producing a homogenous hydrophobic solution.

Separately, a 500 mL beaker was charged with 125.5 g of deionized water, 4.0 g of NEOCOL SW-C, and 20 g of an aqueous solution of 25 mass % NOIGEN EA-177, and the mixture was stirred at room temperature, thereby producing a homogenous aqueous emulsifier solution.

Then, a hydrophobic solution was added to the aqueous emulsifier solution of the 500 mL beaker, and the mixture was stirred with T.K. Homo Mixer MARK model 2.5 (manufactured by PRIMIX Corporation) at 12000 rpm for 5 minutes to emulsify the hydrophobic solution in the aqueous emulsifier solution, thereby preparing a mini-emulsion.

Thereafter, the prepared mini-emulsion was transferred to a 300 mL, 4-neck flask equipped with a stirrer, a reflux condenser, a thermometer, and a nitrogen inlet tube, and polymerized by mini-emulsion polymerization under nitrogen gas current while stirring with a stirrer at 125 rpm and increasing the temperature of the 4-neck flask with water bath.

The mini-emulsion polymerization was regarded as initiated when the temperature reached 55° C., and thereafter, polymerization was performed continuously for 1 hour at 60±2° C., and for 3.5 hours at 70±2° C.

Then, the temperature of the water bath was increased to increase the temperature of the reaction solution to 80° C.±2° C., and the reaction solution was aged at that temperature for 2.5 hours.

Thereafter, the reaction solution was cooled to 30° C. or less, thereby producing an emulsion of controlled release particles containing OIT.

The emulsion was filtered with a filter cloth having 100 pores, and the median size of the controlled release particles in the filtrate was measured: as a result, the median size was 198 nm.

The emulsion was a colloidal dispersion stable as a normal polymer latex, and no tendency of sedimentation or phase separation of the particles was observed during storage at room temperature.

### Example A4

### Production of Controlled Release Particles Containing OIT by Mini-Emulsion Polymerization

A 200 mL container was charged with 30 g of OIT, 65.8 g of MMA, 4.2 g of EGDMA, and 0.5 g of PEROYL L, and the mixture was stirred at room temperature, thereby producing a homogenous hydrophobic solution.

Separately, a 500 mL beaker was charged with 157.26 g of deionized water, 2.0 g of NEOCOL SW-C, 40 g of an aqueous solution of PVA217 (10 mass %), and 0.24 g of DEMOL NL, and the mixture was stirred at room temperature, thereby producing a homogenous aqueous emulsifier solution.

Then, a hydrophobic solution was added to the aqueous emulsifier solution of the 500 mL beaker, and the mixture was stirred with T.K. Homo Mixer MARK model 2.5 (manufactured by PRIMIX Corporation) at 14000 rpm for 10 minutes to emulsify the hydrophobic solution in the aqueous emulsifier solution, thereby preparing a mini-emulsion.

Thereafter, the prepared mini-emulsion was transferred to a 300 mL, 4-neck flask equipped with a stirrer, a reflux condenser, a thermometer, and a nitrogen inlet tube, and polymerized by mini-emulsion polymerization under nitrogen gas current while stirring with a 6 cm-diameter stirrer at 200 rpm (circumferential speed 37.7 m/min) and increasing the temperature of the 4-neck flask with water bath.

The mini-emulsion polymerization was regarded as initiated when the temperature reached 55° C., and thereafter, polymerization was performed continuously for 3 hours at 60±2° C., and for 2 hours at 70±2° C.

Then, the temperature of the water bath was increased to increase the temperature of the reaction solution to 80±2° C., and the reaction solution was aged for 2 hours.

Thereafter, the reaction solution was cooled to 30° C. or less, thereby producing an emulsion of controlled release particles containing OIT.

The emulsion was filtered with a filter cloth having 100 pores, and the median size of the controlled release particles in the filtrate was measured: as a result, the median size was 166 nm.

The emulsion was a colloidal dispersion stable as a normal polymer latex, and no tendency of sedimentation or phase separation of the particles was observed during storage at room temperature.

### Example A5

### Production of Controlled Release Particles Containing Cyfluthrin by Mini-Emulsion Polymerization

An emulsion of controlled release particles was produced in the same manner as in Example A4 using cyfluthrin as the antibiotic compound based on the mixing formulation and the reaction conditions shown in Table A2.

The emulsion was filtered with a filter cloth having 100 pores, and the median size of the controlled release particles in the filtrate was measured. The results are shown in Table A2.

### Example A6

### Production of Controlled Release Particles Containing Propiconazole by Mini-Emulsion Polymerization

An emulsion of controlled release particles was produced in the same manner as in Example A4 using propiconazole as the antibiotic compound based on the mixing formulation and the reaction conditions shown in Table A2.

The emulsion was filtered with a filter cloth having 100 pores, and the median size of the controlled release particles in the filtrate was measured. The results are shown in Table A2.

### Example A7

### Production of Controlled Release Particles Containing Prochloraz by Mini-Emulsion Polymerization

An emulsion of controlled release particles was produced in the same manner as in Example A4 using prochloraz as the antibiotic compound based on the mixing formulation and the reaction conditions shown in Table A2.

The emulsion was filtered with a filter cloth having 100 pores, and the median size of the controlled release particles in the filtrate was measured. The results are shown in Table A2.

### Example A8

### Production of Controlled Release Particles Containing Flusilazole by Mini-Emulsion Polymerization

An emulsion of controlled release particles was produced in the same manner as in Example A4 using flusilazole as the antibiotic compound based on the mixing formulation and the reaction conditions shown in Table A2.

The emulsion was filtered with a filter cloth having 100 pores, and the median size of the controlled release particles in the filtrate was measured. The results are shown in Table A2.

### Example A9 and Example A10

### Production of Controlled Release Particles Containing DEET by Mini-Emulsion Polymerization

An emulsion of controlled release particles was produced in the same manner as in Example A4 using DEET as the antibiotic compound based on the mixing formulation and the reaction conditions shown in Table A3.

The emulsion was filtered with a filter cloth having 100 pores, and the median size of the controlled release particles in the filtrate was measured. The results are shown in Table A3.

### Example A11

### Production of Controlled Release Particles Containing Permethrin by Mini-Emulsion Polymerization

An emulsion of controlled release particles was produced in the same manner as in Example A4 using permethrin as the antibiotic compound based on the mixing formulation and the reaction conditions shown in Table A3.

The emulsion was filtered with a filter cloth having 100 pores, and the median size of the controlled release particles in the filtrate was measured. The results are shown in Table A3.

### Example A12

### Production of Controlled Release Particles Containing Ethofenprox by Mini-Emulsion Polymerization

An emulsion of controlled release particles was produced in the same manner as in Example A4 using ethofenprox as the antibiotic compound based on the mixing formulation and the reaction conditions shown in Table A3.

The emulsion was filtered with a filter cloth having 100 pores, and the median size of the controlled release particles in the filtrate was measured. The results are shown in Table A3.

### Comparative Example A1

### Preparation of Aqueous Dispersion in which Emulsifier was not Blended

An aqueous dispersion of the hydrophobic solution was prepared in the same manner as in Example A1, except that in the preparation of the aqueous emulsifier solution, the aqueous solutions of NEOCOL SW-C and NOIGEN EA-177 (both emulsifiers) were not blended.

However, the oil droplets composed of the hydrophobic solution did not form mini-emulsion particles, and therefore mini-emulsion polymerization could not be performed.

### Comparative Example A2

### Preparation of Aqueous Dispersion in which IPBC was not Blended

An aqueous dispersion of the hydrophobic solution was prepared in the same manner as in Example A1, except that in preparation of the hydrophobic solution, 25 g of IPBC and 75 g of methyl methacrylate were replaced with 100 g of methyl methacrylate.

However, the oil droplets composed of the hydrophobic solution did not form mini-emulsion particles with an average particle size of below 1 μm, and therefore mini-emulsion polymerization could not be performed.

### Comparative Example A3

### Preparation of Aqueous Dispersion in which OIT was not Blended

A mini-emulsion of hydrophobic solution was prepared in the same manner as in Example A3, except that in preparation of the hydrophobic solution, 25 g of OIT, 48 g of methyl methacrylate, 22.5 g of isobutyl methacrylate, and 4.5 g of ethylene glycol dimethacrylate were replaced with 64 g of methyl methacrylate, 30 g of isobutyl methacrylate, and 6 g of ethylene glycol dimethacrylate.

However, in this mini-emulsion, enlargement (that is, increase in average particle size, described later) of the mini-emulsion particles occurred over time when allowed to stand at room temperature, and it was decided that in situmini-emulsion polymerization could not be performed.

### Comparative Example A4

### Production of Controlled Release Particles Containing IPBC by Suspension Polymerization

A 200 mL container was charged with 25 g of IPBC, 52.5 g of methyl methacrylate, 22.5 g of ethylene glycol dimethacrylate, and 0.5 g of PEROYL L, and the mixture was stirred at room temperature, thereby producing a homogenous hydrophobic solution.

Separately, a 500 mL beaker was charged with 109.3 g of deionized water, 40 g of aqueous solution of 10 mass % of PVA-217, and 200 mg of aqueous solution of 5% of DBN, and the mixture was stirred at room temperature, thereby producing a homogenous aqueous solution.

Then, the 500 mL beaker was charged with the hydrophobic solution, and the mixture was stirred with T.K. Homo Mixer (manufactured by PRIMIX Corporation) at 3000 rpm for 10 minutes to disperse the hydrophobic solution in the aqueous solution, thereby preparing a suspension liquid.

Thereafter, the suspension liquid was transferred to a 300 mL, 4-neck flask equipped with a stirrer, a reflux condenser, a thermometer, and a nitrogen inlet tube, and polymerized by suspension polymerization under nitrogen gas current, while stirring with a stirrer at 125 rpm, and increasing the temperature of the 4-neck flask with water bath.

The suspension polymerization was regarded as initiated when the temperature reached 55° C., and thereafter, the polymerization was performed continuously for 1 hour at 60±2° C., for 3 hours at 70±2° C., and for 2 hours at 80±2° C.

Thereafter, the suspension liquid after the reaction was cooled to 30° C. or less, thereby producing a suspension liquid of controlled release particles containing IPBC.

The produced suspension liquid was transferred from the 4-neck flask to a translucent polyethylene container, and the conditions of the controlled release particles when allowed to stand at room temperature for a few hours were observed. It was confirmed that the controlled release particles were sedimented, and separation into two layers occurred.

After three days passed at room temperature, the sedimented lower layer formed a hard cake that cannot be re-dispersed even with strong shaking and mixing.

### Comparative Example A5

### Production of Controlled Release Particles Containing IPBC by Interfacial Polymerization

A 200 mL container was charged with 25 g of IPBC, 64 g of ATBC, and 10 g of T-1890, and the mixture was stirred at room temperature, thereby producing a homogenous hydrophobic solution.

Separately, a 500 mL beaker was charged with 97.8 g of deionized water, 40 g of an aqueous solution of 10 mass % of PVA-217, and 200 mg of an aqueous solution of 5% DBN, and the mixture was stirred at room temperature, thereby producing a homogenous aqueous solution.

Then, the 500 mL beaker was charged with the hydrophobic solution, and the mixture was stirred with T.K. Homo Mixer (manufactured by PRIMIX Corporation) at 5000 rpm for 10 minutes to disperse the hydrophobic solution in the aqueous solution, thereby preparing a suspension liquid.

Thereafter, the suspension liquid was transferred to a 300 mL, 4-neck flask equipped with a mixer, a reflux condenser, and a thermometer, and 13 g of an aqueous solution of 10 mass % DETA was added while stirring at 125 rpm. Then, the temperature of the 4-neck flask was increased with water bath to be interfacially polymerized for 4 hours at 75±2° C.

Thereafter, the suspension liquid after the reaction was cooled to 30° C. or less, thereby producing a suspension liquid of controlled release particles having a median size of 10 μm and containing IPBC.

The produced suspension liquid was transferred from the 4-neck flask to a translucent polyethylene container, and the conditions of the controlled release particles when allowed to stand at room temperature for a few hours were observed. It was confirmed that the controlled release particles were sedimented, and separation into two layers occurred.

After three days passed at room temperature, the sedimented lower layer formed a hard cake that cannot be re-dispersed even with strong shaking and mixing.

### (Mixing Formulation)

The mixing formulations of Examples A and Comparative Examples A are shown in Table A1 to Table A5.

In Tables A, the values under the columns of the mixing formulation of ingredients are shown in grams unless otherwise noted.

TABLE A1

| | | | | | | | Example A | | | |
|---|---|---|---|---|---|---|---|---|---|---|
| | | | δp | δh | Molecular | Melting Point | Example | Example | Example | Example |
| | | | [(J/cm³)^{1/2}] | [(J/cm³)^{1/2}] | Weight | (° C.) | A1 | A2 | A3 | A4 |
| Hydro- | Antibiotic | IPBC | 3.23 | 7.83 | 281 | 60 | 25 | 25 | — | — |
| phobic | Compound | OIT | 5.47 | 5.87 | 213 | <20 | — | — | 25 | 30 |
| Solution | | Cyfluthrin | 3.46 | 6.09 | 434 | 57, 74, 66, 102 | — | — | — | — |
| | | Propiconazole | 6.55 | 9.44 | 342 | <20 | — | — | — | — |
| | | Prochloraz | 7.07 | 8.31 | 375 | 45-52 | — | — | — | — |
| | | Flusilazole | 5.95 | 6.85 | 315 | 54 | — | — | — | — |
| | | DEET | 5.42 | 5.83 | 191 | <20 | — | — | — | — |
| | | Permethrin | 3.63 | 6.22 | 391 | 34-35 | — | — | — | — |
| | | Ethofenprox | 2.27 | 5.33 | 377 | 36-38 | — | — | — | — |

| | Mixing Ratio of Antibiotic Compound relative to Polymerizable Vinyl | | 0.33 | 0.33 | 0.33 | 0.43 |
|---|---|---|---|---|---|---|
| | Monomer | | | | | |
| Polymerizable | Miscible | Methyl Methacrylate | 75 | 70.5 | 48 | 65.8 |
| Vinyl | Monomer | Isobutyl Methacrylate | — | — | 22.5 | — |
| Monomer | Crosslinkable | Ethylene Glycol Dimethacrylate | — | 4.5 | 4.5 | 4.2 |
| | Monomer | | | | | |

| | | | | | |
|---|---|---|---|---|---|
| Oil-soluble Polymerization | PEROYL L | 0.5 | 0.5 | 0.5 | 0.5 |
| Initiator | | | | | |

| δp [(J/cm³)^{1/2}] of Polymer | | | | 5.98 | 5.95 | 5.28 | 5.95 |
|---|---|---|---|---|---|---|---|
| δh [(J/cm³)^{1/2}] of Polymer | | | | 9.25 | 9.32 | 8.74 | 9.32 |
| Δδp [(J/cm³)^{1/2}] | | (=δp, polymer-δp, compound) | | 2.75 | 2.72 | −0.19 | 0.48 |
| Δδh [(J/cm³)^{1/2}] | | (=δh, polymer-δh, compound) | | 1.42 | 1.49 | 2.87 | 3.45 |
| Aqueous Emulsifier | Ion-exchange Water | | | 125.5 | 125.5 | 125.5 | 157.26 |
| Solution | Emulsifier | Anionic | NEOCOL SW-C | 4.0 | 4.0 | 4.0 | 2.0 |
| | | Non-ionic | Aqueous Solution of NOIGEN EA- | 20 | 20 | 20 | — |
| | | | 177 (25%) | | | | |
| | Dispersion | Anionic | DEMOL NL | — | — | — | 0.24 |
| | Stabilizer | | | | | | |

| | | | | | |
|---|---|---|---|---|---|
| Protective | Aqueous Solution of PVA-217 (10%) | — | — | — | 40 |
| Colloid | | | | | |
| Homomixer | Number of Revolution (rpm) × Time (minutes) | 12000 × 5 | 12000 × 5 | 12000 × 5 | 14000 × |
| Dispersion | | | | | 10 |
| Conditions | | | | | |

| | | | | | |
|---|---|---|---|---|---|
| Status of Aqueous Dispersion of | Median Size of Hydrophobic Solution Dispersion | 194 | 223 | 199 | 175 |
| Hydrophobic Solution | Particles*¹ (nm) | | | | |

| | | | | | |
|---|---|---|---|---|---|
| Physical Properties | Antibiotic Compound Concentration (mass %) [vs Controlled Release | 25 | 25 | 25 | 30 |
| | Particles] | | | | |
| | Controlled Release Particles Concentration (mass %) [vsEmulsion] | 40 | 40 | 40 | 33.3 |
| | Antibiotic Compound Concentration (mass %) [vsEmulsion] | 10.0 | 10.0 | 10.0 | 10.0 |
| | Median Size of Controlled Release Particles (nm) | 201 | 230 | 198 | 166 |

^{*1}Median Size after 20 minutes passed from Preparation

TABLE A2

| | | | | | | | Example A | | | |
|---|---|---|---|---|---|---|---|---|---|---|
| | | | δp | δh | Molecular | Melting Point | Example | Example | Example | Example |
| | | | [(J/cm³)^{1/2}] | [(J/cm³)^{1/2}] | Weight | (° C.) | A5 | A6 | A7 | A8 |
| Hydro- | Antibiotic | IPBC | 3.23 | 7.83 | 281 | 60 | — | — | — | — |
| phobic | Compound | OIT | 5.47 | 5.87 | 213 | <20 | — | — | — | — |
| Solution | | Cyfluthrin | 3.46 | 6.09 | 434 | 57, 74, 66, 102 | 30 | — | — | — |
| | | Propiconazole | 6.55 | 9.44 | 342 | <20 | — | 30 | — | — |
| | | Prochloraz | 7.07 | 8.31 | 375 | 45-52 | — | — | 30 | — |
| | | Flusilazole | 5.95 | 6.85 | 315 | 54 | — | — | — | 30 |
| | | DEET | 5.42 | 5.83 | 191 | <20 | — | — | — | — |
| | | Permethrin | 3.63 | 6.22 | 391 | 34-35 | — | — | — | — |
| | | Ethofenprox | 2.27 | 5.33 | 377 | 36-38 | — | — | — | — |

| | Mixing Ratio of Antibiotic Compound relative to Polymerizable Vinyl | | 0.43 | 0.43 | 0.43 | 0.43 |
|---|---|---|---|---|---|---|
| | Monomer | | | | | |
| Polymerizable | Miscible | Methyl Methacrylate | 65.8 | 65.8 | 65.8 | 65.8 |
| Vinyl | Monomer | Isobutyl Methacrylate | — | — | — | — |
| Monomer | Crosslinkable | Ethylene Glycol Dimethacrylate | 4.2 | 4.2 | 4.2 | 4.2 |
| | Monomer | | | | | |

| | | | | | |
|---|---|---|---|---|---|
| Oil-soluble Polymerization | PEROYL L | 0.5 | 0.5 | 0.5 | 0.5 |
| Initiator | | | | | |

| δp [(J/cm³)^{1/2}] of Polymer | | | | 5.95 | 5.95 | 5.95 | 5.95 |
|---|---|---|---|---|---|---|---|
| δh [(J/cm³)^{1/2}] of Polymer | | | | 9.32 | 9.32 | 9.32 | 9.32 |
| Δδp [(J/cm³)^{1/2}] | | (=δp, polymer-δp, compound) | | 2.49 | −0.60 | −1.12 | 0 |
| Δδh [(J/cm³)^{1/2}] | | (=δh, polymer-δh, compound) | | 3.23 | −0.12 | 1.01 | 2.47 |
| Aqueous Emulsifier | Ion-exchange Water | | | 157.26 | 157.26 | 157.26 | 157.26 |
| Solution | Emulsifier | Anionic | NEOCOL SW-C | 2.0 | 2.0 | 2.0 | 2.0 |
| | | Non-ionic | Aqueous Solution of NOIGEN EA- | — | — | — | — |
| | | | 177 (25%) | | | | |
| | Dispersion | Anionic | DEMOL NL | 0.24 | 0.24 | 0.24 | 0.24 |
| | Stabilizer | | | | | | |

| | | | | | |
|---|---|---|---|---|---|
| Protective | Aqueous Solution of PVA-217 (10%) | 40 | 40 | 40 | 40 |
| Colloid | | | | | |
| Homomixer | Number of Revolution (rpm) × Time (minutes) | 14000 × | 14000 × | 14000 × | 14000 × |
| Dispersion | | 10 | 10 | 10 | 10 |
| Conditions | | | | | |

| | | | | | |
|---|---|---|---|---|---|
| Status of Aqueous Dispersion of | Median Size of Hydrophobic Solution Dispersion | 379 | 300 | 289 | 295 |
| Hydrophobic Solution | Particles*¹ (nm) | | | | |

| | | | | | |
|---|---|---|---|---|---|
| Physical Properties | Antibiotic Compound Concentration (mass %) [vs Controlled Release | 30 | 30 | 30 | 30 |
| | Particles] | | | | |
| | Controlled Release Particles Concentration (mass %) [vs Emulsion] | 33.3 | 33.3 | 33.3 | 33.3 |
| | Antibiotic Compound Concentration (mass %) [vs Emulsion] | 10.0 | 10.0 | 10.0 | 10.0 |
| | Median Size of Controlled Release Particles (nm) | 392 | 295 | 302 | 305 |

TABLE A3

| | | | | | | | Example A | | | |
|---|---|---|---|---|---|---|---|---|---|---|
| | | | δp | δh | Molecular | Melting Point | Example | Example | Example | Example |
| | | | [(J/cm³)^{1/2}] | [(J/cm³)^{1/2}] | Weight | (° C.) | A9 | A10 | A11 | A12 |
| Hydro- | Antibiotic | IPBC | 3.23 | 7.83 | 281 | 60 | — | — | — | — |
| phobic | Compound | OIT | 5.47 | 5.87 | 213 | <20 | — | — | — | — |
| Solution | | Cyfluthrin | 3.46 | 6.09 | 434 | 57, 74, 66, 102 | — | — | — | — |
| | | Propiconazole | 6.55 | 9.44 | 342 | <20 | — | — | — | — |
| | | Prochloraz | 7.07 | 8.31 | 375 | 45-52 | — | — | — | — |
| | | Flusilazole | 5.95 | 6.85 | 315 | 54 | — | — | — | — |
| | | DEET | 5.42 | 5.83 | 191 | <20 | 30 | 50 | — | — |
| | | Permethrin | 3.63 | 6.22 | 391 | 34-35 | — | — | 30 | — |
| | | Ethofenprox | 2.27 | 5.33 | 377 | 36-38 | — | — | — | 30 |

| | Mixing Ratio of Antibiotic Compound relative to Polymerizable Vinyl | | 0.43 | 1.00 | 0.43 | 0.43 |
|---|---|---|---|---|---|---|
| | Monomer | | | | | |
| Polymerizable | Miscible | Methyl Methacrylate | 65.8 | 47 | 65.8 | 65.8 |
| Vinyl | Monomer | Isobutyl Methacrylate | — | — | — | — |
| Monomer | Crosslinkable | Ethylene Glycol Dimethacrylate | 4.2 | 3.0 | 4.2 | 4.2 |
| | Monomer | | | | | |

| | | | | | |
|---|---|---|---|---|---|
| Oil-soluble Polymerization | PEROYL L | 0.5 | 0.5 | 0.5 | 0.5 |
| Initiator | | | | | |

| δp [(J/cm³)^{1/2}] of Polymer | | | | 5.95 | 5.95 | 5.95 | 5.95 |
|---|---|---|---|---|---|---|---|
| δh [(J/cm³)^{1/2}] of Polymer | | | | 9.32 | 9.32 | 9.32 | 9.32 |
| Δδp [(J/cm³)^{1/2}] | | (=δp, polymer-δp, compound) | | 0.53 | 0.53 | 2.32 | 3.68 |
| Δδh [(J/cm³)^{1/2}] | | (=δh, polymer-δh, compound) | | 3.49 | 3.49 | 3.1 | 3.99 |
| Aqueous Emulsifier | Ion-exchange Water | | | 108.26 | 157.26 | 157.26 | 157.26 |
| Solution | Emulsifier | Anionic | NEOCOL SW-C | 1.0 | 2.0 | 2.0 | 2.0 |
| | | Non-ionic | Aqueous Solution of NOIGEN EA- | — | — | — | — |
| | | | 177 (25%) | | | | |
| | Dispersion | Anionic | DEMOL NL | 0.24 | 0.24 | 0.24 | 0.24 |
| | Stabilizer | | | | | | |

| | | | | | |
|---|---|---|---|---|---|
| Protective | Aqueous Solution of PVA-217 (10%) | 40 | 40 | 40 | 40 |
| Colloid | | | | | |
| Homomixer | Number of Revolution (rpm) × Time (minutes) | 12000 × | 14000 × | 14000 × | 14000 × |
| Dispersion | | 10 | 10 | 10 | 10 |
| Conditions | | | | | |

| | | | | | |
|---|---|---|---|---|---|
| Status of Aqueous Dispersion of | Median Size of Hydrophobic Solution Dispersion | 320 | 261 | 372 | 366 |
| Hydrophobic Solution | Particles*¹ (nm) | | | | |

| | | | | | |
|---|---|---|---|---|---|
| Physical Properties | Antibiotic Compound Concentration (mass %) [vsControlled Release | 30 | 50 | 30 | 30 |
| | Particles] | | | | |
| | Controlled Release Particles Concentration (mass %) [vsEmulsion] | 40 | 33.3 | 33.3 | 33.3 |
| | Antibiotic Compound Concentration (mass %) [vsEmulsion] | 12.0 | 16.7 | 10.0 | 10.0 |
| | Median Size of Controlled Release Particles (nm) | 330 | 271 | 392 | 381 |

TABLE A4

| | | | | | | | Comparative Example A | | |
|---|---|---|---|---|---|---|---|---|---|
| | | | | | | | | Compar- | Compar |
| | | | | | | | Comparative | ative | ative |
| | | | δp | δh | Molecular | Melting | Example | Example | Example |
| | | | [(J/cm³)^{1/2}] | [(J/cm³)^{1/2}] | Weight | Point (° C.) | A1 | A2 | A3 |
| Hydrophobic | Antibiotic | IPBC | 3.23 | 7.83 | 281 | 60 | 25 | — | — |
| Solution | Compound | OIT | 5.47 | 5.87 | 213 | <20 | — | — | — |
| | | Cyfluthrin | 3.46 | 6.09 | 434 | 57, 74, 66, | — | — | — |
| | | | | | | 102 | | | |
| | | Propiconazole | 6.55 | 9.44 | 342 | <20 | — | — | — |
| | | Prochloraz | 7.07 | 8.31 | 375 | 45-52 | — | — | — |
| | | Flusilazole | 5.95 | 6.85 | 315 | 54 | — | — | — |
| | | DEET | 5.42 | 5.83 | 191 | <20 | — | — | — |
| | | Permethrin | 3.63 | 6.22 | 391 | 34-35 | — | — | — |
| | | Ethofenprox | 2.27 | 5.33 | 377 | 36-38 | — | — | — |

| | Mixing Ratio of Antibiotic Compound | | 0.33 | — | — |
|---|---|---|---|---|---|
| | relative to Polymerizable Vinyl Monomer | | | | |
| Polymerizable | Miscible Monomer | Methyl Methacrylate | 75 | 100 | 64 |
| Vinyl | | Isobutyl Methacrylate | — | — | 30 |
| Monomer | Crosslinkable | Ethylene Glycol Dimethacrylate | — | — | 6 |
| | Monomer | | | | |

| | | | | |
|---|---|---|---|---|
| Oil-soluble Polymerization | PEROYL L | 0.5 | 0.5 | 0.5 |
| Initiator | | | | |

| δp [(J/cm³)^{1/2}] of Polymer | | 5.98 | 5.98 | 5.28 |
|---|---|---|---|---|
| δh [(J/cm³)^{1/2}] of Polymer | | 9.25 | 9.25 | 8.74 |
| Δδp [(J/cm³)^{1/2}] | (=δp, polymer-δp, compound) | 2.74 | — | — |
| Δδh [(J/cm³)^{1/2}] | (=δh, polymer-δh, compound) | 1.42 | | |

| | | | | |
|---|---|---|---|---|
| Aqueous Emulsifier | Ion-exchange Water | 149.5 | 125.5 | 125.5 |

| | | | | | | |
|---|---|---|---|---|---|---|
| Solution | Emulsifier | Anionic | NEOCOL SW-C | — | 4.0 | 4.0 |
| | | Non-ionic | Aqueous Solution of NOIGEN EA- | — | 20 | 20 |
| | | | 177 (25%) | | | |
| | Dispersion | Anionic | DEMOL NL | — | — | — |
| | Stabilizer | | | | | |

| | | | | |
|---|---|---|---|---|
| Protective Colloid | Aqueous Solution of PVA-217 (10%) | — | — | — |
| Homomixer | Number of Revolution (rpm) × Time (minutes) | — | — | — |
| Dispersion | | | | |
| Conditions | | | | |

| | | | | |
|---|---|---|---|---|
| Status of Aqueous Dispersion of | Median Size of Hydrophobic Solution Dispersion | (Enlargement)*² | 2060 | 504 |
| Hydrophobic Solution | Particles*¹ (nm) | | | |

| | | | | |
|---|---|---|---|---|
| Physical Properties | Antibiotic Compound Concentration (mass %) | — | — | — |
| | [vs Controlled Release Particles] | | | |
| | Controlled Release Particles Concentration (mass %) [vs Emulsion] | — | — | — |
| | Antibiotic Compound Concentration (mass %) [vs Emulsion] | — | — | — |
| | Median Size of Controlled Release Particles (nm) | — | — | — |

TABLE A5

| | | | | | | Comparative Example A | |
|---|---|---|---|---|---|---|---|
| | | | | | | Comparative | Comparative |
| | | δp | δh | Molecular | Melting | Example | Example |
| | | [(J/cm³)^{1/2}] | [(J/cm³)^{1/2}] | Weight | Point (° C.) | A4 | A5 |
| Antibiotic | IPBC | 3.24 | 7.83 | 281 | 60 | 25 | 25 |

| Compound | Mixing Ratio of Antibiotic Compound relative | | | 0.33 | — |
|---|---|---|---|---|---|
| | to Polymerizable Vinyl Monomer | | | | |
| Polymerizable | Miscible Monomer | Methyl Methacrylate | | 52.5 | — |
| Vinyl | Crosslinkable Monomer | Ethylene Glycol Dimethacrylate | | 22.5 | — |
| Monomer | | | | | |
| Film-forming | Polyisocyanate | T-1890 | | — | 10 |
| Component | Polyamine | Aqueous Solution of DETA (10%) | | — | 13 |
| Solvent | | ATBC | | — | 64 |
| Oil-soluble Polymerization Initiator | | PEROYL L | | 0.5 | — |
| δp [(J/cm³)^{1/2}] of Polymer | | | | 5.80 | — |
| δh [(J/cm³)^{1/2}] of Polymer | | | | 9.60 | — |
| Δδp [(J/cm³)^{1/2}] | | (=δp, polymer-δp, compound) | | 2.57 | — |
| Δδh [(J/cm³)^{1/2}] | | (=δh, polymer-δh, compound) | | 1.77 | — |
| Aqueous | Ion-exchange Water | | | 109.3 | 97.8 |
| Emulsifier | Emulsifier | Anionic | Aqueous Solution of DBN (5%) | 0.2 | 0.2 |

| | | | | |
|---|---|---|---|---|
| Solution | Dispersing Agent | Aqueous Solution of PVA-217 (10%) | 40 | 40 |

| | | | |
|---|---|---|---|
| Status of Aqueous Dispersion of | Median Size of Hydrophobic Solution | 10 | 10 |
| Hydrophobic Solution | Dispersion Particles*¹ (μm) | | |

| | | | |
|---|---|---|---|
| Physical | Controlled Release Particles Concentration (mass %) [vs Emulsion] | 40 | 40 |
| Properties | Antibiotic Compound Concentration (mass %) [vs Emulsion] | 10 | 10 |
| | Median Size of Controlled Release Particles (μm) | 10 | 10 |

*¹Median Size after 20 minutes passed from Preparation

Evaluation

### 1. Stability of Mini-Emulsion

### (1) Example A1 to Example A12

The median size of the hydrophobic solution dispersion particles (mini-emulsion particles) was measured for those mini-emulsions of Example A1 to Example A12 allowed to stand at room temperature for a predetermined time. The results are shown below.

### (1-1) Example A1

20 minutes passed from preparation 194 nm
5 hours passed from preparation 195 nm
24 hours passed from preparation 192 nm

### (1-2) Example A2

20 minutes passed from preparation 223 nm
16 hours passed from preparation 220 nm

### (1-3) Example A3

20 minutes passed from preparation 199 nm
5 hours passed from preparation 203 nm
24 hours passed from preparation 201 nm

### (1-4) Example A4

20 minutes passed from preparation 175 nm
5 hours passed from preparation 173 nm
24 hours passed from preparation 171 nm

### (1-5) Example A5

20 minutes passed from preparation 379 nm
5 hours passed from preparation 382 nm
24 hours passed from preparation 380 nm

### (1-6) Example A6

20 minutes passed from preparation 300 nm
5 hours passed from preparation 305 nm
24 hours passed from preparation 301 nm

### (1-7) Example A7

20 minutes passed from preparation 289 nm
5 hours passed from preparation 294 nm
24 hours passed from preparation 287 nm

### (1-8) Example A8

20 minutes passed from preparation 295 nm
5 hours passed from preparation 297 nm
24 hours passed from preparation 299 nm

### (1-9) Example A9

20 minutes passed from preparation 320 nm
5 hours passed from preparation 315 nm
24 hours passed from preparation 317 nm

### (1-10) Example A10

20 minutes passed from preparation 261 nm
5 hours passed from preparation 265 nm
24 hours passed from preparation 257 nm

### (1-11) Example A11

20 minutes passed from preparation 372 nm
5 hours passed from preparation 375 nm
24 hours passed from preparation 379 nm

### (1-12) Example A12

20 minutes passed from preparation 366 nm
5 hours passed from preparation 370 nm
24 hours passed from preparation 372 nm

### (2) Comparative Example A1 to Comparative Example A3

The conditions of the hydrophobic solution dispersion particles (oil droplets) were observed, or their median size was measured for those aqueous dispersions of Comparative Example A1 to Comparative Example A3 allowed to stand at room temperature for a predetermined time. The results are shown below.

### (2-1) Comparative Example A1

1 hour passed from preparation Enlargement of oil droplets
(That is, unification of oil droplets, phase separation)

### (2-2) Comparative Example A2

20 minutes passed from preparation 2.06 μm
5 hours passed from preparation 2.54 μm
24 hours passed from preparation 3.31 μm

### (2-3) Comparative Example A3

20 minutes passed from preparation 504 nm
5 hours passed from preparation 679 nm
24 hours passed from preparation 914 nm

### 2. SEM (Scanning Electron Microscope) Observation

The emulsion obtained in Example A2 was naturally dried, and furthermore, coated with metal (electrical conduction treatment) to prepare a sample. The prepared sample was observed with a scanning electron microscope (model number “S-4800”, manufactured by Hitachi High-Technologies Corporation).

The image-processed SEM photographs of Example A2 are shown in FIG. A1 and FIG. A2.

The image-processed SEM photographs show that the controlled release particles are particles with a measured median size value of 230 nm.

### 3. TEM (Transmission Electron Microscope) Observation

Emulsions of Example A2, Example A4 to Example A9, Example A11, and Example A12 are naturally dried, and are dispersed in a bisphenol liquid epoxy resin, and cured with amine. The cured products were cut with an ultramicrotome to expose the cross sections, dyed with ruthenium tetroxide, and cut into ultra thin slices with an ultramicrotome, thereby preparing samples. The prepared samples were observed with a transmission electron microscope (model number “H-7100”, manufactured by Hitachi, Ltd.).

Image-processed TEM photographs of Example A2 are shown in FIG. A3 and FIG. A4. Image-processed TEM photographs of Example A4 are shown in FIG. A5 and FIG. A6. Image-processed TEM photographs of Example A5 are shown in FIG. A7 and FIG. A8. Image-processed TEM photographs of Example A6 are shown in FIG. A9 and FIG. A10. Image-processed TEM photographs of Example A7 are shown in FIG. A11 and FIG. A12. Image-processed TEM photographs of Example A8 are shown in FIG. A13 and FIG. A14. Image-processed TEM photographs of Example A9 are shown in FIG. A15 and FIG. A16. Image-processed TEM photographs of Example A11 are shown in FIG. A17 and FIG. A18. Image-processed TEM photographs of Example A12 are shown in FIG. A19 and FIG. A20.

The images show that the outer layer (surface) of the controlled release particles are covered with an extremely thin emulsifier layer dyed with ruthenium tetroxide, and that the inner layer (inside) of the controlled release particles has a uniform structure without phase separation.

### 4. Controlled Release Properties Test on Controlled Release Particles Containing IPBC (Example A1, Example A2, and Comparative Example A4, Comparative Example A5)

The controlled release particles containing IPBC of Example A1, Example A2, and Comparative Example A4, Comparative Example A5 were subjected to a controlled release properties test of IPBC in the following manner.

First, samples for the controlled release properties test were prepared from emulsions of Example A1 and Example A2 and suspension liquids of Comparative Example A4 and Comparative Example A5 (all having an IPBC concentration of 10 mass %), and an IPBC suspension liquid (IPBC concentration of 30 mass %) as a control in which IPBC was suspended in water. The sample of the control was named Comparative Example A6.

Then, the prepared samples were introduced in an amount of 20 mg (IPBC, by mass) into five polypropylene-made 50 mL centrifuge tubes, respectively. Then, deionized water was added so that the total thereof was 40 g, thereby preparing an IPBC-containing liquid with an IPBC concentration of 0.05 mass %.

Then, the five centrifuge tubes were set in a shaker (TAITEC RECIPRO SHAKER SR-1 manufactured by TAITEC CORPORATION) and were shaken at a rate of 140 times/min. The shaking was stopped at an every predetermined time period. The centrifuge tubes were set in a centrifuge (micro refrigerated centrifuge 3740, manufactured by KUBOTA Corporation) and solid-liquid separation was performed at 15000 rpm for 5 minutes.

Deionized water was added to the solid portion so that the total thereof was 40 g, and the solid portion was re-dispersed with a microspatula. The mixture was set again in the shaker to continue shaking again.

Meanwhile, IPBC in the liquid portion was determined using HPLC manufactured by Shimadzu Corporation, thereby calculating the controlled-release rate.

The controlled-release rate in each shaking time was calculated as a cumulative value (that is, total controlled-release rate).

The results are shown in FIG. A21.

The controlled release particles obtained by mini-emulsion polymerization of Example A1 and Example A2 are slow in controlled-release speed compared with the controlled release particles obtained by interfacial polymerization of Comparative Example A5 and the IPBC particles prepared as control of Comparative Example A6, but fast in controlled-release speed compared with controlled release particles obtained by suspension polymerization of Comparative Example A4.

The controlled release particles of Example A1 and Example A2 had an average particle size of 201 nm and 230 nm, respectively, and had a surface area of about 40 times the surface area of the controlled release particles having an average particle size of 10 μm of Comparative Example A4 and Example A5: thus, compared with the controlled release particles of Comparative Example A4 and Comparative Example A5, controlled release properties per unit surface area of the controlled release particles are excellent.

### 5. Controlled Release Properties Test on Controlled Release Particles Containing OIT (Example A3)

The controlled release particles containing OIT of Example A3 were subjected to a controlled release properties test of OIT in the following manner.

First, samples for the controlled release properties test were prepared from emulsion (OIT concentration 10 mass %) of Example A3 and an OIT (KATHON 893T) suspension liquid (OIT concentration 10 mass %) as a control, in which OIT was suspended in water.

Then, samples were added so that OIT was 1000 ppm by mass relative to the solid content amount of acrylic styrene water-based paint (Ultrasol A-20 base, titanium oxide concentration 20 mass %, solid content concentration 50 mass %, manufactured by Aica Kogyo Co., Ltd.) and the mixture was stirred, thereby preparing paints for evaluation. The sample of the control was named Comparative Example A7.

Then, the paints for evaluation were applied on an aluminum plate using #75 bar coater, and heated at 40° C. for 16 hours and dried, thereby forming a coating.

Then, the aluminum plate was cut into a size of 70 mm×150 mm to prepare a cut plate, and the cut plate were set to Dewpanel Weather Meter (set to rainfall only) manufactured by Suga Test Instruments Co., Ltd., exposing the cut plate under rainfall environment for seven days.

The cut plate after the exposure to the rainfall was cut into a size of 25 mm×25 mm to prepare test pieces, and the test pieces were put into glass bottles. Methanol in an amount of 10 ml was added to the glass bottles, and OIT in the coating of the test piece was extracted by ultrasonic extraction for 10 minutes.

The methanol extraction liquid with which OIT was extracted was analyzed with HPLC manufactured by Shimadzu Corporation, thereby calculating the remaining rate of OIT in the coating.

The results are shown in FIG. A22.

The results show that the coating to which the controlled release particles of Example A3 were added had a high OIT remaining rate in the coating compared with Comparative Example A7.

### 6. Controlled Release Properties Test on Controlled Release Particles Containing Cyfluthrin (Example A5)

The controlled release particles containing cyfluthrin of Example A5 were subjected to a controlled release properties test in the following manner.

That is, an emulsion of controlled release particles (emulsion agent)(cyfluthrin concentration 10 mass %) of Example A5, and a solution of 10 mass % acetinitrile in which cyfluthrin was dissolved as a control were prepared.

Then, two sheets of circular filter paper (Toyo Roshi Kaisha, Ltd. No. 5C, corresponds to type 5C JIS P 3801) were piled and pleated.

Then, to the filter paper, 0.5 mL of the prepared emulsion of Examples A5, and 0.5 mL of the solution of cyfluthrin in acetonitrile were poured slowly, and thereafter dried in air.

Thereafter, the filter paper was put into a glass bottle, and 180 mL of ion-exchange water/methanol (=50/50 (volume ratio)) mixture liquid was added thereto, and allowed to stand and to be impregnated at room temperature for 20 hours. Then, the ion-exchange water/methanol mixture liquid was collected, 180 mL of another ion-exchange water/methanol mixture liquid was added thereto, and allowed to stand and to be impregnated for 20 hours at room temperature. Thereafter, the above-described ion-exchange water/methanol mixture liquid exchange operation was repeated twice.

The controlled-release amount of the cyfluthrin was calculated using LC/TOF-MS based on the each of the ion-exchange water/methanol mixture liquids collected as described above. The controlled-release amount in the each mixture was calculated as a cumulative value (that is, total controlled-release amount).

The results are shown in FIG. A23.

### 7. Controlled Release Test on Controlled Release Particles Containing Propiconazole (Example A6)

Controlled release particles containing propiconazole of Example A6 were subjected to controlled release properties test in the following manner.

First, an emulsion of controlled release particles of Example A6 (propiconazole concentration 10 mass %), and a propiconazole suspension liquid (propiconazole concentration 10 mass %) in which propiconazole was dispersed as a control were prepared.

Then, two sheets of circular filter paper (Toyo Roshi Kaisha, Ltd. No. 5C, corresponds to type 5C of JIS P 3801) were piled and folded to be pleated.

Then, 0.5 mL of the prepared emulsion and suspension liquid were slowly poured individually onto the filter papers, and thereafter dried in air.

To the filter paper, water in an amount of 1000 mL was passed through using a metered-dose tube pump at a flow rate of 20 mL/hr, and controlled-release rate of propiconazole was calculated using HPLC based on the propiconazole amount of the obtained filtrate and the propiconazole amount remained in the filter paper. The controlled-release rate in each amount of water passed through was calculated as a cumulative value (that is, total controlled-release rate).

The results are shown in FIG. A24.

### 8. Controlled Release Test on Controlled Release Particles Containing Prochloraz (Example A7)

Controlled release test on the controlled release particles containing prochloraz of Example A7 was performed in conformity with the above-described “7. Controlled release test on controlled release particles containing propiconazole”.

The results are shown in FIG. A25.

### 9. Controlled Release Test on Controlled Release Particles Containing Flusilazole (Example A8)

Controlled release test on the controlled release particles containing flusilazole of Example A8 was performed in conformity with the above-described “7. Controlled release test on controlled release particles containing propiconazole”.

The results are shown in FIG. A26.

### 10. Controlled Release Properties Test on Controlled Release Particles Containing DEET (Example A10)

### (1) Preparation of Insect Cage

A frame coupled unit 1 shown in FIG. A27 was produced using a dry square timber (Japanese cedar, 42 mm×42 mm).

That is, the frame coupled unit 1 extends longer in left-right directions, and includes a first frame 2 and a second frame 3 disposed to face each other in spaced-apart relation in left-right directions, and a connection frame 4 that connects the first frame 2 and the second frame 3.

The first frame 2 and the second frame 3 were formed into a rectangular parallelepiped frame. The connection frame 4 is formed to connect the upper portions of the first frame 2 and the second frame 3. The first frame 2 and the second frame 3 had a size of the following: a length in left-right directions of 300 mm, a length in front-rear direction (depth) of 210 mm, and a length in up-down directions (height) of 210 mm. The connection frame 4 had a size of the following: a length in left-right directions of 210 mm, a length in front-rear direction of 210 mm, and a length in up-down directions of 70 mm.

Thereafter, as shown in FIG. A28, filter cloths 5 having 40 pores are disposed as exterior surfaces on the frame coupled unit 1 shown in FIG. A27, and by fixing their peripheral end portions with pushpins to the first frame 2, the second frame 3, and the connection frame 4, the insect cage 10 was produced.

That is, in the insect cage 10, a first space 6 that is defined by the first frame 2 and the filter cloths 5, and a second space 7 that is defined by the second frame 3 and the filter cloths 5, and a connection space 8 defined by the connection frame 4 and the filter cloths 5 were formed. The first space 6 and the second space 7 are communicating with each other through the connection space 8.

In this manner, the filter cloths 5 are removable and attachable to the frames, and air freely goes there through. The small insects to be put into the insect cage 10 can freely travels from and to the first space 6 and the second space 7 through the connection space 8, but cannot go outside the insect cage 10.

### (2) Controlled Release Particles Containing DEET of Example A10

A square filter paper was cut into a size of 120×200 mm. An emulsion of controlled release particles containing 10 mass % of DEET was prepared by diluting the emulsion of Example A10 with ion-exchange water to 1.67 times. The prepared emulsion was sprayed with an atomizer onto the square filter paper as DEET so that the emulsion was applied in an amount of 200 mg of DEET. The square filter paper was placed above the filter cloths 5 on the bottom face of the first space 6 of the insect cage 10 and allowed to stand outside in the shade (Konohana ward, Osaka City, Japan) in summer (August 2012).

Slices of apple (bait for common house mosquito to be described later) were placed above the bottom face of the filter cloths 5 in the second space 7 of the insect cage 10.

Then, 20 common house mosquitoes emerged on the day of the test were released in the second space 7 of the insect cage 10. After the release, for 8 hours, and even after 24 hours, the 20 common house mosquitoes did not move from the second space 7 to the first space 6.

### (3) Controlled Release Properties Test on Control of Example A10

A square filter paper was cut into a size of 120×200 mm, and an ethylalcohol solution of 10 mass % DEET was sprayed onto a filter paper using an atomizer so that the solution of 10 mass % DEET was applied in an amount of 200 mg of DEET: this was named control. The filter paper was placed above the filter cloths 5 on the bottom face of the first space 6 of the insect cage 10 and allowed to stand outside in the shade (Konohana ward, Osaka City) in summer (August 2012).

Slices of apple (bait for common house mosquito to be described later) were placed above the bottom face of the filter cloths 5 in the second space 7 of the insect cage 10.

Then, 20 common house mosquitoes emerged on the day of the test were released in the second space 7 of the insect cage 10. After the release, up to 8 hours, the 20 common house mosquitoes did not move from the second space 7 to the first space 6.

However, after 24 hours from the release, 7 common house mosquitoes moved from the second space 7 to the first space 6.

### 11. Controlled Release Properties Test on Controlled Release Particles Containing Permethrin (Example A11)

The controlled release properties test was conducted for controlled release particles containing permethrin of Example A11 in conformity with “6. Controlled release properties test on controlled release particles containing cyfluthrin” above.

The results are shown in FIG. A29.

### 12. Controlled Release Properties Test on Controlled Release Particles Containing Ethofenprox (Example A12)

The controlled release properties test was conducted for controlled release particles containing ethofenprox of Example A12 in conformity with “6. Controlled release properties test on controlled release particles containing cyfluthrin” above.

The results are shown in FIG. A30.

### [2] Examples B Corresponding to the Second Invention Group

Details of the ingredients and the measurement methods used in Examples B and Comparative Examples B are described below.

IPBC: trade name “Fungitrol 400”, 3-iodo-2-propynylbutylcarbamate, molecular weight 281, melting point: 60° C., water solubility: 150 ppm, polar term δ_{p,IPBC} of the solubility parameter (δ): 3.23 [(J/cm³)^{1/2}], hydrogen bonding term δ_{h,IPBC} of the solubility parameter (δ): 7.83 [(J/cm³)^{1/2}], manufactured by International Specialty Products Inc.

MMA: methyl methacrylate, trade name “ACRYESTER M”, water solubility: 1.6 mass %, polar term δ_{p,1st monomer unit} of the solubility parameter (δ): 5.98 [(J/cm³)^{1/2}], hydrogen bonding term δ_{h,1st monomer unit} of the solubility parameter (δ): 9.25 [(J/cm³)^{1/2}], manufactured by Mitsubishi Rayon Co., Ltd.

EGDMA: ethylene glycol dimethacrylate, trade name “Light Ester EG”, water solubility: 5.37 ppm, polar term δ_{p,1st monomer unit} of the solubility parameter (δ): 5.37 [(J/cm³)^{1/2}], hydrogen bonding term δ_{h,1st monomer unit} of the solubility parameter (δ): 10.42 [(J/cm³)^{1/2}], manufactured by Kyoeisha Chemical Co., Ltd.

nBMA: n-butyl methacrylate, water solubility: 0.08 mass %, polar term δ_{p,2nd monomer unit} of the solubility parameter (δ): 3.76 (J/cm³)^{1/2}], hydrogen bonding term δ_{h,2nd monomer unit} of the solubility parameter (δ): 7.33 [(J/cm³)^{1/2}], manufactured by Mitsubishi Rayon Co., Ltd.

MA: methyl acrylate, water solubility: 5.7 mass %, polar term δ_{p,2nd monomer unit} of the solubility parameter (δ): 7.36 [(J/cm³)^{1/2}], hydrogen bonding term δ_{h,2nd monomer unit} of the solubility parameter (δ): 10.25 [(J/cm³)^{1/2}], manufactured by Nippon Shokubai Co., Ltd.

EA: ethyl acrylate, water solubility: 1.5 mass %, polar term δ_{p,2nd monomer unit} of the solubility parameter (δ): 5.93 [(J/cm³)^{1/2}], hydrogen bonding term δ_{h,2nd monomer unit} of the solubility parameter (δ): 9.20 [(J/cm³)^{1/2}], manufactured by Nippon Shokubai Co., Ltd.

nBA: n-butyl acrylate, water solubility: 0.2 mass %, polar term δ_{p,2nd monomer unit} of the solubility parameter (δ): 4.26 [(J/cm³)^{1/2}], hydrogen bonding term δ_{h,2nd monomer unit} of the solubility parameter (δ): 7.81 [(J/cm³)^{1/2}], manufactured by Nippon Shokubai Co., Ltd.

SM: styrene, water-insoluble, polar term δ_{p,2nd monomer unit} of the solubility parameter (δ): 1.27 [(J/cm³)^{1/2}], hydrogen bonding term δ_{h,2nd monomer unit} of the solubility parameter (δ): 0.00 [(J/cm³)¹″²]

PEROYL L: trade name (“PEROYL” is registered trademark), dilauroyl peroxide, manufactured by NOF CORPORATION

NEOCOL SW-C: trade name, solution of 70 mass % sodium dioctyl sulfosuccinate (anionic emulsifier) in isopropanol, manufactured by Dai-ichi Kogyo Seiyaku Co., Ltd.

NOIGEN EA-177: trade name, polyoxyethylene styrenated phenylether (non-ionic emulsifier, HLB:15.6), manufactured by Dai-ichi Kogyo Seiyaku Co., Ltd.

Average Particle Size: samples below were evaluated by the following measurement method.

Hydrophobic solution dispersion particles and controlled release particles of Example B1 to Example B20 and Comparative Example B4 to Comparative Example B6, and hydrophobic solution dispersion particles of Comparative Example B1 and Comparative Example B2

Measured as volume-based median size by dynamic light scattering using a particle size analyzer (FPAR-1000, measurable average particle size 3 nm to 7 μm, however, measurement accuracy significantly decreases in the range when the particle size is over several μm and where the effects of gravity are large on Brownian movement, Otsuka Electronics Co., Ltd.).

For the hydrophobic solution dispersion particles, mini-emulsion after 20 minutes passed from preparation was subjected to measurement.

For the controlled release particles, filtrate was subjected to measurement after filtration with a filter cloth having 100 pores.

Controlled Release Particles of Comparative Example B3:

Filtrate after filtration with a filter cloth having 100 pores was measured as volume-based median size by laser diffraction using a laser diffraction scattering particle size distribution analyzerLA-920 (measurable average particle size 20 nm to 2000 μm, however, with the particle size of 1 μm or less, angular dependence of Mie scattering is lost, and measurement accuracy significantly decreases, manufactured by HORIBA, Ltd.).

### Example B1

### Production of Controlled Release Particles Containing IPBC by Mini-Emulsion Polymerization

A 200 mL container was charged with 25 g of IPBC, 75 g of MMA, and 0.5 g of PEROYL L, and the mixture was stirred at room temperature, thereby producing a homogenous hydrophobic solution.

Separately, a 500 mL beaker was charged with 125.5 g of deionized water, 4.0 g of NEOCOL SW-C, and 20 g of an aqueous solution of 25 mass % NOIGEN EA-177, and the mixture was stirred at room temperature, thereby producing a homogenous aqueous emulsifier solution.

Then, a hydrophobic solution was added to the aqueous emulsifier solution of the 500 mL beaker, and the mixture was stirred with T.K. Homo Mixer MARK model 2.5 (manufactured by PRIMIX Corporation) at 12000 rpm for 5 minutes to emulsify the hydrophobic solution in the aqueous emulsifier solution, thereby preparing a mini-emulsion.

Thereafter, the prepared mini-emulsion was transferred to a 300 mL, 4-neck flask equipped with a stirrer, a reflux condenser, a thermometer, and a nitrogen inlet tube, and polymerized by mini-emulsion polymerization under nitrogen gas current, while stirring with a 6 cm-diameter stirrer at 125 rpm (circumferential speed 23.6 m/min), and increasing the temperature of the 4-neck flask with water bath.

The mini-emulsion polymerization was regarded as initiated when the temperature reached 55° C., and thereafter, polymerization was performed continuously for 1 hour at 60±2° C., and for 3.5 hours at 70±2° C.

Then, the temperature of the water bath was increased to increase the temperature of the reaction solution to 78±2° C., and the reaction solution was aged at that temperature for 2.5 hours.

Thereafter, the reaction solution was cooled to 30° C. or less, thereby producing an emulsion of controlled release particles containing IPBC.

Thereafter, the emulsion was filtered with a filter cloth having 100 pores, and the median size of the controlled release particles in the filtrate was measured: as a result, the median size was 201 nm.

The emulsion was a colloidal dispersion stable as a normal polymer latex, and no tendency of sedimentation or phase separation of the controlled release particles was observed during storage at room temperature.

### Example B2, Example B3, Example B7 to Example B9, Example B13, and Example B17

Controlled release particles were produced in the same manner as in Example B1, except that the mixing formulation of the polymerizable vinyl monomer was changed in conformity with Table B1 and Table B2.

Any of the emulsions of Example B2, Example B3, Example B7 to Example B9, Example B13, and Example B17 was a colloidal dispersion stable as a normal polymer latex, and no tendency of sedimentation or phase separation of the particles was observed during storage at room temperature.

### Example B4

### Production of Controlled Release Particles Containing IPBC by Mini-Emulsion Polymerization

A 200 mL container was charged with 40 g of IPBC, 54 g of MMA, 6 g of EGDMA, and 0.5 g of PEROYL L, and the mixture was stirred at room temperature, thereby producing a homogenous hydrophobic solution.

Separately, a 1000 mL beaker was charged with 275.5 g of deionized water, 4.0 g of NEOCOL SW-C, and 20 g of an aqueous solution of 25 mass % NOIGEN EA-177, and the mixture was stirred at room temperature, thereby producing a homogenous aqueous emulsifier solution.

Then, a hydrophobic solution was added to the aqueous emulsifier solution of the 1000 mL beaker, and the mixture was stirred with T.K. Homo Mixer MARK model 2.5 (manufactured by PRIMIX Corporation) at 12000 rpm for 5 minutes to emulsify the hydrophobic solution in the aqueous emulsifier solution, thereby preparing a mini-emulsion.

Thereafter, the prepared mini-emulsion was transferred to a 500 mL, 4-neck flask equipped with a stirrer, a reflux condenser, a thermometer, and a nitrogen inlet tube, and polymerized by mini-emulsion polymerization in the same manner as in Example B1.

Thereafter, the reaction solution was cooled to 30° C. or less, thereby producing an emulsion of controlled release particles containing IPBC. The emulsion was filtered with a filter cloth having 100 pores, and the median size of the controlled release particles in the filtrate was measured: as a result, the median size was 238 nm.

The emulsion was a colloidal dispersion stable as a normal polymer latex, and no tendency of sedimentation or phase separation of the particles was observed during storage at room temperature.

### Example B5, Example B6, Example B10 to Example B12, Example B14 to Example B16 and Example B18 to Example B20

Controlled release particles were produced in the same manner as in Example B4, except that the mixing formulation of the polymerizable vinyl monomer was changed in conformity with Table B1 and Table B2.

Any of the emulsions of Example B5, Example B6, Example B10 to Example B12, Example B14 to Example B16, and Example B18 to Example B20 was a colloidal dispersion stable as a normal polymer latex, and no tendency of sedimentation or phase separation of the particles was observed during storage at room temperature.

### Comparative Example B1

### Preparation of Aqueous Dispersion in which Emulsifier was not Blended

An aqueous dispersion of the hydrophobic solution was prepared in the same manner as in Example B1, except that in the preparation of the aqueous emulsifier solution, NEOCOL SW-C and NOIGEN EA-177 (both emulsifiers) were not blended.

However, the oil droplets composed of the hydrophobic solution did not form mini-emulsion particles, and therefore mini-emulsion polymerization could not be performed.

### Comparative Example B2

### Preparation of Aqueous Dispersion in which IPBC was not Blended

An aqueous dispersion of the hydrophobic solution was prepared in the same manner as in Example B1, except that in preparation of the hydrophobic solution, 25 g of IPBC and 75 g of MMA were replaced with 100 g of MMA.

However, the oil droplets composed of the hydrophobic solution did not form mini-emulsion particles with an average particle size of below 1 μm, and therefore mini-emulsion polymerization could not be performed.

### Comparative Example B3

### Production of Controlled Release Particles Containing IPBC by Suspension Polymerization

A 200 mL container was charged with 25 g of IPBC, 67.5 g of MMA, 7.5 g of EGDMA, and 0.5 g of PEROYL L, and the mixture was stirred at room temperature, thereby producing a homogenous hydrophobic solution.

Separately, a 500 mL beaker was charged with 109.3 g of deionized water, 40 g of aqueous solution of 10 mass % PVA-217, and 200 mg of aqueous solution of 5% DBN, and the mixture was stirred at room temperature, thereby producing a homogenous aqueous solution.

Then, a hydrophobic solution was added to the 500 mL beaker, and the mixture was stirred with T.K. Homo Mixer (manufactured by PRIMIX Corporation) at 3000 rpm for 10 minutes to disperse the hydrophobic solution in the aqueous solution, thereby preparing a suspension liquid.

Thereafter, the suspension liquid was transferred to a 300 mL, 4-neck flask equipped with a stirrer, a reflux condenser, a thermometer, and a nitrogen inlet tube, and polymerized by suspension polymerization under nitrogen gas current, while stirring with a stirrer at 125 rpm, and increasing the temperature of the 4-neck flask with water bath.

The suspension polymerization was regarded as initiated when the temperature reached 55° C., and thereafter, the polymerization was performed continuously for 1 hour at 60±2° C., for 3 hours at 70±2° C., for 2 hours at 80±2° C.

Thereafter, the suspension liquid after the reaction was cooled to 30° C. or less, thereby producing a suspension liquid of controlled release particles containing IPBC.

Thereafter, the median size of the suspension liquid was measured: as a result, the median size was 10 μm.

The produced suspension liquid was transferred from the 4-neck flask to a translucent polyethylene container, and the conditions of the controlled release particles when allowed to stand at room temperature for a few hours were observed. It was confirmed that the controlled release particles were sedimented, and separation into two layers occurred.

After three days passed at room temperature, the sedimented lower layer formed a hard cake that cannot be re-dispersed even with strong shaking and mixing.

### Comparative Example B4 to Comparative Example B6

Synthesis of controlled release particles was conducted in the same manner as in Example B4, except that the mixing formulation of the polymerizable vinyl monomer was changed in conformity with Table B3.

However, polymerization stability (ref: Table B3, column of remaining amount on filter cloth having 100 pores) of mini-emulsion to be described later was low, needle crystal of IPBC deposited in a large amount, and remained on the filter cloth having 100 pores at the time of filtering. Therefore, mini-emulsion polymerization with IPBC sufficiently contained was not performed.

### (Mixing Formulation)

The mixing formulation of Examples B and Comparative Examples B are shown in Table B1 to Table B4.

In Table B, the values under the columns of the mixing formulation of ingredients are shown in grams unless otherwise noted.

TABLE B1

| | | | | | | Example B | | | | |
|---|---|---|---|---|---|---|---|---|---|---|
| | | | | δp | δh | Example | Example | Example | Example | Example |
| | | | | [(J/cm²)^{1/2}] | [(J/cm²)^{1/2}] | B1 | B2 | B3 | B4 | B5 |
| Hydrophobic | IPBC | | | 3.23 | 7.83 | 25 | 25 | 25 | 40 | 40 |
| Solution | Polymerizable | First Monomer | MMA | 5.98 | 9.25 | 75 | 70.5 | 67.5 | 54 | 42 |
| | Vinyl Monomer | | EGDMA | 5.37 | 10.42 | — | 45 | 75 | 6 | 18 |
| | | | δp, 1st monomer unit(s) [(J/cm³)^{1/2}] | | | 5.98 | 5.95 | 5.92 | 5.92 | 5.80 |
| | | | δh, 1st monomer unit(s) [(J/cm³)^{1/2}] | | | 9.25 | 9.32 | 9.36 | 9.36 | 9.60 |
| | | Second | nBMA | 3.76 | 7.33 | — | — | — | — | — |
| | | Monomer | MA | 7.36 | 10.25 | — | — | — | — | — |
| | | | EA | 5.93 | 9.20 | — | — | — | — | — |
| | | | nBA | 4.26 | 7.81 | — | — | — | — | — |
| | | | SM | 1.27 | 0.00 | — | — | — | — | — |
| | | | δp, 2nd monomer unit [(J/cm³)^{1/2}] | | | — | — | — | — | — |
| | | | δh, 2nd monomer unit [(J/cm³)^{1/2}] | | | — | — | — | — | — |
| | Oil-soluble Polymerization | | | PEROYL L | | 0.5 | 0.5 | 0.5 | 0.5 | 0.5 |
| Polymer | δp, polymer [(J/cm³)^{1/2}] | | | | | 5.98 | 5.95 | 5.92 | 5.92 | 5.80 |
| | δh, polymer [(J/cm³)^{1/2}] | | | | | 9.25 | 9.32 | 9.36 | 9.36 | 9.60 |
| | Δδp [(J/cm³)^{1/2}] | | | | | 2.75 | 2.72 | 2.69 | 2.69 | 2.57 |
| | Δδh [(J/cm³)^{1/2}] | | | | | 1.42 | 1.49 | 1.53 | 1.53 | 1.77 |
| Aqueous | | Ion-exchange Water | | | | 125.5 | 125.5 | 125.5 | 275.5 | 275.5 |
| Emulsifier | | Emulsifier | Anionic | NEOCOL SW-C | | 4.0 | 4.0 | 4.0 | 4.0 | 4.0 |
| Solution | | | Non-ionic | Aqueous Solution of | | 20 | 20 | 20 | 20 | 20 |
| | | | | NOIGEN EA-177 (25%) | | | | | | |
| Status of Aqueous Dispersion of Hydrophobic Solution | | | | Median Size of | | 194 | 223 | 231 | 233 | 243 |
| | | | | Hydrophobic Solution | | | | | | |
| | | | | Dispersion | | | | | | |
| | | | | Particles*¹ (nm) | | | | | | |
| Physical Properties | | Controlled Release | | Concentration of IPBC | | 40.0 | 40.0 | 40.0 | 25.0 | 25.0 |
| | | Particles Concentration | | and Polymer in total | | | | | | |
| | | (mass %) [vs Emulsion] | | (excluding Emulsifier) | | | | | | |
| | | | | Concentration of IPBC, | | 43.3 | 43.3 | 43.3 | 27.1 | 27.1 |
| | | | | Polymer, and Emulsifier | | | | | | |
| | | | | in total | | | | | | |
| | | IPBC concentration (mass %) [vs Emulsion] | | | | 10.0 | 10.0 | 10.0 | 10.0 | 10.0 |
| | | Median Size of Controlled Release Particles (nm) | | | | 201 | 230 | 236 | 238 | 250 |
| | | Remaining Amount on Filter Cloth having | | | | 0 | 0 | 18 | 49 | 108 |
| | | 100 pores (mg)*³ | | | | | | | | |
| | | | | | | Example B | | | | |
| | | | | δp | δh | Example | Example | Example | Example | Example |
| | | | | [(J/cm²)^{1/2}] | [(J/cm²)^{1/2}] | B6 | B7 | B8 | B9 | B10 |
| Hydrophobic | IPBC | | | 3.23 | 7.83 | 40 | 25 | 25 | 25 | 40 |
| Solution | Polymerizable | First Monomer | MMA | 5.98 | 9.25 | 30 | 71.25 | 73.5 | 30 | 24 |
| | Vinyl Monomer | | EGDMA | 5.37 | 10.42 | 30 | 3.75 | 15 | 22.5 | 18 |

| | δp, 1st monomer unit(s) [(J/cm³)^{1/2}] | | | 5.68 | 5.95 | 5.97 | 5.72 | 5.72 |
|---|---|---|---|---|---|---|---|---|
| | δh, 1st monomer unit(s) [(J/cm³)^{1/2}] | | | 9.83 | 9.30 | 9.30 | 9.75 | 9.75 |
| Second | nBMA | 3.76 | 7.33 | — | — | — | 22.5 | 18 |
| Monomer | MA | 7.36 | 10.25 | — | — | — | — | — |
| | EA | 5.93 | 9.20 | — | — | — | — | — |
| | nBA | 4.26 | 7.81 | — | — | — | — | — |
| | SM | 1.27 | 0.00 | — | — | — | — | — |

| | | | | | |
|---|---|---|---|---|---|
| δp, 2nd monomer unit [(J/cm³)^{1/2}] | — | — | — | 3.76 | 3.76 |
| δh, 2nd monomer unit [(J/cm³)^{1/2}] | — | — | — | 7.33 | 7.33 |

| | | | | | | |
|---|---|---|---|---|---|---|
| Oil-soluble Polymerization | PEROYL L | 0.5 | 0.5 | 0.5 | 0.5 | 0.5 |

| | | | | | | |
|---|---|---|---|---|---|---|
| Polymer | δp, polymer [(J/cm³)^{1/2}] | 5.68 | 5.95 | 5.97 | 5.13 | 5.13 |
| | δh, polymer [(J/cm³)^{1/2}] | 9.83 | 9.30 | 9.30 | 9.02 | 9.02 |
| | Δδp [(J/cm³)^{1/2}] | 2.45 | 2.72 | 2.74 | 1.90 | 1.90 |
| | Δδh [(J/cm³)^{1/2}] | 2.00 | 1.47 | 1.47 | 1.19 | 1.19 |

| Aqueous | Ion-exchange Water | | | 275.5 | 125.5 | 125.5 | 125.5 | 275.5 |
|---|---|---|---|---|---|---|---|---|
| Emulsifier | Emulsifier | Anionic | NEOCOL SW-C | 4.0 | 4.0 | 4.0 | 4.0 | 4.0 |
| Solution | | Non-ionic | Aqueous Solution of | 20 | 20 | 20 | 20 | 20 |
| | | | NOIGEN EA-177 (25%) | | | | | |

| Status of Aqueous Dispersion of Hydrophobic Solution | | Median Size of | 249 | 218 | 197 | 252 | 260 |
|---|---|---|---|---|---|---|---|
| | | Hydrophobic Solution | | | | | |
| | | Dispersion | | | | | |
| | | Particles*¹ (nm) | | | | | |
| Physical Properties | Controlled Release | Concentration of | 25.0 | 40.0 | 40.0 | 40.0 | 25.0 |
| | Particles Concentration | IPBC and Polymer in | | | | | |
| | (mass %) [vs Emulsion] | total (excluding Emulsifier) | | | | | |
| | | Concentration of IPBC, | 27.1 | 43.3 | 43.3 | 43.3 | 27.1 |
| | | Polymer, and Emulsifier | | | | | |
| | | in total | | | | | |

| | | | | | |
|---|---|---|---|---|---|
| IPBC concentration (mass %) [vs Emulsion] | 10.0 | 10.0 | 10.0 | 10.0 | 10.0 |
| Median Size of Controlled Release Particles (nm) | 255 | 225 | 205 | 260 | 266 |
| Remaining Amount on Filter Cloth having | 240 | 0 | 0 | 27 | 76 |
| 100 pores (mg)*³ | | | | | |

*¹Median Size after 20 minutes passed from Preparation
*³Remainder of filtering with Filter Cloth having 100 pores after allowing reaction solution to stand for 16 hours (Needle Crystal of IPBC)

TABLE B2

| | | | | | | Example B | | | | |
|---|---|---|---|---|---|---|---|---|---|---|
| | | | | δp | δh | Example | Example | Example | Example | Example |
| | | | | [(J/cm²)^{1/2}] | [(J/cm²)^{1/2}] | B11 | B12 | B13 | B14 | B15 |
| Hydrophobic | IPBC | | | 3.23 | 7.83 | 40 | 40 | 25 | 40 | 40 |
| Solution | Polymerizable Vinyl | First | MMA | 5.98 | 9.25 | 27 | 30 | 30 | 24 | 27 |
| | Monomer | Monomer | EGDMA | 5.37 | 10.42 | 18 | 18 | 22.5 | 18 | 18 |

| | δp, 1st monomer unit(s) [(J/cm³)^{1/2}] | | | 5.74 | 5.75 | 5.72 | 5.72 | 5.74 |
|---|---|---|---|---|---|---|---|---|
| | δh, 1st monomer unit(s) [(J/cm³)^{1/2}] | | | 9.71 | 9.68 | 9.75 | 9.75 | 9.71 |
| Second | nBMA | 3.76 | 7.33 | 15 | 12 | — | — | — |
| Monomer | MA | 7.36 | 10.25 | — | — | — | — | — |
| | EA | 5.93 | 9.20 | — | — | 22.5 | 18 | 15 |
| | nBA | 4.26 | 7.81 | — | — | — | — | — |
| | SM | 1.27 | 0.00 | — | — | — | — | — |

| | | | | | |
|---|---|---|---|---|---|
| δp, 2nd monomer unit [(J/cm³)^{1/2}] | 3.76 | 3.76 | 5.93 | 5.93 | 5.93 |
| δh, 2nd monomer unit [(J/cm³)^{1/2}] | 7.33 | 7.33 | 9.20 | 9.20 | 9.20 |

| | | | | | | |
|---|---|---|---|---|---|---|
| Oil-soluble Polymerization | PEROYL L | 0.5 | 0.5 | 0.5 | 0.5 | 0.5 |
| Initiator | | | | | | |

| | | | | | | |
|---|---|---|---|---|---|---|
| Polymer | δp, polymer [(J/cm³)^{1/2}] | 5.24 | 5.36 | 5.78 | 5.78 | 5.79 |
| | δh, polymer [(J/cm³)^{1/2}] | 9.12 | 9.21 | 9.58 | 9.58 | 9.59 |
| | Δδp [(J/cm³)^{1/2}] | 2.01 | 2.13 | 2.55 | 2.55 | 2.56 |
| | Δδh [(J/cm³)^{1/2}] | 1.29 | 1.38 | 1.75 | 1.75 | 1.76 |

| Aqueous | Ion-exchange Water | | | 275.5 | 275.5 | 125.5 | 275.5 | 275.5 |
|---|---|---|---|---|---|---|---|---|
| Emulsifier | Emulsifier | Anionic | NEOCOL SW-C | 4.0 | 4.0 | 4.0 | 4.0 | 4.0 |
| Solution | | Non-ionic | Aqueous Solution of NOIGEN EA-177 (25%) | 20 | 20 | 20 | 20 | 20 |

| | | | | | | |
|---|---|---|---|---|---|---|
| Status of Aqueous Dispersion of | Median Size of Hydrophobic Solution | 241 | 225 | 239 | 243 | 245 |
| Hydrophobic Solution | Dispersion Particles*¹ (nm) | | | | | |

| | | | | | | | |
|---|---|---|---|---|---|---|---|
| Physical | Controlled Release | Concentration of IPBC and Polymer in total | 25.0 | 25.0 | 40.0 | 25.0 | 25.0 |
| Properties | Particles Concentration | (excluding Emulsifier) | | | | | |
| | (mass %) [vs Emulsion] | Concentration of IPBC, Polymer, and | 27.1 | 27.1 | 43.3 | 27.1 | 27.1 |
| | Emulsifier in total | | | | | | |

| | | | | | |
|---|---|---|---|---|---|
| IPBC concentration (mass %) [vs Emulsion] | 10.0 | 10.0 | 10.0 | 10.0 | 10.0 |
| Median Size of Controlled Release Particles (nm) | 244 | 230 | 242 | 248 | 248 |
| Remaining Amount on Filter Cloth having 100 pores (mg)*³ | 21 | 23 | 28 | 71 | 19 |

| | | | | | | Example B | | | | |
|---|---|---|---|---|---|---|---|---|---|---|
| | | | | δp | δh | Example | Example | Example | Example | Example |
| | | | | [(J/cm²)^{1/2}] | [(J/cm²)^{1/2}] | B16 | B17 | B18 | B19 | B20 |
| Hydrophobic | IPBC | | | 3.23 | 7.83 | 40 | 25 | 40 | 40 | 40 |
| Solution | Polymerizable Vinyl | First | MMA | 5.98 | 9.25 | 30 | 30 | 24 | 27 | 30 |
| | Monomer | Monomer | EGDMA | 5.37 | 10.42 | 18 | 22.5 | 18 | 18 | 18 |

| | δp, 1st monomer unit(s) [(J/cm³)^{1/2}] | | | 5.75 | 5.72 | 5.72 | 5.74 | 5.75 |
|---|---|---|---|---|---|---|---|---|
| | δh, 1st monomer unit(s) [(J/cm³)^{1/2}] | | | 9.68 | 9.75 | 9.75 | 9.71 | 9.68 |
| Second | nBMA | 3.76 | 7.33 | — | — | — | — | — |
| Monomer | MA | 7.36 | 10.25 | — | — | — | — | — |
| | EA | 5.93 | 9.20 | 12 | — | — | — | — |
| | nBA | 4.26 | 7.81 | — | 22.5 | 18 | 15 | 12 |
| | SM | 1.27 | 0.00 | — | — | — | — | — |

| | | | | | |
|---|---|---|---|---|---|
| δp, 2nd monomer unit [(J/cm³)^{1/2}] | 5.93 | 4.26 | 4.26 | 4.26 | 4.26 |
| δh, 2nd monomer unit [(J/cm³)^{1/2}] | 9.20 | 7.81 | 7.81 | 7.81 | 7.81 |

| | | | | | | |
|---|---|---|---|---|---|---|
| Oil-soluble Polymerization | PEROYL L | 0.5 | 0.5 | 0.5 | 0.5 | 0.5 |
| Initiator | | | | | | |

| | | | | | | |
|---|---|---|---|---|---|---|
| Polymer | δp, polymer [(J/cm³)^{1/2}] | 5.79 | 5.28 | 5.28 | 5.37 | 5.46 |
| | δh, polymer [(J/cm³)^{1/2}] | 9.59 | 9.16 | 9.16 | 9.24 | 9.31 |
| | Δδp [(J/cm³)^{1/2}] | 2.56 | 2.05 | 2.05 | 2.14 | 2.23 |
| | Δδh [(J/cm³)^{1/2}] | 1.76 | 1.33 | 1.33 | 1.41 | 1.48 |

| Aqueous | Ion-exchange Water | | | 275.5 | 125.5 | 275.5 | 275.5 | 275.5 |
|---|---|---|---|---|---|---|---|---|
| Emulsifier | Emulsifier | Anionic | NEOCOL SW-C | 4.0 | 4.0 | 4.0 | 4.0 | 4.0 |
| Solution | | Non-ionic | Aqueous Solution of NOIGEN EA-177 (25%) | 20 | 20 | 20 | 20 | 20 |

| | | | | | | |
|---|---|---|---|---|---|---|
| Status of Aqueous Dispersion of | Median Size of Hydrophobic Solution | 241 | 251 | 252 | 245 | 238 |
| Hydrophobic Solution | Dispersion Particles*¹ (nm) | | | | | |

| | | | | | | | |
|---|---|---|---|---|---|---|---|
| Physical | Controlled Release | Concentration of IPBC and Polymer in total | 25.0 | 40.0 | 25.0 | 25.0 | 25.0 |
| Properties | Particles Concentration | (excluding Emulsifier) | | | | | |
| | (mass %) [vs Emulsion] | Concentration of IPBC, Polymer, and | 27.1 | 43.3 | 27.1 | 27.1 | 27.1 |
| | Emulsifier in total | | | | | | |

| | | | | | |
|---|---|---|---|---|---|
| IPBC concentration (mass %) [vs Emulsion] | 10.0 | 10.0 | 10.0 | 10.0 | 10.0 |
| Median Size of Controlled Release Particles (nm) | 247 | 253 | 259 | 250 | 244 |
| Remaining Amount on Filter Cloth having 100 pores (mg)*³ | 25 | 26 | 63 | 15 | 18 |

*¹Median Size after 20 minutes passed from Preparation
*³Remainder of filtering with Filter Cloth having 100 pores after allowing reaction solution to stand for 16 hours(Needle Crystal of IP

TABLE B3

| | | | | | | Comparative Example B | | | | |
|---|---|---|---|---|---|---|---|---|---|---|
| | | | | | | Comparative | Comparative | Comparative | Comparative | Comparative |
| | | | | δp | δh | Example | Example | Example | Example | Example |
| | | | | [(J/cm²)^{1/2}] | [(J/cm²)^{1/2}] | B1 | B2 | B4 | B5 | B6 |
| Hydro- | IPBC | | | 3.23 | 7.83 | 25 | — | 40 | 40 | 40 |
| phobic | Poly- | First | MMA | 5.98 | 9.25 | 75 | 100 | — | — | — |
| Solution | merizable | Monomer | EGDMA | 5.37 | 10.42 | — | — | 18 | 18 | 18 |
| | Vinyl | | δp, 1st monomer unit(s) [(J/cm³)^{1/2}] | | | 5.98 | 5.98 | 5.37 | 5.37 | 5.37 |
| | Monomer | | δh, 1st monomer unit(s) [(J/cm³)^{1/2}] | | | 9.25 | 9.25 | 10.42 | 10.42 | 10.42 |
| | | Second | nBMA | 3.76 | 7.33 | — | — | 42 | — | — |
| | | Monomer | MA | 7.36 | 10.25 | — | — | — | — | 42 |
| | | | EA | 5.93 | 9.20 | — | — | — | — | — |
| | | | nBA | 4.26 | 7.81 | — | — | — | — | — |
| | | | SM | 1.27 | 0.00 | — | — | — | 42 | — |

| | | | | | |
|---|---|---|---|---|---|
| δp, 2nd monomer unit [(J/cm³)^{1/2}] | — | — | 3.76 | 1.27 | 7.36 |
| δh, 2nd monomer unit [(J/cm³)^{1/2}] | — | — | 7.33 | 0 | 10.25 |

| | | | | | | |
|---|---|---|---|---|---|---|
| Oil-soluble Polymerization Initiator | PEROYL L | 0.5 | 0.5 | 0.5 | 0.5 | 0.5 |

| | | | | | | |
|---|---|---|---|---|---|---|
| Polymer | δp, polymer [(J/cm³)^{1/2}] | 5.98 | 5.98 | 4.25 | 2.50 | 6.76 |
| | δh, polymer [(J/cm³)^{1/2}] | 9.25 | 9.25 | 8.26 | 3.13 | 10.30 |
| | Δδp [(J/cm³)^{1/2}] | 2.75 | — | 1.02 | −0.73 | 3.53 |
| | Δδh [(J/cm³)^{1/2}] | 1.42 | | 0.43 | −4.70 | 2.47 |

| Aqueous | Ion-exchange Water | | | 149.5 | 125.5 | 275.5 | 275.5 | 275.5 |
|---|---|---|---|---|---|---|---|---|
| Emulsifier | Emulsifier | Anionic | NEOCOL SW-C | — | 4.0 | 4.0 | 4.0 | 4.0 |
| Solution | | Non-ionic | Aqueous Solution of | — | 20 | 20 | 20 | 20 |
| | | | NOIGEN EA-177 (25%) | | | | | |

| | | | | | | |
|---|---|---|---|---|---|---|
| Status of Aqueous Dispersion | Median Size of | (Enlargement)*² | 2060 | 272 | 290 | 212 |
| of Hydrophobic Solution | Hydrophobic Solution | | | | | |
| | Dispersion Particles*¹ (nm) | | | | | |

| Physical | Controlled Release Particles Concentration | — | — | | |
|---|---|---|---|---|---|
| Properties | (mass %) [vs Emulsion] | | | | |
| | IPBC concentration (mass %) [vs Emulsion] | | | | |
| | Median Size of Controlled Release Particles (nm) | | 270 | 283 | 870 |
| | Remaining Amount on Filter Cloth having | | 18.4 × 10³ | 23.8 × 10³ | 30.3 × 10³ |
| | 100 pores (mg)*³ | | | | |

*¹Median Size after 20 minutes passed from Preparation
*²State of Phase Separation
*³Remainder of filtering with Filter Cloth having 100 pores after allowing reaction solution to stand for 16 hours(Needle Crystal of IPBC)

TABLE B4

| | | | | | | Comparative |
|---|---|---|---|---|---|---|
| | | | | | | Example B |
| | | | | | | Comparative |
| | | δp | δh | Molecular | Melting | Example |
| | | [(J/cm³)^{1/2}] | [(J/cm³)^{1/2}] | Weight | Point (° C.) | B3 |
| Antibiotic | IPBC | 3.23 | 7.83 | 281 | 60 | 25 |

| Compound | Mixing Ratio of Antibiotic Compound relative to Polymerizable Vinyl Monomer | | 0.33 |
|---|---|---|---|
| Polymerizable | Miscible Monomer | Methyl Methacrylate | 67.5 |
| Vinyl Monomer | Crosslinkable Monomer | Ethylene Glycol Dimethacrylate | 7.5 |

| Oil-soluble Polymerization Initiator | PEROYL L | 0.5 |
|---|---|---|
| δp [(J/cm³)^{1/2}] of Polymer | | 5.92 |
| δh [(J/cm³)^{1/2}] of Polymer | | 9.36 |
| Δδp [(J/cm³)^{1/2}] | (=δp, polymer-δp, compound) | 2.69 |
| Δδh [(J/cm³)^{1/2}] | (=δh, polymer-δh, compound) | 1.53 |

| Dispersing Agent | Ion-exchange Water | | 109.3 |
|---|---|---|---|
| Aqueous | Emulsifier | Aqueous Solution of DBN (5%) | 0.2 |
| Solution | Dispersing Agent | Aqueous Solution of PVA-217 (10%) | 40 |

| | | |
|---|---|---|
| Status of Aqueous Dispersion of | Median Size of Hydrophobic Solution Dispersion | 10 |
| Hydrophobic Solution | Particles*¹ (μm) | |

| | | |
|---|---|---|
| Physical | Controlled Release Particles Concentration (mass %) [vs Emulsion] | 40 |
| Properties | Antibiotic Compound Concentration (mass %) [vs Emulsion] | 10 |
| | Median Size of Controlled Release Particles (μm) | 10 |

*¹Median Size after 20 minutes passed from Preparation

### Evaluation

### 1. Stability of Mini-Emulsion

### (1) Example B1 to Example B20

The median size of the hydrophobic solution dispersion particles (mini-emulsion particles) was measured for those mini-emulsions of Example B1 to Example B20 allowed to stand at room temperature for a predetermined time. The results are shown below.

### (1-1) Example B1

20 minutes passed from preparation 194 nm
5 hours passed from preparation 195 nm
24 hours passed from preparation 192 nm

### (1-2) Example B2

20 minutes passed from preparation 223 nm
16 hours passed from preparation 223 nm

### (1-3) Example B3

20 minutes passed from preparation 231 m
5 hours passed from preparation 233 nm
24 hours passed from preparation 233 nm

### (1-4) Example B4 to Example B20

The ratio of the median size after 20 minutes passed from preparation relative to the median size after 5 hours passed from preparation was within the range of 0.95 to 1.05 in any of Example B4 to Example B20.

The ratio of the median size after 20 minutes passed from preparation relative to the median size after 24 hours passed from preparation was within the range of 0.95 to 1.05 in any of Example B4 to Example B20.

### (2) Comparative Examples B1 and 2

The conditions of the hydrophobic solution dispersion particles (oil droplets) were observed after allowing the aqueous dispersion of Comparative Examples B1 and 2 to stand at room temperature for a predetermined time, or their median size was measured. The results are shown below.

### (2-1) Comparative Example B1

1 hour passed from preparation Enlargement of oil droplets

(That is, unification of oil droplets, phase separation)

### (2-2) Comparative Example B2

20 minutes passed from preparation 2.06 μm
5 hours passed from preparation 2.54 μm
24 hours passed from preparation 3.31 μm

### 2. Remaining Amount on Filter Cloth Having 100 Pores

The reaction solution of Example B1 to Example B20 and Comparative Example B4 to Comparative Example B6 allowed to stand for 16 hours after mini-emulsion polymerization was filtered with a filter cloth having 100 pores, and the amount (mass) of the needle crystal of IPBC remained on the filter cloth was measured.

The results are shown in Table B1 and Table B2.

### 3. SEM (Scanning Electron Microscope) Observation

The emulsion obtained in Example B2 was naturally dried, and furthermore, coated with metal (electrical conduction treatment) to prepare a sample. The prepared sample was observed with a scanning electron microscope (model number “S-4800”, manufactured by Hitachi High-Technologies Corporation).

The image-processed SEM photographs of Example B2 are shown in FIG. B1 and FIG. B2.

The image-processed SEM photographs show that the controlled release particles are particles with a measured median size value of 230 nm.

### 4. TEM (Transmission Electron Microscope) Observation

The emulsion of Example B2 was naturally dried, dispersed in a bisphenol liquid epoxy resin, and cured with amine. The cured products were cut with an ultramicrotome to expose the cross sections, dyed with ruthenium tetroxide, and cut into ultra thin slices with an ultramicrotome, thereby preparing samples. The prepared sample was observed with a transmission electron microscope (model number “H-7100”, manufactured by Hitachi, Ltd.).

The image-processed TEM photographs of Example B2 are shown in FIG. B3 and FIG. B4.

The images show that the outer layer (surface) of the controlled release particles are covered with an extremely thin emulsifier layer dyed with ruthenium tetroxide, and that the inner layer (inside) of the controlled release particles has a uniform structure without phase separation.

### 5. Controlled Release Properties Test on Controlled Release Particles Containing IPBC (Example B1, Example B2, and Comparative Example B3)

The controlled release particles containing IPBC of Example B1, Example B2, and Comparative Example B3 were subjected to a controlled release properties test of IPBC in the following manner.

First, samples for the controlled release properties test were prepared from emulsions of Example B1, Example B2, and Comparative Example B3 (IPBC concentration 10 mass %), and an IPBC suspension liquid (IPBC concentration of 30 mass %) as a blank in which IPBC was suspended in water. The sample of the blank was named Comparative Example B7.

Then, the prepared samples were introduced in an amount of 20 mg (IPBC, by mass) into five polypropylene-made 50 mL centrifuge tubes, respectively. Then, deionized water was added so that the total thereof was 40 g, thereby preparing an IPBC-containing liquid having an IPBC concentration of 0.05 mass %.

Then, the five centrifuge tubes were set in a shaker (TAITEC RECIPRO SHAKER SR-1 manufactured by TAITEC CORPORATION) and were shaken at a rate of 140 times/min. The shaking was stopped at an every predetermined time period. The centrifuge tubes were set in a centrifuge (micro refrigerated centrifuge 3740, manufactured by KUBOTA Corporation) and solid-liquid separation was performed at 15000 rpm for 5 minutes.

Deionized water was added to the solid portion so that the total thereof was 40 g, and the solid portion was re-dispersed with a microspatula. The mixture was set again in the shaker to continue shaking again.

Meanwhile, IPBC in the liquid portion was determined using HPLC manufactured by Shimadzu Corporation, thereby calculating the controlled-release rate.

The controlled-release rate in each shaking time was calculated as a cumulative value (that is, total controlled-release rate).

The results are shown in FIG. B5.

The controlled release particles obtained by mini-emulsion polymerization of Example B1 and Example B2 are slow in controlled-release speed compared with the IPBC in the IPBC suspension liquid prepared as blank of Comparative Example B7, while fast in controlled-release speed compared with IPBC prepared by suspension polymerization of Comparative Example B3.

The controlled release particles of Example B1 had an average particle size of 201 nm, and a surface area of about 50 times the surface area of the controlled release particles of Comparative Example B3 having an average particle size of 10 μm: thus, compared with the controlled release particles of Comparative Example B3, controlled release properties per unit surface area of the controlled release particles are excellent.

### [3] Examples C Corresponding to the Third Invention Group

Details of the ingredients used in Examples C, Reference Examples C, and Comparative Examples C are described below.

IPBC: trade name “Fungitrol 400”, 3-iodo-2-propynylbutylcarbamate, molecular weight 281, melting point: 60° C., water solubility: 150 ppm, polar term δ_{p,IPBC} of the solubility parameter (δ): 3.23 [(J/cm³)^{1/2}], hydrogen bonding term δ_{h,IPBC} of the solubility parameter (δ): 7.83 [(J/cm³)^{1/2}], manufactured by International Specialty Products Inc.

Propiconazole: 1-[2-(2,4-dichlorophenyl)-4-n-propyl-1,3-dioxolane-2-ylmethyl]-1H-1,2,4-triazole, molecular weight 342, melting point below 20° C., water solubility 110 ppm, polar term δ_{p,PROP} of the solubility parameter (δ): 6.55 [(J/cm³)^{1/2}], hydrogen bonding term δ_{h,PROP} of the solubility parameter (δ): 9.44 [(J/cm³)^{1/2}], manufactured by HAKKO TSUSHO CO., LTD.

Cyfluthrin: trade name “Preventol HS12” (“Preventol” is registered trademark), (RS)-α-cyano-4-fluoro-3-phenoxybenzyl=(1RS,3RS)-(1RS,3RS)-3-(2,2-dichlorovinyl)-2,2-methylcyclopropane carboxylate, molecular weight 434, water solubility: 1 to 2 ppb, a mixture of isomer I (melting point 57° C.), isomer II (melting point 74° C.), isomer III (melting point 66° C.), and isomer IV (melting point 102° C.), polar term δ_{p,INSEC} of the solubility parameter (δ): 3.46 [(J/cm³)^{1/2}], hydrogen bonding term δ_{h,INSEC} of the solubility parameter (δ): 6.09 [(J/cm³)^{1/2}], manufactured by LANXESS

MMA: methyl methacrylate, trade name “ACRYESTER M” (ACRYESTER is registered trademark), water solubility: 1.6 mass %, polar term δ_{p,MMA unit} of the solubility parameter (δ) as monomer unit: 5.98 [(J/cm³)^{1/2}], hydrogen bonding term δ_{h,MMA unit} of the solubility parameter (δ) as monomer unit: 9.25 [(J/cm³)^{1/2}], manufactured by Mitsubishi Rayon Co., Ltd.

EGDMA: ethylene glycol dimethacrylate, trade name “Light Ester EG” (Light Ester is registered trademark), water solubility: 5.37 ppm, polar term δ_{p,EGDMA unit} of the solubility parameter (δ) as monomer unit: 5.37 [(J/cm³)^{1/2}], hydrogen bonding term δ_{h,EGDMA unit} of the solubility parameter (δ) as monomer unit: 10.42 [(J/cm³)^{1/2}], manufactured by Kyoeisha Chemical Co., Ltd.

MAA: methacrylic acid, water solubility: 8.9 mass %, polar term δ_{p,2nd monomer unit} of the solubility parameter (δ) as monomer unit: 7.13 [(J/cm³)^{1/2}], hydrogen bonding term δ_{h,2nd monomer unit} of the solubility parameter (δ) as monomer unit: 13.03 [(J/cm³)^{1/2}], manufactured by Mitsubishi Rayon Co., Ltd.

PEROYL L: trade name (“PEROYL” is registered trademark), dilauroyl peroxide, oil-soluble polymerization initiator, manufactured by NOF CORPORATION

Pelex SS-L: trade name, aqueous solution of 50 mass % sodium alkyl diphenyl ether disulfonate (anionic emulsifier), manufactured by Kao Corporation

NEOCOL SW-C: trade name, solution of 70 mass % sodium dioctyl sulfosuccinate (anionic emulsifier) in isopropanol, manufactured by Dai-ichi Kogyo Seiyaku Co., Ltd.

NOIGEN EA-177: trade name, polyoxyethylene styrenated phenylether (non-ionic emulsifier, HLB:15.6), manufactured by Dai-ichi Kogyo Seiyaku Co., Ltd.

DEMOL NL: trade name, aqueous solution of 41 mass % β-sodium naphthalene sulfonate formaldehyde condensate, dispersing agent, manufactured by Kao Corporation

Pronon 208: trade name, polyoxyethylenepolyoxypropylene glycol (non-ionic emulsifier), manufactured by NOF CORPORATION

PVA-217: trade name “Kuraray Poval 217”, aqueous solution of 10 mass % partially saponified polyvinyl alcohol, protective colloid, manufactured by Kuraray Co., Ltd.

### Example C1

### Production of Controlled Release Particles Containing Propiconazole and IPBC by Mini-Emulsion Polymerization

A 200 mL container was charged with 12 g of IPBC, 28 g of propiconazole, 56.4 g of MMA, 3.6 g of EGDMA, and 0.5 g of PEROYL L, and the mixture was stirred at room temperature, thereby producing a homogenous hydrophobic solution.

Separately, a 500 mL beaker was charged with 107.86 g of deionized water, 1.4 g of Pelex SS-L, 40 g of aqueous solution of PVA217 (10%), and 0.24 g of DEMOL NL, and the mixture was stirred at room temperature, thereby producing a homogenous aqueous emulsifier solution.

Then, a hydrophobic solution was added to the aqueous emulsifier solution of the 500 mL beaker, and the mixture was stirred with T.K. Homo Mixer MARK model 2.5 (manufactured by PRIMIX Corporation) at 12000 rpm for 5 minutes to emulsify the hydrophobic solution in the aqueous emulsifier solution, thereby preparing a mini-emulsion.

Thereafter, the prepared mini-emulsion was transferred to a 300 mL, 4-neck flask equipped with a stirrer, a reflux condenser, a thermometer, and a nitrogen inlet tube, and polymerized by mini-emulsion polymerization under nitrogen gas current, while stirring with a 6 cm-diameter stirrer at 200 rpm (circumferential speed 37.7 m/min), and increasing the temperature of the 4-neck flask with water bath.

The mini-emulsion polymerization was regarded as initiated when the temperature reached 55° C., and thereafter, polymerization was performed continuously for 3 hours at 62±2° C., and for 2 hours at 70±2° C.

Then, the temperature of the water bath was increased to increase the temperature of the reaction solution to 80±2° C., and the reaction solution was aged for 2 hours.

Thereafter, the reaction solution was cooled to 30° C. or less, thereby producing an emulsion of controlled release particles containing IPBC and propiconazole.

### Example C2 to Example C11

Emulsion of controlled release particles was obtained in the same manner as in Example C1, except that the mixing formulation of the component and the conditions were changed in conformity with Table C1 and Table C2.

### Comparative Example C1

### Production of Controlled Release Particles Containing Propiconazole and IPBC by Suspension Polymerization

A 200 mL container was charged with 12 g of propiconazole, 28 g of IPBC, 56.4 g of MMA, 3.6 g of EGDMA, and 0.5 g of PEROYL L, and the mixture was stirred at room temperature, thereby producing a homogenous hydrophobic solution.

Separately, a 500 mL beaker was charged with 108.5 g of deionized water, 1.0 g of aqueous solution of Pronon 208 (1%), 40 g of aqueous solution of PVA217 (10%), and the mixture was stirred at room temperature, thereby producing a homogenous aqueous solution.

Then, a hydrophobic solution was added to the aqueous solution of the 500 mL beaker, and the mixture was stirred with T.K. Homo Mixer MARK model 2.5 (manufactured by PRIMIX Corporation) at 3000 rpm for 5 minutes to disperse the hydrophobic solution in the aqueous solution, thereby preparing a dispersion liquid.

Thereafter, the prepared dispersion liquid was transferred to a 300 mL, 4-neck flask equipped with a stirrer, a reflux condenser, a thermometer, and a nitrogen inlet tube, and polymerized by suspension polymerization under nitrogen gas current, while stirring with a 6 cm-diameter stirrer at 200 rpm (circumferential speed 37.7 m/min), and increasing the temperature of the 4-neck flask with water bath.

The suspension polymerization was regarded as initiated when the temperature reached 55° C., and thereafter, the polymerization was performed continuously for 3 hours at 62±2° C., and for 2 hours at 70±2° C.

Then, the temperature of the water bath was increased to increase the temperature of the reaction solution to 80±2° C., and the reaction solution was aged for 2 hours.

Thereafter, the reaction solution was cooled to 30° C. or less, thereby producing a suspension liquid of controlled release particles containing IPBC and propiconazole.

### Reference Example C1

An emulsion of controlled release particles containing IPBC was obtained in the same manner as in Example C1, except that the mixing formulation of the component and the conditions were changed in conformity with Table C3.

### Reference Example C2

An emulsion of controlled release particles containing IPBC was obtained in the same manner as in Example C1, except that the mixing formulation of the component and the conditions were changed in conformity with Table C3.

### Reference Example C3

An emulsion of controlled release particles containing propiconazole was obtained in the same manner as in Example C1, except that the mixing formulation of the component and the conditions were changed in conformity with Table C3.

### Reference Example C4

The emulsion of Reference Example C2 in an amount of 90 g and the emulsion of Reference Example C3 in an amount of 105 g were mixed, thereby producing an emulsion containing 9 g of IPBC and 21 g of propiconazole.

### (Mixing Formulation)

The mixing formulations in Examples C, Reference Examples C, and Comparative Examples C are shown in Table C1, Table C2, and Table C3.

In the emulsions of Example C1 to Example C11, Comparative Example C1, Reference Example C1, Reference Example C2, and Reference Example C3, the antibiotic compound (IPBC and propiconazole) content of the controlled release particles, the controlled release particles content of the emulsion, and the antibiotic compound content in the emulsion on a mass basis are shown in Table C1, Table C2, and Table C3.

In Tables C, “%” represents “mass %” unless otherwise indicated.

TABLE C1

| | | | Example C | | | | | | | | | | | |
|---|---|---|---|---|---|---|---|---|---|---|---|---|---|---|
| | | | Example | | Example | | Example | | Example | | Example | | Example | |
| | | | C1 | | C2 | | C3 | | C4 | | C5 | | C6 | |
| Hydrophobic | Antibiotic | IPBC | 12 | g | 13.5 | g | 15 | g | 16.5 | g | 18 | g | 19.5 | g |
| Solution | Compound | Propiconazole | 28 | g | 31.5 | g | 35 | g | 38.5 | g | 42 | g | 45.5 | g |
| | | Cyfluthrin | — | | — | | — | | — | | — | | — | |
| | Polymerizable | MMA | 56.4 | g | 51.7 | g | 47.0 | g | 42.3 | g | 37.6 | g | 32.9 | g |
| | Vinyl Monomer | MAA | — | | — | | — | | — | | — | | — | |
| | | EGDMA | 3.6 | g | 3.3 | g | 3.0 | g | 2.7 | g | 2.4 | g | 2.1 | g |
| | Polymerization | PEROYL L | 0.5 | g | 0.5 | g | 0.5 | g | 0.5 | g | 0.5 | g | 0.5 | g |
| | Initiator | | | | | | | | | | | | | |
| δP, polymer of Polymer [(J/cm³)^{1/2}] | | | 5.95 | | 5.95 | | 5.95 | | 5.95 | | 5.95 | | 5.95 | |
| δh, polymer of Polymer[(J/cm³)^{1/2}] | | | 9.32 | | 9.32 | | 9.32 | | 9.32 | | 9.32 | | 9.32 | |
| Aqueous | Emulsifier | Pelex SS-L | 1.4 | g | 5.6 | g | 5.6 | g | 5.6 | g | — | | — | |
| Emulsifier | | NEOCOL SW-C | — | | — | | — | | — | | 4.0 | g | 4.0 | g |
| Solution | | NOIGEN EA-177 | — | | — | | — | | — | | 20 | g | 20 | g |
| | Protective Colloid | PVA217(10%) | 40 | g | 40 | g | 40 | g | 40 | g | — | | — | |
| | Dispersing Agent | DEMOL NL | 0.24 | g | 0.24 | g | 0.24 | g | 0.24 | g | 0.24 | g | 0.24 | g |

| | | | | | | | | | | | | |
|---|---|---|---|---|---|---|---|---|---|---|---|---|
| Deionized water | 107.86 | g | 103.66 | g | 103.66 | g | 103.66 | g | 125.26 | g | 125.26 | g |

| | | | | | | | | | | | | |
|---|---|---|---|---|---|---|---|---|---|---|---|---|
| Total | 250 | g | 250 | g | 250 | g | 250 | g | 250 | g | 250 | g |

| | | | | | | | |
|---|---|---|---|---|---|---|---|
| Dispersion | Number of | 12000 rpm × | 12000 rpm × | 12000 rpm × | 12000 rpm × | 12000 rpm × | min |
| Conditions | Revolution × Time | 5 min | 5 min | 5 min | 5 min | 5 min | 12000 rpm × |
| | | | | | | | 5 min |

| Physical | Remaining Amount on Filter Cloth having | 2.65% | | 0.08% | | 0.02% | | 0.05% | | 0.04% | | 0.02% | |
|---|---|---|---|---|---|---|---|---|---|---|---|---|---|
| Properties | 100 pores [vs Controlled Release Particles] | | | | | | | | | | | | |
| | Antibiotic Compound Content | 40% | | 45% | | 50% | | 55% | | 60% | | 65% | |
| | [vs Controlled Release Particles] | | | | | | | | | | | | |
| | Controlled Release Particles Content | 40% | | 40% | | 40% | | 40% | | 40% | | 40% | |
| | [vs Suspension] | | | | | | | | | | | | |
| | Antibiotic Compound Content | 16% | | 18% | | 20% | | 22% | | 24% | | 26% | |
| | [vs Suspension] | | | | | | | | | | | | |
| | Median Size | 429 | nm | 333 | nm | 329 | nm | 356 | nm | 306 | nm | 321 | nm |

| | | | | | | |
|---|---|---|---|---|---|---|
| Controlled Release Particles Content | 2.0% | 0.0% | 0.0% | 0.0% | 0.0% | 0.0% |
| (Controlled Release Particles of 1 μm or | | | | | | |
| more) | | | | | | |
| Deposit of Needle Crystal of IPBC | No | No | No | No | No | No |
| After 14 days at 40° C. | Deposit | Deposit | Deposit | Deposit | Deposit | Deposit |

TABLE C2

| | | | Example C | | | | | | | | | |
|---|---|---|---|---|---|---|---|---|---|---|---|---|
| | | | Example | | Example | | Example | | Example | | Example | |
| | | | C7 | | C8 | | C9 | | C10 | | C11 | |
| Hydrophobic | Antibiotic | IPBC | 21 | g | 35 | g | 12 | g | 15 | g | 12 | g |
| Solution | Compound | Propiconazole | 49 | g | 20 | g | 28 | g | 15 | g | 18 | g |
| | | Cyfluthrin | — | | — | | 2 | g | — | | — | |
| | Polymerizable | MMA | 28.2 | g | 42.3 | g | 54.52 | g | 48 | g | 48 | g |
| | Vinyl Monomer | MAA | — | | — | | — | | 2.0 | g | 2.0 | g |
| | | EGDMA | 1.8 | g | 2.7 | g | 3.48 | g | 20 | g | 20 | g |
| | Polymerization | PEROYL L | 0.5 | g | 0.5 | g | 0.5 | g | 0.5 | g | 0.5 | g |
| | Initiator | | | | | | | | | | | |
| δP, polymer of Polymer [(J/cm³)^{1/2}] | | | 5.95 | | 5.95 | | 5.95 | | 5.84 | | 5.84 | |
| δh, polymer of Polymer [(J/cm³)^{1/2}] | | | 9.32 | | 9.32 | | 9.32 | | 9.69 | | 9.69 | |
| Aqueous | Emulsifier | Pelex SS-L | — | | — | | — | | — | | — | |
| Emulsifier | | NEOCOL SW-C | 4.0 | g | 4.0 | g | 4.0 | g | 4.0 | g | 4.0 | g |
| Solution | | NOIGEN EA-177 | 20 | g | 20 | g | — | | 20 | g | 20 | g |
| | Protective Colloid | PVA217(10%) | — | | — | | 40 | g | — | | — | |
| | Dispersing Agent | DEMOL NL | 0.24 | g | 0.24 | g | 0.24 | g | 0.24 | g | 0.24 | g |
| | Deionized water | | 125.26 | g | 125.26 | g | 109.26 | g | 175.26 | g | 125.26 | g |
| Total | | | 250 | g | 250 | g | 250 | g | 300 | g | 250 | g |
| | Dispersion | Number of | 12000 rpm × | | 12000 rpm × | | 12000 rpm × | | 14000 rpm × | | 14000 rpm × | |
| | Conditions | Revolution × Time | 5 min | | 5 min | | 5 min | | 5 min | | 5 min | |
| Physical | Remaining Amount on Filter Cloth having | | 0.06% | | 0.05% | | 0.05% | | 0.03% | | 0.03% | |
| Properties | 100 pores [vs Controlled Release Particles] | | | | | | | | | | | |
| | Antibiotic Compound Content | | 70% | | 55% | | 42% | | 30% | | 30% | |
| | [vs Controlled Release Particles] | | | | | | | | | | | |
| | Controlled Release Particles Content | | 40% | | 40% | | 40% | | 33.3% | | 40% | |
| | [vs Suspension] | | | | | | | | | | | |
| | Antibiotic Compound Content | | 28% | | 22% | | 16.8% | | 10% | | 12% | |
| | [vs Suspension] | | | | | | | | | | | |
| | Median Size | | 346 | nm | 316 | nm | 371 | nm | 212 | nm | 177 | nm |

| | | | | | |
|---|---|---|---|---|---|
| Controlled Release Particles Content | 0.0% | 0.0% | 1.6% | 0.0% | 0.0% |
| (Controlled Release Particles of 1 μm or | | | | | |
| more) | | | | | |
| Deposit of Needle Crystal of IPBC After | No | No | No | No | No |
| 14 days at 40° C. | Deposit | Deposit | Deposit | Deposit | Deposit |

TABLE C3

| | | | Comparative Example C • Reference Example C | | | |
|---|---|---|---|---|---|---|
| | | | Comparative | Reference | Reference | Reference |
| | | | Example | Example | Example | Example |
| | | | C1 | C1 | C2 | C3 |
| Hydrophobic | Antibiotic | IPBC | 12 g | 35 g | 30 g | — |
| Solution | Compound | Propiconazole | 28 g | — | — | 50 g |
| | Polymerizable | MMA | 56.4 g | 61.1 g | 65.8 g | 47.0 g |
| | Vinyl Monomer | EGDMA | 3.6 g | 3.9 g | 4.2 g | 3.0 g |
| | Polymerization | PEROYL L | 0.5 g | 0.5 g | 0.5 g | 0.5 g |
| | Initiator | | | | | |
| δP, polymer[(J/cm³)^{1/2}] of Polymer | | | 5.95 | 5.95 | 5.95 | 5.95 |
| δh, polymer[(J/cm³)^{1/2}] of Polymer | | | 9.32 | 9.32 | 9.32 | 9.32 |
| Aqueous | Emulsifier | Pronon 208 | 1.0 g | — | — | — |
| Emulsifier | | NEOCOL SW-C | — | 4.0 g | 4.0 g | 4.0 g |
| Solution | | NOIGEN EA-177 | — | 20 g | 20 g | 20 g |
| | Protective Colloid | PVA217 (10%) | 40 g | — | — | — |
| | Dispersing Agent | DEMOL NL | — | 0.24 g | 0.24 g | 0.24 g |
| | Deionized water | | 108.50 g | 224.76 g | 175.26 g | 125.26 g |
| Total | | | 250 g | 350 g | 300 g | 250 g |
| | Dispersion | Number of | 3000 rpm × 5 min | 14000 rpm × 5 min | 14000 rpm × 5 min | 14000 rpm × 5 min |
| | Conditions | Revolution × Time | | | | |

| | | | | | |
|---|---|---|---|---|---|
| Physical | Remaining Amount on Filter Cloth | 0.37% | 0.10% | 0.08% | 0.07% |
| Properties | having 100 pores | | | | |
| | [vs Controlled Release Particles] | | | | |
| | Antibiotic Compound Content | 40% | 35% | 30% | 50% |
| | [vs Controlled Release Particles] | | | | |
| | Controlled Release Particles Content | 40% | 28.6% | 33.3% | 40% |
| | [vs Suspension] | | | | |
| | Antibiotic Compound Content | 16% | 10% | 10% | 20% |
| | [vs Suspension] | | | | |
| | Median Size | 11 μm | 238 nm | 215 nm | 248 nm |
| | Controlled Release Particles Content | 100.0% | 0.0% | 0.0% | 0.0% |
| | (Controlled Release Particles of 1 μm or | | | | |
| | more) | | | | |
| | Deposit of Needle Crystal of IPBC at | No Deposit | 1.4% deposited | No Deposit | — |
| | 40° C. | after 14 days | After 1 day | after 14 days | |
| | | | 6.1% deposited | | |
| | | | after 4 days | | |

### (Remaining Amount on Filter Cloth Having 100 Pores (Polymerization Stability))

Emulsions of Examples C, Reference Examples C, and Comparative Examples C were filtered with a filter cloth having 100 pores, and the amount of the remained substance on the filter cloth after drying with air (mass %) was calculated based on the controlled release particles.

The results are shown in Table C1, Table C2, and Table C3.

### (Measurement of Particle Size of Controlled Release Particles)

Emulsions of Examples C, Reference Examples C, and Comparative Examples C were filtered with a filter cloth having 100 pores. The filtrate was subjected to dynamic light scattering using a particle size analyzer (FPAR-1000, Otsuka Electronics Co. Ltd.), thereby measuring the particle size of the controlled release particles as volume-based median size.

The results are shown in Table C1, Table C2, and Table C3.

### (Content of Controlled Release Particles of 1 μm or More)

Based on “scattering intensity distribution and frequency table” obtained at the time of the above-described “measurement of particle size of controlled release particles”, the cumulative frequency for the particle size of below 1 μm was regarded as X %, and (100−X) % was regarded as amount of the controlled release particles of 1 μm or more contained.

The results are shown in Table C1, Table C2, and Table C3.

### (Storage Stability)

Storage stability was evaluated by the measurement method below.

A predetermined emulsion was weighed and put in a glass bottle with a stopper, and allowed to stand in a room with a constant temperature of 40° C. The emulsion was filtered with a filter cloth having 100 pores after 1 day, 4 days, and 14 days from the standing, and the amount (mass %) of the remained substance on the filter cloth after drying with air was calculated based on the controlled release particles, and also the remained substance on the filter cloth was observed with an optical microscope.

The results are shown in Table C1, Table C2, and Table C3.

### (Preparation of Wood Treatment Agent and Antiseptic Test)

Water was added to the emulsions of Example C1 to Example C11, Comparative Example C1 and Reference Example C4 for dilution so that the propiconazole content was 0.6 mass %, thereby preparing a wood treatment agent. Using those wood treatment agents, an antiseptic test was conducted in conformity with “indoor rot-control efficacy test and performance standards for lumber antiseptic for surface treatment (JWPS-FW-S.1)” specified by Japan Wood Protection Association. Tyromyces palustris and Coriolus versicolor were used as decay fungus in the Antiseptic Test, and the mass decrease ratio (%) of the lumber was measured.

For the control, the antiseptic test was conducted without using the antiseptic and antifungal agent for lumber. This was named Comparative Example C2.

The results are shown in Table C4. The mass decrease ratio of 3% or less is a passing value under the regulation for wood preservatives.

TABLE C4

| | | Example C • Comparative Example C • Reference Example C | | | | | | | |
|---|---|---|---|---|---|---|---|---|---|
| | | Example | Example | Example | Example | Example | Example | Example | Example |
| | | C1 | C2 | C3 | C4 | C5 | C6 | C7 | C8 |
| Antibiotic | IPBC | 12 g | 13.5 g | 15 g | 16.5 g | 18 g | 19.5 g | 21 g | 35 g |
| Compound | Propiconazole | 28 g | 31.5 g | 35 g | 38.5 g | 42 g | 45.5 g | 49 g | 20 g |
| | Cyfluthrin | — | — | — | — | — | — | — | — |
| Amount of Undiluted Emulsion in Total | | 250 g | 250 g | 250 g | 250 g | 250 g | 250 g | 250 g | 250 g |
| Antibiotic | IPBC | 4.8% | 5.4% | 6.0% | 6.6% | 7.2% | 7.8% | 8.4% | 14.0% |
| Compound | Propiconazole | 11.2% | 12.6% | 14.0% | 15.4% | 16.8% | 18.2% | 19.6% | 8.0% |
| | Cyfluthrin | — | — | — | — | — | — | — | — |
| Amount of Undiluted Emulsion in Total | | 100% | 100% | 100% | 100% | 100% | 100% | 100% | 100% |
| Dilution Rate to Achieve 0.6% of | | 18.7 | 21.1 | 23.3 | 25.7 | 28.0 | 30.3 | 32.7 | 13.3 |
| Propiconazole | | times | times | times | times | times | times | times | times |
| Evaluation on | Tyromyces palustris | 2.8% | 2.6% | 2.5% | 2.7% | 2.6% | 2.5% | 2.5% | 2.2% |
| Antiseptics | Coriolus versicolor | 1.2% | 1.2% | 1.1% | 1.2% | 1.1% | 1.0% | 0.9% | 0.9% |
| (Mass Decrease | | | | | | | | | |
| Ratio) | | | | | | | | | |

Example C • Comparative Example C • Reference Example C

| | | Example | Example | Example | Comparative | Reference | Comparative |
|---|---|---|---|---|---|---|---|
| | | C9 | C10 | C11 | Example C1 | Example C4 | Example C2 |
| Antibiotic | IPBC | 12 g | 15 g | 12 g | 12 g | 9 g | |
| Compound | Propiconazole | 28 g | 15 g | 18 g | 28 g | 21 g | |
| | Cyfluthrin | 2 g | — | — | — | — | |
| Amount of Undiluted Emulsion in Total | | 250 g | 300 g | 250 g | 250 g | 195 g | |
| Antibiotic | IPBC | 4.8% | 5.0% | 4.8% | 4.8% | 4.6% | |
| Compound | Propiconazole | 11.2% | 5.0% | 7.2% | 11.2% | 10.76% | |
| | Cyfluthrin | 1% | — | — | — | — | |
| Amount of Undiluted Emulsion in Total | | 100% | 100% | 100% | 100% | 100% | |
| Dilution Rate to Achieve 0.6% of | | 18.7 | 8.3 times | 12.0 | 18.7 times | 17.9 | |
| Propiconazole | | times | | times | | times | |
| Evaluation on | Tyromyces palustris | 2.7% | 2.2% | 2.3% | 8.2% | 2.2% | 34% |
| Antiseptics | Coriolus versicolor | 1.2% | 1.0% | 1.0% | 7.3% | 1.0% | 41% |
| (Mass Decrease | | | | | | | |
| Ratio) | | | | | | | |

### (TEM (Transmission Electron Microscope) Observation)

The emulsion of Example C8 was naturally dried, dispersed in a bisphenol liquid epoxy resin, and cured with amine. The cured products were cut with an ultramicrotome to expose the cross sections, dyed with ruthenium tetroxide, and cut into ultra thin slices with an ultramicrotome, thereby preparing samples. The prepared sample was observed with a transmission electron microscope (model number “H-7100”, manufactured by Hitachi, Ltd.).

Image-processed TEM photographs of Example C8 are shown in FIG. C1 and FIG. C2.

### [4] Examples Corresponding to the Fourth Invention Group

Details of the ingredients and the measurement methods used in Examples D, Reference Examples D, and Comparative Examples D are described below.

IPBC: trade name “Fungitrol 400”, 3-iodo-2-propynylbutylcarbamate, molecular weight 281, melting point: 60° C., water solubility: 150 ppm, polar term δ_{p,IPBC} of the solubility parameter (δ): 3.23 [(J/cm³)^{1/2}], hydrogen bonding term δ_{h,IPBC} of the solubility parameter (δ): 7.83 [(J/cm³)^{1/2}], manufactured by International Specialty Products Inc.

MMA: methyl methacrylate, trade name “ACRYESTER M”, water solubility: 1.6 mass %, polar term δ_{p,1st monomer unit} of the solubility parameter (δ): 5.98 [(J/cm³)^{1/2}], hydrogen bonding term δ_{h,1st monomer unit} of the solubility parameter (δ): 9.25 [(J/cm³)^{1/2}], manufactured by Mitsubishi Rayon Co., Ltd.

EGDMA: ethylene glycol dimethacrylate, trade name “Light Ester EG”, water solubility: 5.37 ppm, polar term δ_{p,1st monomer unit} of the solubility parameter (δ): 5.37 [(J/cm³)^{1/2}], hydrogen bonding term δ_{h,1st monomer unit} of the solubility parameter (δ): 10.42 [(J/cm³)^{1/2}], manufactured by Kyoeisha Chemical Co., Ltd.

PEROYL L: trade name (“PEROYL” is registered trademark), dilauroyl peroxide, manufactured by NOF CORPORATION

NEOCOL SW-C: trade name, solution of 70 mass % sodium dioctyl sulfosuccinate (anionic emulsifier) in isopropanol, manufactured by Dai-ichi Kogyo Seiyaku Co., Ltd.

NOIGEN EA-177: trade name, polyoxyethylene styrenated phenylether (non-ionic emulsifier, HLB:15.6), manufactured by Dai-ichi Kogyo Seiyaku Co., Ltd.

PVA205: trade name, polyvinyl alcohol, the degree of saponification: 87.0 to 89.0%, degree of polymerization: 500, viscosity (4% aqueous solution, 20° C.): 5.0 to 6.0 mPa·sec, manufactured by Kuraray Co., Ltd.

PVA217: trade name, polyvinyl alcohol, the degree of saponification: 87.0 to 89.0%, degree of polymerization: 1700, viscosity (4% aqueous solution, 20° C.): 22.0 to 27.0 mPa·sec, manufactured by Kuraray Co., Ltd.

PVA224: trade name, polyvinyl alcohol, the degree of saponification: 87.0 to 89.0%, degree of polymerization: 2400, viscosity (4% aqueous solution, 20° C.): 42.0 to 50.0 mPa·sec, manufactured by Kuraray Co., Ltd.

DEMOL NL: trade name, β-sodium naphthalene sulfonate formaldehyde condensate, dispersing agent, manufactured by Kao Corporation

Metolose 90SH-50: trade name, hydroxypropylmethylcellulose, viscosity (2% aqueous solution, 20° C.): 50 mPa·sec, manufactured by Shin-Etsu Chemical Co., Ltd.

Metolose 90SH-100: trade name, hydroxypropylmethylcellulose, viscosity (2% aqueous solution, 20° C.): 100 mPa sec, manufactured by Shin-Etsu Chemical Co., Ltd.

NPS: sodium persulfate, water-soluble polymerization initiator, manufactured by Wako Pure Chemical Industries, Ltd.

In Table D1, Table D2, Table D3, and Table D4, “%” refers to “mass %” unless otherwise noted.

### Example D1

### Production of Controlled Release Particles Containing IPBC by Mini-Emulsion Polymerization

A 200 mL container was charged with 25 g of IPBC, 70.5 g of MMA, 4.5 g of EGDMA, and 0.5 g of PEROYL L, and the mixture was stirred at room temperature, thereby producing a homogenous hydrophobic solution.

Separately, a 500 mL beaker was charged with 106.3 g of deionized water, 1.0 g of NEOCOL SW-C, 40 g of aqueous solution of PVA217 (10%), and 0.24 g of DEMOL NL, and the mixture was stirred at room temperature, thereby producing a homogenous aqueous emulsifier/PVA solution.

Then, a hydrophobic solution was added to the aqueous emulsifier solution of the 500 mL beaker, and the mixture was stirred with T.K. Homo Mixer MARK model 2.5 (manufactured by PRIMIX Corporation) at 14000 rpm for 5 minutes. The hydrophobic solution was emulsified in the aqueous emulsifier solution, thereby preparing a mini-emulsion.

Thereafter, the prepared mini-emulsion was transferred to a 300 mL, 4-neck flask equipped with a stirrer, a reflux condenser, a thermometer, and a nitrogen inlet tube, and polymerized by mini-emulsion polymerization under nitrogen gas current, while stirring with a 6 cm-diameter stirrer at 125 rpm (circumferential speed 23.6 m/min), and increasing the temperature of the 4-neck flask with water bath.

The mini-emulsion polymerization was regarded as initiated when the temperature reached 55° C., and thereafter, polymerization was performed continuously for 3 hours at 62±2° C., for 2 hours at 70±2° C.

Then, the temperature of the water bath was increased to increase the temperature of the reaction solution to 80±2° C., and the reaction solution was aged at that temperature for 2 hours, while 2 g of aqueous solution of NPS (5%) was supplied by taking 1 hour (addition of NPS).

Thereafter, the reaction solution was cooled to 30° C. or less, thereby producing an emulsion of controlled release particles containing IPBC.

Thereafter, the emulsion was filtered with a filter cloth having 100 pores, and the median size of the controlled release particles in the filtrate was measured: as a result, the median size was 435 nm.

The emulsion was a colloidal dispersion stable as a normal polymer latex, and no tendency of sedimentation or phase separation of the controlled release particles was observed during storage at room temperature.

### Example D2 to Example D11

Emulsion of controlled release particles was obtained in the same manner as in Example D1, except that the mixing formulation of the component and the conditions were changed in conformity with Table D1 and Table D2.

Any of the emulsions of Example D2 to Example D11 was a colloidal dispersion stable as a normal polymer latex, and no tendency of sedimentation or phase separation of the particles was observed during storage at room temperature.

### Reference Example D1, Comparative Example D2 and Reference Example D3 to Reference Example D9

Emulsion of controlled release particles was obtained in the same manner as in Example D1, except that the mixing formulation of the component and the conditions were changed in conformity with Table D3 and Table D4.

### (Mixing Formulation)

The mixing formulations in Examples D, Reference Examples D, and Comparative Examples Dare shown in Table D1 to Table D4.

TABLE D1

| | | | Example D | | |
|---|---|---|---|---|---|
| | | | Example D1 | Example D2 | Example D3 |
| Hydrophobic Solution | Active Component | IPBC | 25 g | 30 g | 35 g |
| | Monomer | MMA | 70.5 g | 65.8 g | 61.1 g |
| | | EGDMA | 4.5 g | 4.2 g | 3.9 g |
| | Polymerization Initiator | PEROYL L | 0.5 g | 0.5 g | 0.5 g |
| Aqueous Emulsifier/PVA | Emulsifier | NEOCOL SW-C (AI: 70%) | 1.0 g | 1.0 g | 1.0 g |
| Solution | Aqueous PVA Solution | PVA205 (10%) | — | — | — |
| | | PVA217 (10%) | 40 g | 40 g | 40 g |
| | | PVA224 (10%) | — | — | — |
| | Dispersing Agent | DEMOL NL(AI: 41%) | 0.24 g | 0.24 g | 0.24 g |
| | Deionized water | | 106.26 g | 156.26 g | 206.26 g |
| | Initiator(Aqueous Solution of 5% NPS) | | 2.0 g | 2.0 g | 2.0 g |
| | Addition of Extra NPS | | | | |
| Dispersion | Number of Revolution × Time | | 14000 rpm × | 14000 rpm × | 14000 rpm × |
| | | | 5 min | 5 min | 5 min |
| Polymer | δp, polymer [(J/cm³)^{1/2}] | | 5.95 | 5.95 | 5.95 |
| | δh, polymer [(J/cm³)^{1/2}] | | 9.32 | 9.32 | 9.32 |
| | Δδp [(J/cm³)^{1/2}] | | 2.72 | 2.72 | 2.72 |
| | Δδh [(J/cm³)^{1/2}] | | 1.49 | 1.49 | 1.49 |
| Results | Controlled Release Particles Concentration [vsEmulsion] | | 40% | 33.3% | 28.4% |
| | IPBC concentration [vsEmulsion] | | 10% | 10% | 10% |
| | Emulsion | Remaining Amount on Filter Cloth having 100 pores | 0.074% | 0.098% | 0.004% |
| | Conditions | [vs Controlled Release Particles] | | | |
| | | Particle Size (Median Size) | 435 nm | 454 nm | 475 nm |
| | | Particle Content (Particles with more than 1 μm) | 7.0% | 2.4% | 2.6% |
| | | Remaining MMA amount [vsEmulsion] | 0.07% | 0.06% | 0.06% |
| | Storage Stability | Deposit of Needle Crystal (mass %) | Excellent | Excellent | Excellent |
| | (On 100 Pores) | [vs Controlled Release Particles] | | | |
| | (40° C.) | | | | |
| | | | Example D | | |
| | | | Example D4 | Example D5 | Example D6 |
| Hydrophobic Solution | Active Component | IPBC | 40 g | 30 g | 35 g |
| | Monomer | MMA | 56.4 g | 65.8 g | 61.1 g |
| | | EGDMA | 3.6 g | 4.2 g | 3.9 g |
| | Polymerization Initiator | PEROYL L | 0.5 g | 0.5 g | 0.5 g |
| Aqueous Emulsifier/PVA | Emulsifier | NEOCOL SW-C (AI: 70%) | 1.0 g | 1.0 g | 1.0 g |
| Solution | Aqueous PVA Solution | PVA205 (10%) | — | — | — |
| | | PVA217 (10%) | 40 g | 40 g | 40 g |
| | | PVA224 (10%) | — | — | — |
| | Dispersing Agent | DEMOL NL(AI: 41%) | 0.24 g | 0.24 g | 0.24 g |
| | Deionized water | | 256.26 g | 106.26 g | 106.26 g |
| | Initiator(Aqueous Solution of 5% NPS) | | 2.0 g | 2.0 g | 2.0 g |
| | Addition of Extra NPS | | | | |
| Dispersion | Number of Revolution × Time | | 14000 rpm × | 14000 rpm × | 14000 rpm × |
| | | | 5 min | 5 min | 5 min |
| Polymer | δp, polymer [(J/cm³)^{1/2}] | | 5.95 | 5.95 | 5.95 |
| | δh, polymer [(J/cm³)^{1/2}] | | 9.32 | 9.32 | 9.32 |
| | Δδp [(J/cm³)^{1/2}] | | 2.72 | 2.72 | 2.72 |
| | Δδh [(J/cm³)^{1/2}] | | 1.49 | 1.49 | 1.49 |
| Results | Controlled Release Particles Concentration [vsEmulsion] | | 25% | 40% | 40% |
| | IPBC concentration [vsEmulsion] | | 10% | 12% | 14% |
| | Emulsion | Remaining Amount on Filter Cloth having 100 pores | 0.002% | 0.005% | 0.007% |
| | Conditions | [vs Controlled Release Particles] | | | |
| | | Particle Size (Median Size) | 437 nm | 410 nm | 382 nm |
| | | Particle Content (Particles with more than 1 μm) | 4.6% | 1.5% | 0.0% |
| | | Remaining MMA amount [vsEmulsion] | 0.05% | 0.06% | 0.05% |
| | Storage Stability | Deposit of Needle Crystal (mass %) | Good (*1) | Excellent | Excellent |
| | (On 100 Pores) | [vs Controlled Release Particles] | | | |
| | (40° C.) | | | | |

(*1) Amount of Aggregate after 60 days was 2.13 mass % (vs Controlled Release Particles).

TABLE D2

| | | | Example D | | | | |
|---|---|---|---|---|---|---|---|
| | | | Example D7 | Example D8 | Example D9 | Example D10 | Example D11 |
| Hydrophobic | Active Component | IPBC | 40 g | 25 g | 25 g | 25 g | 25 g |
| Solution | Monomer | MMA | 56.4 g | 70.5 g | 70.5 g | 70.5 g | 70.5 g |
| | | EGDMA | 3.6 g | 4.5 g | 4.5 g | 4.5 g | 4.5 g |
| | Polymerization Initiator | PEROYL L | 0.5 g | 0.5 g | 0.5 g | 0.5 g | 0.5 g |
| Aqueous | Emulsifier | NEOCOL SW-C (AI: 70%) | 1.0 g | 1.0 g | 1.0 g | 1.0 g | 1.0 g |
| Emulsifier/ | Aqueous PVA Solution | PVA205 (10%) | — | 40 g | — | — | — |
| PVA | | PVA217 (10%) | 40 g | — | 40 g | — | 20 g |
| Solution | | PVA224 (5%) | — | — | — | 80 g | — |
| | Dispersing Agent | DEMOL NL (AI: 41%) | 0.24 g | 0.24 g | 0.24 g | 0.24 g | 0.24 g |
| | Deionized water | | 106.26 g | 106.26 g | 106.26 g | 66.26 g | 126.26 g |
| | Initiator (Aqueous Solution of 5% NPS) | | 2.0 g | 2.0 g | 2.0 g | 2.0 g | 2.0 g |
| | Addition of Extra NPS | | | | | | |
| Dispersion | Number of Revolution × Time | | 14000 rpm × | 10000 rpm × | 10000 rpm × | 10000 rpm × | 10000 rpm × |
| | | | 5 min | 10 min | 10 min | 10 min | 10 min |
| Polymer | δp, polymer [(J/cm³)^{1/2}] | | 5.95 | 5.95 | 5.95 | 5.95 | 5.95 |
| | δh, polymer [(J/cm³)^{1/2}] | | 9.32 | 9.32 | 9.32 | 9.32 | 9.32 |
| | Δδp [(J/cm³)^{1/2}] | | 2.72 | 2.72 | 2.72 | 2.72 | 2.72 |
| | Δδh [(J/cm³)^{1/2}] | | 1.49 | 1.49 | 1.49 | 1.49 | 1.49 |
| Results | Controlled Release Particles Concentration [vsEmulsion] | | 40% | 40% | 40% | 40% | 40% |
| | IPBC concentration [vsEmulsion] | | 16% | 10% | 10% | 10% | 10% |
| | Emulsion | Remaining Amount on Filter | 0.008% | 0.017% | 0.038% | 0.018% | 0.082% |
| | Conditions | Cloth having 100 pores | | | | | |
| | | [vs Controlled Release Particles] | | | | | |
| | | Particle Size (Median Size) | 402 nm | 473 nm | 485 nm | 559 nm | 480 nm |
| | | Particle Content | 1.1% | 9.9% | 7.1% | 16.0% | 4.0% |
| | | (Particles with more than 1 μm) | | | | | |
| | | Remaining MMA amount | 0.07% | 0.07% | 0.07% | 0.07% | 0.07% |
| | | [vsEmulsion] | | | | | |
| | Storage Stability | Deposit of Needle Crystal | Good (*2) | Excellent | Excellent | Excellent | Excellent |
| | (On 100 Pores) | (mass %) | | | | | |
| | (40° C.) | [vs Controlled Release Particles] | | | | | |

(*2) Amount of Aggregate after 60 days was 2.36 mass % (vs Controlled Release Particles).

TABLE D3

| | | | Reference Example D • Comparative Example D | | | | |
|---|---|---|---|---|---|---|---|
| | | | Reference | Comparative | Reference | Reference | Reference |
| | | | Example D1 | Example D2 | Example D3 | Example D4 | Example D5 |
| Hydrophobic | Active Component | IPBC | 25 g | 25 g | 25 g | 25 g | 30 g |
| Solution | Monomer | MMA | 70.5 g | 70.5 g | 70.5 g | 70.5 g | 65.8 g |
| | | EGDMA | 4.5 g | 4.5 g | 4.5 g | 4.5 g | 4.2 g |
| | Polymerization | PEROYL L | 0.5 g | 0.5 g | 0.5 g | 0.5 g | 0.5 g |
| | Initiator | | | | | | |
| Aqueous | Emulsifier | NEOCOL SW-C (AI: 70%) | 1.0 g | — | 4.0 g | 4.0 g | 4.0 g |
| Solution | | Aqueous Solution of NOIGEN | — | — | 20 g | 20 g | 20 g |
| | | EA-177 (25%) | | | | | |
| | Protective Colloid | PVA217 (10%) | — | 40 g | — | — | — |
| | Aqueous Solution | Metolose90SH-100 (10%) | — | — | — | — | — |
| | | Metolose90SH-50 (10%) | — | — | — | — | — |
| | Dispersing Agent | DEMOL NL (AI: 41%) | 0.24 g | — | 0.24 g | — | 0.24 g |
| | Deionized water | | 146.26 g | 107.50 g | 123.26 g | 125.50 g | 173.26 g |
| | Initiator (Aqueous Solution of 5% NPS) | | 2.0 g | 2.0 g | 2.0 g | — | 2.0 g |
| | Addition of Extra NPS | | | | | | |
| Polymer | δp, polymer [(J/cm³)^{1/2}] | | 5.95 | 5.95 | 5.95 | 5.95 | 5.95 |
| | δh, polymer [(J/cm³)^{1/2}] | | 9.32 | 9.32 | 9.32 | 9.32 | 9.32 |
| | Δδp [(J/cm³)^{1/2}] | | 2.72 | 2.72 | 2.72 | 2.72 | 2.72 |
| | Δδh [(J/cm³)^{1/2}] | | 1.49 | 1.49 | 1.49 | 1.49 | 1.49 |
| Results | Controlled Release Particles Concentration [vsEmulsion] | | 40% | 40% | 40% | 25% | 33.3% |
| | IPBC concentration [vsEmulsion] | | 10% | 10% | 10% | 10% | 10% |
| | Emulsion | Remaining Amount on Filter Cloth | 0.58% | 0.0057% | 0.61% | 0.050% | 0.75% |
| | Conditions | having 100 pores | | | | | |
| | | [vs Controlled Release Particles] | | | | | |
| | | Particle Size (Median Size) | 317 nm | 843 nm | 206 nm | 214 nm | 217 nm |
| | | Particle Content | 0.0% | 35.0% | 0.0% | 0.0% | 0.0% |
| | | (Particles with more than 1 μm) | | | | | |
| | | Remaining MMA amount [vsEmulsion] | 0.06% | 0.07% | 0.06% | 0.52% | 0.05% |
| | Storage Stability | Deposit of Needle Crystal | Excellent | Excellent | Excellent | Excellent | Excellent |
| | (On 100 Pores) | [vs Controlled Release Particles] | | | | | |
| | (40° C.) | Calculated value in ( ) | | | | | |

(Dispersion Conditions: 14000 rpm × 5 min,, Dispersed the Day before Reaction)
(Reaction Conditions: 60° C. × 3 Hr→70° C. × 2 Hr→80° C. × 2 Hr, Reaction Time includes Time for Temperature Increase)

TABLE D4

| | | | Reference Example D | | | | | |
|---|---|---|---|---|---|---|---|---|
| | | | | | | | Reference | Reference |
| | | | Reference | Reference | Reference | Reference | Example | Example |
| | | | Example D6 | Example D7 | Example D8 | Example D9 | D10 | D11 |
| Hydrophobic | Active | IPBC | 35 g | 40 g | 35 g | 40 g | 30 g | 30 g |
| Solution | Component | | | | | | | |
| | Monomer | MMA | 61.1 g | 56.4 g | 61.1 g | 56.4 g | 65.8 g | 65.8 g |
| | | EGDMA | 3.9 g | 3.6 g | 3.9 g | 3.6 g | 4.2 g | 4.2 g |
| | Polymerization | PEROYL L | 0.5 g | 0.5 g | 0.5 g | 0.5 g | 0.5 g | 0.5 g |
| | Initiator | | | | | | | |
| Aqueous | Emulsifier | NEOCOL SW-C (AI: 70%) | 4.0 g | 4.0 g | 4.0 g | 4.0 g | 1.0 g | 1.0 g |
| Solution | | Aqueous Solution of NOIGEN | 20 g | 20 g | 20 g | 20 g | — | — |
| | | EA-177 (25%) | | | | | | |
| | Protective | PVA217 (10%) | — | — | — | — | — | — |
| | Colloid | Metolose 90SH-100 (10%) | — | — | — | — | 40 g | — |
| | Aqueous | Metolose 90SH-50 (10%) | — | — | — | — | — | 40 g |
| | Solution | | | | | | | |
| | Dispersing | DEMOL NL (AI: 41%) | 0.24 g | 0.24 g | 0.24 g | 0.24 g | 0.24 g | 0.24 g |
| | Agent | | | | | | | |
| | Deionized water | | 223.26 g | 273.26 g | 123.26 g | 123.26 g | 156.26 g | 156.26 g |
| | Initiator (Aqueous Solution of 5% NPS) | | 2.0 g | 2.0 g | 2.0 g | 2.0 g | 2.0 g | 2.0 g |
| | Addition of Extra NPS | | | | | | | |
| Polymer | δp, polymer [(J/cm³)^{1/2}] | | 5.95 | 5.95 | 5.95 | 5.95 | 5.95 | 5.95 |
| | δh, polymer [(J/cm³)^{1/2}] | | 9.32 | 9.32 | 9.32 | 9.32 | 9.32 | 9.32 |
| | Δδp [(J/cm³)^{1/2}] | | 2.72 | 2.72 | 2.72 | 2.72 | 2.72 | 2.72 |
| | Δδh [(J/cm³)^{1/2}] | | 1.49 | 1.49 | 1.49 | 1.49 | 1.49 | 1.49 |
| Results | Controlled Release Particles Concentration | | 28.6% | 25% | 40% | 40% | 33.3% | 33.3% |
| | [vsEmulsion] | | | | | | | |
| | IPBC concentration [vsEmulsion] | | 10% | 10% | 14% | 16% | 10% | 10% |
| | Emulsion | Remaining Amount on Filter | 1.0% | 1.2% | 1.4% | 2.1% | 0.002% | Could not be |
| | Conditions | Cloth having 100 pores | | | | | | filtered |
| | | [vs Controlled Release Particles] | | | | | | because |
| | | | | | | | | of Clogging |
| | | Particle Size (Median Size) | 230 nm | 236 nm | 216 nm | 219 nm | 1.50 μm | 2.27 μm |
| | | Particle Content (Particles with | 0.0% | 0.0% | 0.0% | 0.0% | 87.0% | 99.0% |
| | | more than 1 μm) | | | | | | |
| | | Remaining MMA amount | 0.04% | 0.04% | 0.05% | 0.06% | — | — |
| | | [vsEmulsion] | | | | | | |
| | Storage | Deposit of Needle Crystal | Not Present | Not Present | Not Present | Not Present | — | — |
| | Stability | [vs Controlled Release Particles] | Day 1: | Day 1: | Day 1: | Day 1: | | |
| | (On 100 Pores) | | 1.22% | 4.94% | 1.06% | 4.72% | | |
| | (40° C.) | Calculated value in ( ) | Day 4: | Day 4: | Day 4: | Day 4: | | |
| | | | 6.17% | 7.88% | 6.41% | 8.11% | | |
| | | | Day 20: | Day 20: | Day 20: | Day 20: | | |
| | | | 0.013% | 0.010% | 0.012% | 0.011% | | |
| | | | (Remaining | (Remaining | (Remaining | (Remaining | | |
| | | | IPBC | IPBC | IPBC | IPBC | | |
| | | | Amount | 27.2%) | 27.5%) | Amount | | |
| | | | 27.6%) | | | 27.2%) | | |

(Dispersion Conditions: 14000 rpm × 5 min,, Dispersed the Day before Reaction)
(Reaction Conditions: 60° C. × 3 Hr→70° C. × 2 Hr→80° C. × 2 Hr, Reaction Time includes Time for Temperature Increase)

### Evaluation

### 1. Emulsion Characteristics

### (1) Measurement of Particle Size of Controlled Release Particles

Emulsions of Examples D, Reference Examples D, and Comparative Examples D were filtered with a filter cloth having 100 pores. The filtrate was subjected to dynamic light scattering using a particle size analyzer (FPAR-1000, Otsuka Electronics Co. Ltd.), thereby measuring the particle size as volume-based median size.

The results are shown in Tables D1 to D4.

### (2) Amount of Controlled Release Particles of Over 1 μm Contained

Based on “scattering intensity distribution and frequency table” obtained at the time of the above-described “(1) measurement of particle size of controlled release particles”, the cumulative frequency for the particles having a particle size of 1 μm or less was regarded as X %, and (100−X) % was regarded as the amount of the controlled release particles of over 1 μm contained.

The results are shown in Tables D1 to D4.

### (3) Remaining Amount on Filter Cloth Having 100 Pores (Polymerization Stability)

Emulsions of Examples D, Reference Examples D, and Comparative Examples D were filtered with a filter cloth having 100 pores, and the amount (mass %) of the remained substance on the filter cloth after drying with air was calculated based on the controlled release particles.

The results are shown in Tables D1 to D4.

### (4) Remaining Monomer

Emulsions of Examples D, Reference Examples D, and Comparative Examples D were filtered with a filter cloth having 100 pores. The filtrate was subjected to the measurement of the remaining monomer amount using a pyrosis gas chromatograph manufactured by Shimadzu Corporation with the following measurement conditions. First, a standard solution for calibration curve was prepared, setting MMA as a standard sample, cyclohexanone as an internal standard, and using methanol as a dilution solvent; and using a pyrolizer, a calibration curve was made by vaporization under the conditions of 220° C.×20 seconds. The solution of internal standard was added to the 4 g of the emulsion sample, and methanol was added to prepare a sample solution of a total amount of 10 g. The sample solution was subjected to the measurement under the same measurement conditions with the standard solution, thereby determining the amount of remaining monomer.

The results are shown in Tables D1 to D4.

### 2. Storage Stability

Storage stability was evaluated by the measurement method below.

A predetermined emulsion was weighed and put in a glass bottle with a stopper, and allowed to stand in a room with a constant temperature of 40° C. The emulsion was filtered with a filter cloth having 100 pores after 1 day, 4 days, 20 days, and 2 months from the standing, and the amount (mass %) of the remained substance on the filter cloth after drying with air was calculated based on the controlled release particles, and also the remained substance on the filter cloth was observed with an optical microscope.

Evaluation was made as follows. Excellent: no deposit of needle crystal of IPBC was observed from the preparation of the emulsion to after 2 months from the preparation of the emulsion. Good: generation of aggregation of the controlled release particles was observed from the preparation of the emulsion to within 2 months from the preparation of the emulsion, but no deposit of needle crystal of IPBC was observed. Bad: deposit of needle crystal of IPBC was seen from the preparation of the emulsion to within 2 months from the preparation of the emulsion.

The results are shown in Tables D1 to D4.

### 3. TEM (Transmission Electron Microscope) Observation

The emulsion of Example D2 was naturally dried, dispersed in a bisphenol liquid epoxy resin, and cured with amine. The cured products were cut with an ultramicrotome to expose the cross sections, dyed with ruthenium tetroxide, and cut into ultra thin slices with an ultramicrotome, thereby preparing samples. The prepared sample was observed with a transmission electron microscope (model number “H-7100”, manufactured by Hitachi, Ltd.).

Image-processed TEM photographs of Example D2 are shown in FIG. D1 and FIG. D2.

The images show that the inner layer (inside) of the controlled release particles has a uniform structure without phase separation.

### 4. Controlled Release Properties Test on Controlled Release Particles Containing IPBC (Example D1 and Example D2) and on IPBC Suspension Liquid as a Control

Preparation of IPBC Suspension Liquid (Control)

An IPBC suspension liquid was prepared in accordance with Example 3 of Japanese Unexamined Patent Publication No. 2007-204441 from 30 parts by mass of IPBC, 2 parts by mass of Metolose 90SH-100, 1.5 parts by mass of DK ester F-160 (sucrose fatty acid ester, manufactured by Dai-ichi Kogyo Seiyaku Co., Ltd.), 0.6 parts by mass of Pelex SSL (sodium alkyl diphenyl ether sulfonate), and 65.9 parts by mass of ion-exchange water.

The controlled release particles containing IPBC of Example D1 and Example D2 were subjected to a controlled release properties test of IPBC in the following manner. An IPBC suspension liquid was used as a control.

First, samples for the controlled release properties test were prepared from emulsions of Example D1 and Example D2 (IPBC concentration 10 mass %) and the above-described IPBC suspension liquid (IPBC concentration 30 mass %) as a control.

Then, the prepared samples were introduced in an amount of 20 mg (IPBC, by mass) into three polypropylene-made, 50 mL centrifuge tubes, and deionized water was added so that the total thereof was 40 g, thereby preparing an IPBC-containing liquid having an IPBC concentration of 0.05 mass %.

Then, the three centrifuge tubes were set in a shaker (TAITEC RECIPRO SHAKER SR-1 manufactured by TAITEC CORPORATION) and were shaken at a rate of 140 times/min. The shaking was stopped at an every predetermined time period. The centrifuge tubes were set in a centrifuge (micro refrigerated centrifuge 3740, manufactured by KUBOTA Corporation) and solid-liquid separation was performed at 15000 rpm for 5 minutes.

Deionized water was added to the solid portion so that the total thereof was 40 g, and the solid portion was re-dispersed with a microspatula. The mixture was set again in the shaker to continue shaking again.

Meanwhile, IPBC in the liquid portion was determined using HPLC manufactured by Shimadzu Corporation, thereby calculating the controlled-release rate.

The controlled-release rate in each shaking time was calculated as a cumulative value (that is, total controlled-release rate).

The results are shown in FIG. D3.

The controlled release particles obtained by mini-emulsion polymerization of Example D1 and Example D2 are slow in controlled-release speed compared with the IPBC of the IPBC suspension liquid as the control.

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICABILITY

Controlled release particles of the present invention can be added as an additive that exhibit antibiotic activities to various industrial products, for example, can be blended in indoor/outdoor paint, rubber, fiber, resin, plastic, adhesive, joint mixture, sealing agent, building material, caulking agent, soil treating agent, wood treatment agent, white water in paper-making processes, pigment, treatment liquid for printing plates, cooling water, ink, cutting oil, cosmetic products, nonwoven fabric, spinning oil, and leather.

1. Controlled release particles obtained by
dissolving a hydrophobic antibiotic compound with a hydrophobic polymerizable vinyl monomer to prepare a hydrophobic solution,
blending water with an emulsifier to prepare an aqueous emulsifier solution,
emulsifying the hydrophobic solution in the aqueous emulsifier solution, and
polymerizing the polymerizable vinyl monomer by mini-emulsion polymerization in the presence of a polymerization initiator, thereby producing a polymer containing an antibiotic compound and having an average particle size of below 1 μm.

2. The controlled release particles according to claim 1, wherein the antibiotic compound is 3-iodo-2-propynylbutylcarbamate, and the polymer obtained by the mini-emulsion polymerization has a polar term δ_{p,polymer} of 5.0 to 6.0 [(J/cm³)^{1/2}] of the solubility parameter (δ), and a hydrogen bonding term δ_{h,polymer} of 9.0 to 9.9 [(J/cm³)^{1/2}] of the solubility parameter (δ), the solubility parameter (δ) being defined by Hansen and calculated by van Krevelen and Hoftyzer method.

3. The controlled release particles according to claim 2,
wherein the polymerizable vinyl monomer contains 50 mass % or more of a first monomer, and
50 mass % or more of the first monomer has a character such that the monomer unit composing the polymer obtained from the first monomer has a polar term δ_{p,1st monomer unit(s)} of 5.6 to 6.0 [(J/cm³)^{1/2}] of the solubility parameter (δ), and a hydrogen bonding term δ_{h,1st monomer unit(s)} of 9.2 to 9.9 [(J/cm³)^{1/2}] of the solubility parameter (δ).

4. The controlled release particles according to claim 3, wherein the first monomer contains methyl methacrylate and/or ethylene glycol dimethacrylate.

5. The controlled release particles according to claim 1, wherein the antibiotic compound is at least 3-iodo-2-propynylbutylcarbamate and propiconazole.

6. A wood treatment agent containing controlled release particles,
wherein the controlled release particles are obtained by
dissolving at least 3-iodo-2-propynylbutylcarbamate and propiconazole, which are hydrophobic, with a hydrophobic polymerizable vinyl monomer to prepare a hydrophobic solution,
blending water with an emulsifier to prepare an aqueous emulsifier solution,
emulsifying the hydrophobic solution in the aqueous emulsifier solution,
polymerizing the polymerizable vinyl monomer by mini-emulsion polymerization in the presence of a polymerization initiator, thereby producing a polymer having an average particle size of below 1 μm and containing at least 3-iodo-2-propynylbutylcarbamate and propiconazole.

7. The controlled release particles according to claim 1, wherein the antibiotic compound is 3-iodo-2-propynylbutylcarbamate,
the aqueous emulsifier solution is an aqueous emulsifier/polyvinyl alcohol solution prepared by blending water with an emulsifier and polyvinyl alcohol, and
the polymer obtained by mini-emulsion polymerization has a polar term δ_{p,polymer} of 5.0 to 7.0 [(J/cm³)^{1/2}] of the solubility parameter (δ) and a hydrogen bonding term δ_{h,polymer} of 8.0 to 10.0 [(J/cm³)^{1/2}] of the solubility parameter (δ), the solubility parameter (δ) being defined by Hansen and calculated by van Krevelen and Hoftyzer method.

8. The controlled release particles according to claim 7, wherein the 3-iodo-2-propynylbutylcarbamate content relative to the controlled release particles is 10 to 50 mass %.

9. A method for producing controlled release particles comprising the steps of
dissolving a hydrophobic antibiotic compound with a hydrophobic polymerizable vinyl monomer to prepare a hydrophobic solution,
blending water with an emulsifier to prepare an aqueous emulsifier solution,
emulsifying the hydrophobic solution in the aqueous emulsifier solution, and
polymerizing the polymerizable vinyl monomer in the emulsified hydrophobic solution by mini-emulsion polymerization in the presence of a polymerization initiator, thereby producing a polymer containing an antibiotic compound and having an average particle size of below 1 μm.

10. The method for producing controlled release particles according to claim 9,
wherein the antibiotic compound is 3-iodo-2-propynylbutylcarbamate,
the polymer obtained by mini-emulsion polymerization has a polar term δ_{p,polymer} of the solubility parameter (δ) of 5.0 to 6.0 [(J/cm³)^{1/2}] and a hydrogen bonding term δ_{h,polymer} of the solubility parameter (δ) of 9.0 to 9.9 [(J/cm³)^{1/2}], the solubility parameter (δ) being defined by Hansen and calculated by van Krevelen and Hoftyzer method.

11. The method for producing controlled release particles according to claim 9, wherein the antibiotic compound is at least 3-iodo-2-propynylbutylcarbamate and propiconazole.

12. The method for producing controlled release particles according to claim 9, wherein the antibiotic compound is 3-iodo-2-propynylbutylcarbamate,
in the step of preparing an aqueous emulsifier solution, water is blended with an emulsifier and polyvinyl alcohol to prepare an aqueous emulsifier/polyvinyl alcohol solution,
in the step of emulsifying the hydrophobic solution in the aqueous emulsifier solution, the hydrophobic solution is emulsified in the aqueous emulsifier/polyvinyl alcohol solution, and
the polymer obtained by mini-emulsion polymerization has a polar term δ_{p,polymer} of 5.0 to 7.0 [(J/cm³)^{1/2}] of the solubility parameter (δ) and a hydrogen bonding term δ_{h,polymer} of 8.0 to 10.0 [(J/cm³)^{1/2}] of the solubility parameter (δ), the solubility parameter (δ) being defined by Hansen and calculated by van Krevelen and Hoftyzer method.
